(19) United States
(12) Patent Application Publication
(10) Pub. No.: US 2025/0175598 A1
(43) Pub. Date: May 29, 2025

(54) METHOD AND APPARATUS FOR CROSS-COMPONENT PREDICTION FOR VIDEO CODING

(71) Applicant: BEIJING DAJIA INTERNET INFORMATION TECHNOLOGY CO., LTD., Beijing (CN)

(72) Inventors: Che-Wei KUO, Beijing (CN); Hong-Jheng JHU, Beijing (CN); Xiaoyu XIU, San Diego, CA (US); Ning YAN, Hangzhou (CN); Wei CHEN, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/038,951

(22) Filed: Jan. 28, 2025

Related U.S. Application Data
(63) Continuation of application No. PCT/US2023/028992, filed on Jul. 28, 2023.
(63) Continuation of application No. PCT/US2023/030091, filed on Aug. 11, 2023.
(60) Provisional application No. 63/393,177, filed on Jul. 28, 2022.
(60) Provisional application No. 63/397,731, filed on Aug. 12, 2022.

(51) Int. Cl. H04N 19/117; H04N 19/167; H04N 19/176; H04N 19/59

(52) U.S. Cl. CPC H04N 19/117; H04N 19/167; H04N 19/176; H04N 19/59

(57) ABSTRACT

The present disclosure provides a method for decoding video data, comprising: obtaining a video block from a bitstream; obtaining internal luma sample values of the video block, external luma sample values of an external region of the video block and external chroma sample values of the external region; selecting, based on the external luma sample values and the external chroma sample values, one filter shape candidate from a plurality of filter shape candidates for predicting internal chroma sample values of the video block, wherein the plurality of filter shape candidates correspond to different sets of weighting coefficients for predicting chroma sample values based on corresponding luma sample values; predicting, with the selected filter shape candidate, the internal chroma sample values based on the internal luma sample values; and obtaining decoded video block using the predicted internal chroma sample values.

### CROSS-REFERENCE TO RELATED APPLICATION

This application is a continuation of the following PCT applications: PCT Application No. PCT/US2023/028992 filed on Jul. 28, 2023 and claims the benefits of U.S. Provisional Application No. 63/393,177 filed on Jul. 28, 2022; and PCT Application No. PCT/US2023/030091 filed on Aug. 11, 2023 and claims the benefits of U.S. Provisional Application No. 63/397,731 filed on Aug. 12, 2022. The entire contents thereof are incorporated herein by reference in their entirety.

### FIELD

Aspects of the present disclosure relate generally to image/video coding and compression, and more particularly, to methods and apparatus for cross-component prediction technology.

### BACKGROUND

Various video coding techniques may be used to compress video data. Video coding is performed according to one or more video coding standards. For example, video coding standards include versatile video coding (VVC), high-efficiency video coding (H.265/HEVC), advanced video coding (H.264/AVC), moving picture expert group (MPEG) coding, or the like. Video coding generally utilizes prediction methods (e.g., inter-prediction, intra-prediction, or the like) that take advantage of redundancy present in video images or sequences. An important goal of video coding techniques is to compress video data into a form that uses a lower bit rate, while avoiding or minimizing degradations to video quality.

### SUMMARY

The following presents a simplified summary of one or more aspects according to the present disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one aspect of the present disclosure, there is provided a method for decoding video data, comprising: obtaining a video block from a bitstream; obtaining internal luma sample values of the video block, external luma sample values of an external region of the video block and external chroma sample values of the external region; selecting, based on the external luma sample values and the external chroma sample values, one filter shape candidate from a plurality of filter shape candidates for predicting internal chroma sample values of the video block, wherein the plurality of filter shape candidates correspond to different sets of weighting coefficients for predicting chroma sample values based on corresponding luma sample values; predicting, with the selected filter shape candidate, the internal chroma sample values based on the internal luma sample values; and obtaining decoded video block using the predicted internal chroma sample values.

According to another aspect of the present disclosure, there is provided a method for encoding video data, comprising: obtaining a video block; obtaining internal luma sample values of the video block, external luma sample values of an external region of the video block and external chroma sample values of the external region; selecting, based on the external luma sample values and the external chroma sample values, one filter shape candidate from a plurality of filter shape candidates for predicting internal chroma sample values of the video block, wherein the plurality of filter shape candidates correspond to different sets of weighting coefficients for predicting chroma sample values based on corresponding luma sample values; predicting, with the selected filter shape candidate, the internal chroma sample values based on the internal luma sample values; and generating a bitstream comprising encoded video block by using the predicted internal chroma sample values.

According to another aspect of the present disclosure, there is provided another method for decoding video data, comprising: obtaining a video block from a bitstream; obtaining internal luma sample values of the video block, external luma sample values of an external region of the video block and external chroma sample values of the external region; determining, based on the external luma sample values and the external chroma sample values, a set of weighting coefficients corresponding to a filter shape, wherein the filter shape and the set of weighting coefficients are configured for predicting an chroma sample value based on a plurality of corresponding luma sample values, and wherein the set of weighting coefficients includes a weighting coefficient for a non-linear value derived by scaling the product of two of a plurality of corresponding luma sample values or a square of one of the plurality of corresponding luma sample values to a luma sample value range of the video block; predicting, with the filter shape and the set of weighting coefficients, the internal chroma sample values based on the internal luma sample values; and obtaining decoded video block using the predicted internal chroma sample values.

According to another aspect of the present disclosure, there is provided another method for encoding video data, comprising: obtaining a video block; obtaining internal luma sample values of the video block, external luma sample values of an external region of the video block and external chroma sample values of the external region; determining, based on the external luma sample values and the external chroma sample values, a set of weighting coefficients corresponding to a filter shape, wherein the filter shape and the set of weighting coefficients are configured for predicting an chroma sample value based on a plurality of corresponding luma sample values, and wherein the set of weighting coefficients includes a weighting coefficient for a non-linear value derived by scaling the product of two of a plurality of corresponding luma sample values or a square of one of the plurality of corresponding luma sample values to a luma sample value range of the video block; predicting, with the filter shape and the set of weighting coefficients, the internal chroma sample values based on the internal luma sample values; and generating a bitstream comprising encoded video block by using the predicted internal chroma sample values.

According to another aspect of the present disclosure, there is provided a computer system, comprising: one or more processors; and one or more storage devices storing computer-executable instructions that, when executed, cause the one or more processors to perform the operations of the method of the present disclosure.

According to another aspect of the present disclosure, there is provided a computer program product, storing computer-executable instructions that, when executed, cause one or more processors to perform the operations of the method of the present disclosure.

According to another aspect of the present disclosure, there is provided a computer readable medium, storing computer-executable instructions that, when executed, cause one or more processors to receive a bitstream and perform the operations of the method of the present disclosure based on the bitstream.

According to another aspect of the present disclosure, there is provided a computer readable medium, storing computer-executable instructions that, when executed, cause one or more processors to perform the operations of the method of the present disclosure and transmit a bitstream comprising encoded video information associated with the predicted chroma samples.

According to another aspect of the present disclosure, there is provided a computer readable medium storing a bitstream, wherein the bitstream is to be decoded by performing the operations of the method of the present disclosure.

According to another aspect of the present disclosure, there is provided a computer readable medium storing a bitstream, wherein the bitstream is obtained by performing the operations of the method of the present disclosure.

### BRIEF DESCRIPTION OF THE DRAWINGS

The disclosed aspects will hereinafter be described in connection with the appended drawings that are provided to illustrate and not to limit the disclosed aspects.

FIG. 1 illustrates a block diagram of a generic block-based hybrid video encoding system.

FIGS. 2A, 2B, 2C, 2D and 2E illustrate five splitting types, comprising quaternary partitioning, horizontal binary partitioning, vertical binary partitioning, horizontal ternary partitioning, and vertical ternary partitioning.

FIG. 3 illustrates a general block diagram of a block-based video decoder.

FIG. 4 illustrates an example of the locations of the left and above samples and the sample of the current block involved in the CCLM mode.

FIGS. 5A, 5B and 5C illustrate examples of deriving CCLM parameters.

FIG. 6 illustrates an example of classifying the neighboring samples into two groups based on the value Threshold.

FIG. 7 illustrates an example of classifying the neighboring samples into two groups based on a knee point.

FIGS. 8A and 8B illustrate the effect of the scale adjustment parameter “u”.

FIG. 8C illustrates the collocated reconstructed luma samples.

FIG. 8D illustrates the neighboring reconstructed samples.

FIGS. 8E, 8F and 8H illustrate the steps of decoder-side intra mode derivation.

FIG. 9 illustrates an example of four reference lines neighboring to a prediction block.

FIG. 10A illustrates an exemplary pattern for convolutional cross-component model (CCCM).

FIG. 10B illustrates an exemplary reference area which consists of 6 lines of chroma samples above and left of the PU.

FIGS. 10C and 10D illustrate schematic diagrams for correlation among a chroma sample and one or more luma samples.

FIG. 11 illustrates an example that 6-tap is used in multiple linear regression (MLR) model according to one or more aspects of the present disclosure.

FIG. 12 illustrates exemplary different filter shapes and/or numbers of taps according to one or more aspects of the present disclosure.

FIG. 13 illustrates an example in which FLM can only use top or left luma and/or chroma samples (extended) for parameter derivation.

FIG. 14 illustrates an example in which FLM can use different lines for parameter derivation.

FIGS. 15A, 15B, 15C and 15D illustrate some examples for 1-tap/2-tap pre-operations.

FIG. 16 illustrates examples of different shape/number of filter taps.

FIG. 17 illustrates examples of different shape/number of filter taps.

FIGS. 18A and 18B illustrate examples of different shape/number of filter taps.

FIGS. 19A, 19B, 19C, 19D, 19E, 19F and 19G illustrate examples of different set of filter taps.

FIG. 20A and FIG. 20B illustrate examples of 2-fold training for implicitly filter shape derivation.

FIG. 21 illustrates a workflow of a method for decoding video data according to one or more aspects of the present disclosure.

FIG. 22 illustrates a workflow of a method for encoding video data according to one or more aspects of the present disclosure.

FIG. 23 illustrates a workflow of another method for decoding video data according to one or more aspects of the present disclosure.

FIG. 24 illustrates a workflow of another method for encoding video data according to one or more aspects of the present disclosure.

FIG. 25 illustrates an exemplary computing system according to one or more aspects of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

The first version of the VVC standard was finalized in July, 2020, which offers approximately 50% bit-rate saving or equivalent perceptual quality compared to the prior generation video coding standard HEVC. Although the VVC standard provides significant coding improvements than its predecessor, there is evidence that superior coding efficiency can be achieved with additional coding tools. Recently, Joint Video Exploration Team (JVET) under the collaboration of ITU-T VCEG and ISO/IEC MPEG started the exploration of advanced technologies that can enable substantial enhancement of coding efficiency over VVC. In April 2021, one software codebase, called Enhanced Compression Model (ECM) was established for future video coding exploration work. The ECM reference software was based on VVC Test Model (VTM) that was developed by JVET for the VVC, with several existing modules (e.g., intra/inter prediction, transform, in-loop filter and so forth) are further extended and/or improved. In future, any new coding tool beyond the VVC standard need to be integrated into the ECM platform, and tested using JVET common test conditions (CTCs).

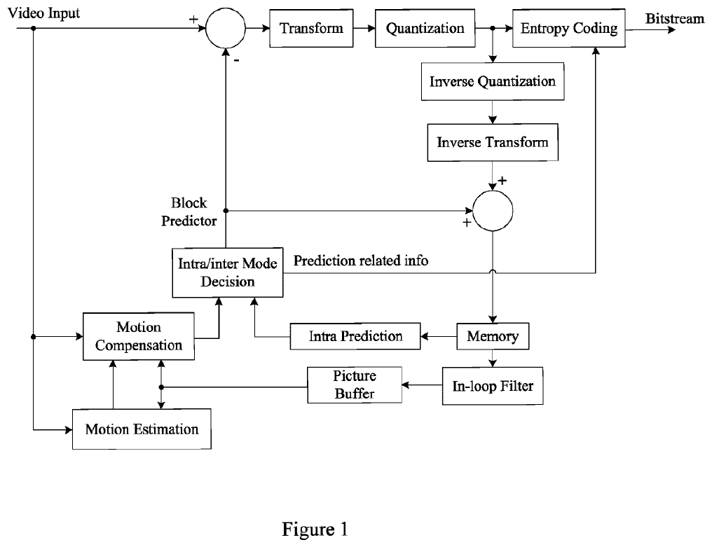

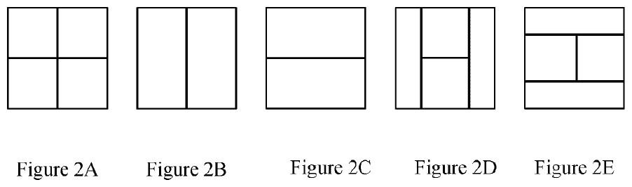

Similar to all the preceding video coding standards, the ECM is built upon the block-based hybrid video coding framework. FIG. 1 illustrates a block diagram of a generic block-based hybrid video encoding system. The input video signal is processed block by block (called coding units (CUs)). In ECM-1.0, a CU can be up to 128×128 pixels. However, same to the VVC, one coding tree unit (CTU) is split into CUs to adapt to varying local characteristics based on quad/binary/ternary-tree. In the multi-type tree structure, one CTU is firstly partitioned by a quad-tree structure. Then, each quad-tree leaf node can be further partitioned by a binary and ternary tree structure. As shown in FIGS. 2A, 2B, 2C, 2D, and 2E, there are five splitting types, quaternary partitioning, vertical binary partitioning, horizontal binary partitioning, vertical extended quaternary partitioning, and horizontal extended quaternary partitioning.

In FIG. 1, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes. After spatial and/or temporal prediction, the mode decision block in the encoder chooses the best prediction mode, for example based on the rate-distortion optimization method. The prediction block is then subtracted from the current video block; and the prediction residual is de-correlated using transform and quantized. The quantized residual coefficients are inverse quantized and inverse transformed to form the reconstructed residual, which is then added back to the prediction block to form the reconstructed signal of the CU. Further in-loop filtering, such as deblocking filter, sample adaptive offset (SAO) and adaptive in-loop filter (ALF) may be applied on the reconstructed CU before it is put in the reference picture store and used to code future video blocks. To form the output video bit-stream, coding mode (inter or intra), prediction mode information, motion information, and quantized residual coefficients are all sent to the entropy coding unit to be further compressed and packed to form the bit-stream. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g., a Coding Tree Block (CTB), a Coding Block (CB), a Prediction Block (PB) or a Transform Block (TB) and/or to a sub-block.

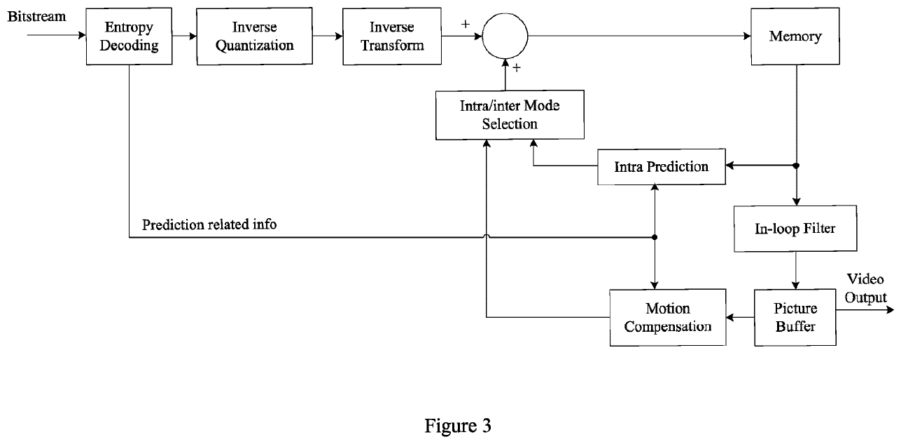

FIG. 3 illustrates a general block diagram of a block-based video decoder. The video bit-stream is first entropy decoded at entropy decoding unit. The coding mode and prediction information are sent to either the spatial prediction unit (if intra coded) or the temporal prediction unit (if inter coded) to form the prediction block. The residual transform coefficients are sent to inverse quantization unit and inverse transform unit to reconstruct the residual block. The prediction block and the residual block are then added together. The reconstructed block may further go through in-loop filtering before it is stored in reference picture store. The reconstructed video in reference picture store is then sent out to drive a display device, as well as used to predict future video blocks.

The main focus of this disclosure is to further enhance the coding efficiency of the coding tool of cross-component prediction, cross-component linear model (CCLM), that is applied in the ECM. In the following, some related coding tools in the ECM are briefly reviewed. After that, some deficiencies in the existing design of CCLM are discussed. Finally, the solutions are provided to improve the existing CCLM prediction design.

### Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , i ) + β \qquad ( 1 )$$

where pred_{C}(i,j) represents the predicted chroma samples in a CU, and rec_{L}′(i,j) represents the down-sampled reconstructed luma samples of the same CU which are obtained by performing down-sampling on the reconstructed luma samples rec_{L}(i, j). The above α and β are linear model parameters which are derived from at most four neighboring chroma samples and their corresponding down-sampled luma samples, which may be referred to as neighboring luma-chroma sample pairs. Suppose that a current chroma block has a size of W×H, then W′ and H′ are obtained as follows:
W′=W, H′=H when LM mode is applied;
W′=W+H when LM-A mode is applied;
H′=H+W when LM-L mode is applied;
   where in the LM mode, above samples and left samples of the CU are used together to calculate the linear model coefficients; in the LM_A mode, only the above samples of the CU are used to calculate the linear model coefficients; and in the LM_L mode, only the left samples of the CU are used to calculate the linear model coefficients.

If locations of above neighboring samples of a chroma block are denoted as S[0, −1] . . . S[W′−1, −1] and locations of left neighboring samples of the chroma block are denoted as S[−1, 0] . . . S[−1, H′−1], positions of four neighboring chroma samples are selected as follows:
S[W′/4, −1], S[3*W′/4, −1], S[−1, H′/4], S[−1, 3*H′/4] are selected as the positions of the four neighboring chroma samples when LM mode is applied and both above and left neighboring samples are available;
S[W′/8, −1], S[3*W′/8, −1], S[5*W′/8, −1], S[7*W′/8, −i] are selected as the positions of the four neighboring chroma samples when LM-A mode is applied or only the above neighboring samples are available;
S[−1, H′/8], S[−1, 3*H′/8], S[−1, 5*H′/8], S[−1, 7*H′/8] are selected as the positions of the four neighboring chroma samples when LM-L mode is applied or only the left neighboring samples are available.

The four neighboring luma samples corresponding to the selected locations are obtained by a down-sampling operation and the obtained four neighboring luma samples are compared four times to find two larger values: x⁰_{A} and x¹_{A}, and two smaller values: x⁰_{B} and x¹_{B}. Chroma sample values corresponding to the two larger values and the two smaller values are denoted as y⁰_{A}, y¹_{A}, y⁰_{B} and y¹_{B} respectively. Then Xₐ, X_{b}, Yₐ and Y_{b} are derived as:

$${Y}_{a} = ( {y}_{A}^{0} + {y}_{A}^{1} + 1 ) >> 1 ; \qquad ( 2 )$$

$${Y}_{b} = ( {y}_{B}^{0} + {y}_{B}^{1} + 1 ) >> 1$$

Finally, the linear model parameters α and β are obtained according to the following equations.

$$α = \frac{{Y}_{a} + {Y}_{b}}{{X}_{a} + {X}_{b}} \qquad ( 3 )$$

$$β = {Y}_{b} - α \cdot {X}_{b} \qquad ( 4 )$$

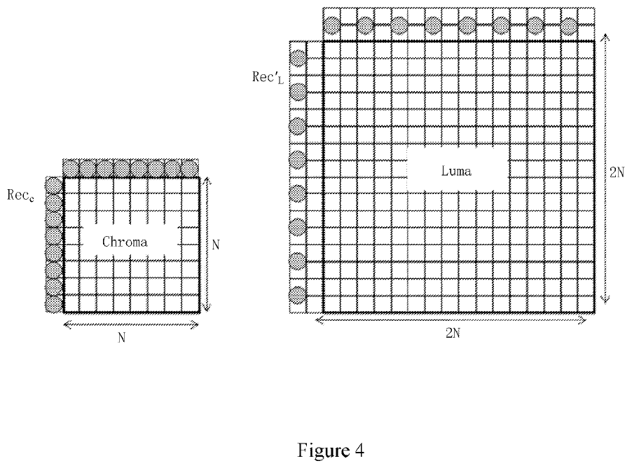

FIG. 4 illustrates an example of the locations of the left and above samples and the sample of the current block involved in the CCLM mode, including locations of left and above samples of an N×N chroma block in the CU and locations of left and above samples of an 2N×2N luma block in the CU.

The division operation to calculate parameter α is implemented with a look-up table. To reduce the memory required for storing the table, the diff value (difference between maximum and minimum values) and the parameter α are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables

Besides the above template and left template can be used to calculate the linear model coefficients together, they also can be used alternatively in the other 2 LM modes, called LM_A, and LM_L modes.

In LM_T mode, only the above template is used to calculate the linear model coefficients. To get more samples, the above template is extended to (W+H) samples. In LM_L mode, only left template is used to calculate the linear model coefficients. To get more samples, the left template is extended to (H+W) samples.

In LM_LT mode, left and above templates are used to calculate the linear model coefficients.

To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$$( 6 )$$

$${Rec}_{L}^{′} \text{} ( i , j ) = [ \begin{matrix}{rec}_{L} ( 2 i − 1 , 2 j − 1 ) + 2 \cdot {rec}_{L} ( 2 i , 2 j − 1 ) + {rec}_{L} ( 2 i + 1 , 2 j − 1 ) + \\ {rec}_{L} ( 2 i − 1 , 2 j ) + 2 \cdot {rec}_{L} ( 2 i , 2 j ) + {rec}_{L} ( 2 i + 1 , 2 j ) + 4\end{matrix} ] ≫ 3$$

$$( 7 )$$

$${rec}_{L}^{′} \text{} ( i , j ) = [ \begin{matrix}{rec}_{L} ( 2 i , 2 j − 1 ) + 2 \cdot {rec}_{L} ( 2 i - 1 , 2 j ) + 4 \cdot {rec}_{L} ( 2 i , 2 j ) + \\ {rec}_{L} ( 2 i − 1 , 2 j ) + {rec}_{L} ( 2 i , 2 j + 1 ) + 4\end{matrix} ] ≫ 3$$

Note that only one luma line (general line buffer in intra prediction) is used to make the down-sampled luma samples when the upper reference line is at the CTU boundary.

This parameter computation is performed as part of the decoding process, and is not just as an encoder search operation. As a result, no syntax is used to convey the α and β values to the decoder.

For chroma intra mode coding, a total of 8 intra modes are allowed for chroma intra mode coding. Those modes include five traditional intra modes and three cross-component linear model modes (CCLM, LM_A, and LM_L). Chroma mode signalling and derivation process are shown in Table 1. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 1
Derivation of chroma prediction mode
from luma mode when cclm is enabled

| | Corresponding luma intra prediction mode | | | | |
|---|---|---|---|---|---|
| Chroma prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2.

TABLE 2
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_A (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 2 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

During the ECM development, the simplified derivation of α and β (min-max approximation) is removed. Instead, linear least square solution between causal reconstructed data of down-sampled luma samples and causal chroma samples to derive model parameters α and β.

$$α = \frac{I \times {\sum }_{i = 0}^{I} R e {c}_{C} ( i ) \times {Rec}_{L}^{′} ( i ) - {\sum }_{i = 0}^{I} R e {c}_{C} ( i ) \times {\sum }_{i = 0}^{I} {Rec}_{L}^{′} ( i )}{I \times {\sum }_{i = 0}^{I} {Rec}_{L}^{′} ( i ) \times {Rec}_{L}^{′} ( i ) - {( {\sum }_{i = 0}^{I} {Rec}_{L}^{′} ( i ) )}^{2}} = \frac{{A}_{1}}{{A}_{2}} \qquad ( 8 )$$

$$β = \frac{{\sum }_{i = 0}^{I} R e {c}_{C} ( i ) - α \times {\sum }_{i = 0}^{I} {Rec}_{L}^{′} ( i )}{I} \qquad ( 9 )$$

where Rec_{C}(i) and Rec′_{L}(i) indicate reconstructed chroma samples and down-sampled reconstructed luma samples around the target block, I indicates total samples number of neighboring data.

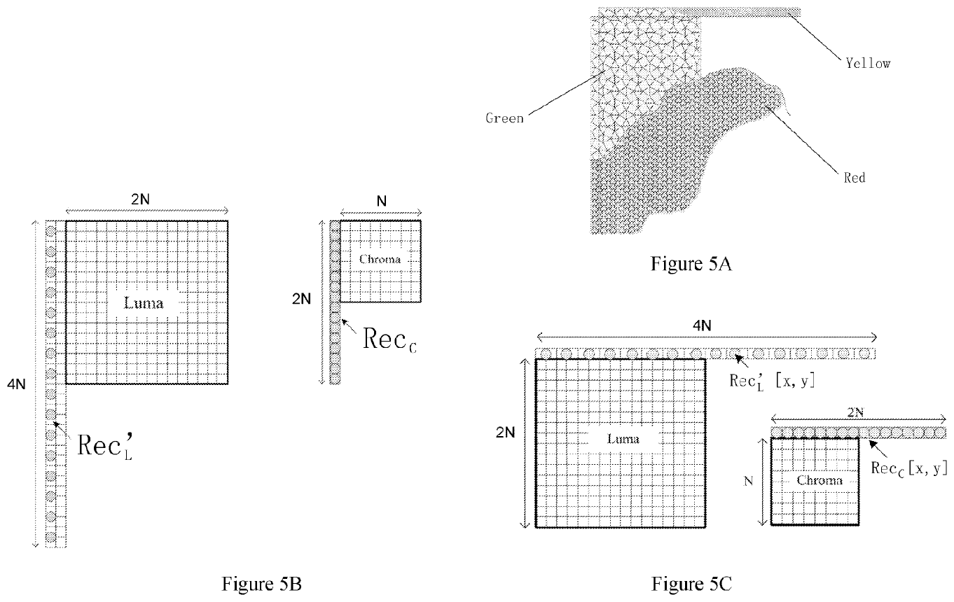

The LM_A, LM_L modes are also called Multi-Directional Linear Model (MDLM). FIG. 5A illustrates an example that MDLM works when the block content cannot be predicted from the L-shape reconstructed region. FIG. 5B illustrates MDLM_L which only uses left reconstructed samples to derive CCLM parameters. FIG. 5C illustrates MDLM_T which only uses top reconstructed samples to derive CCLM parameters.

Integerization for the above discussed Least Mean Square (LMS) (please refer to equations (8)-(9)) has been proposed as improvements for CCLM. The initial integerization design of LMS CCLM was firstly proposed in JCTVC-C206. The method was then improved by a series of simplification, including JCTVC-F0233/10178 which reduces α precision n_{α} from 13 to 7, JCTVC-I0151 which reduces the maximum multiplier bitwidth, and JCTVC-H0490/10166 which reduces division LUT entries from 64 to 32, finally leads to the ECM LMS version.

As discussed in equation (1), the integerization design utilizes the linear relationship to modelize the correlation of luma signal and chroma signal. The chroma values are predicted from reconstructed luma values of collocated block.

Luma and chroma components have different sampling ratios in YUV420 sampling. The sampling ratio of chroma components is half of that of luma component and has 0.5 pixel phase difference in vertical direction. Reconstructed luma needs down-sampling in vertical direction and subsample in horizontal direction to match size of chroma signal. For example, the down-sampling may be implemented by:

$${Rec}_{L}^{′} ( i , j ) = ( r e {c}_{L} ( 2 i , 2 j ) + r e {c}_{L} ( 2 i , 2 j + 1 ) ) >> 1 \qquad ( 10 )$$

Float point operation is necessary in equation (8) to calculate linear model parameters α to keep high data accuracy. And float point multiplication is involved in equation (1) when α is represented by float point value. In this section, the integer implementation of this algorithm is designed. Specifically, fractional part of parameter α is quantized with n_{α} bits data accuracy. Parameter a value is represented by an up-scaled and rounded integer value α′ and a′=a×(1<<n_{α}). Then the linear model of equation (1) is changed to:

$${pred}_{C} [ x , y ] = ( {α}^{′} \cdot {Rec}_{L}^{′} [ x , y ] >> {n}_{α} ) + {β}^{′} \qquad ( 11 )$$

Where β′ is the rounding value of float point β and α′ can be calculated as follows.

$${α}^{′} = a \cdot ( 1 << {n}_{α} ) = \frac{{A}_{1}}{{A}_{2}} \cdot ( 1 << {n}_{α} ) \qquad ( 12 )$$

It is proposed to replace division operation of equation (12) by table lookup and multiplication. A₂ is firstly de-scaled to reduce the table size. A₁ is also de-scaled to avoid product overflow. Then, in A₂ it is kept only most significant bits defined by n_{A}_{₂} value and others bits are put to zero. The approximate value A₂′ can be calculated as:

$${A}_{2}^{′} = [ {A}_{2} >> {r}_{{A}_{2}} ] \cdot {2}^{{r}_{{A}_{2}}} \qquad ( 13 )$$

Where [ . . . ] means rounding operation and r_{A}_{₂} can be calculated as:

$${r}_{{A}_{2}} = max ( bdepth ( {A}_{2} ) - {n}_{{A}_{2}} , 0 )$$

Where bdepth(A₂) means bit depth of value A₂.

Same operation is done for A₁, as follows:

$${A}_{1}^{′} = [ {A}_{1} >> {r}_{{A}_{1}} ] \cdot {2}^{{r}_{{A}_{1}}} \qquad ( 14 )$$

$${r}_{{A}_{1}} = max ( bdepth ( {A}_{1} ) - {n}_{{A}_{1}} , 0 )$$

Taking into account quantized representation of A₁ and A₂, equation (12) can be re-written as following.

$$( 15 )$$

$${α}^{′} \approx \frac{[ {A}_{1} >> {r}_{{A}_{1}} ] \cdot 2 \text{?}}{[ {A}_{2} >> {r}_{{A}_{2}} ] \cdot 2 \text{?}} \cdot 2 \text{?} = \frac{{2}^{{n}_{table}} \cdot [ {A}_{1} >> {r}_{{A}_{1}} ] \cdot {2}^{{r}_{{A}_{1}} + {n}_{α}}}{[ {A}_{2} >> {r}_{{A}_{2}} ] \cdot {2}^{{r}_{{A}_{2}} + {n}_{table}}} \approx [ \frac{{2}^{{n}_{table}}}{{A}_{2} >> {r}_{{A}_{2}}} ] \cdot [ {A}_{1} >> {r}_{{A}_{1}} ] \cdot {2}^{{r}_{{A}_{2}} + {n}_{α} − ( {r}_{{A}_{2}} + {n}_{table} )}$$

$$\text{?} \text{indicates text missing or illegible when filed}$$

### Where

$$[ \frac{{2}^{{n}_{table}}}{{A}_{2} >> {r}_{{A}_{2}}} ]$$

is represented as lookup table with length of

$${2}^{{n}_{{A}_{2}}}$$

to avoid the division.

In the simulation, the constant parameters are set as:
n_{α} equals to 13, which value is tradeoff between data accuracy and computational cost.
n_{A}_{₂} equals to 6, results in lookup table size as 64, table size can be further reduced to 32 by up-scaling A₂ when bdepth(A₂)<6 (e.g. A₂<32).
n_{table} equals to 15, results in 16 bits data representation of table elements.
n_{A}_{₁} is set as 15, to avoid product overflow and keep 16 bits multiplication.

In final, α′ is clipped to [−2⁻¹⁵, 2¹⁵−1], to remain 16 bits multiplication in equation (11). With this clipping, the actual a value is limited to −4,4) when n_{α} equals to 13, which is useful to prevent the error amplification.

With calculated parameter α′, parameter β′ is calculated as follows:

$${β}^{′} = \frac{{{\sum }_{i = 0}^{I}}_{} {Rec}_{C} ( i ) - ( {α}^{′} \cdot ( {\sum }_{i = 0}^{I} {Rec}_{L}^{′} ( i ) ) >> {n}_{α} )}{I} \qquad ( 16 )$$

Wherein the division of above equation can be simply replaced by shift, since value I is power of 2.

Similar as discussed above with regard to equation (1), in HM6.0, an intra prediction mode called LM is applied to predict chroma PU based on a linear model using the reconstruction of the collocated luma PU. The parameters of the linear model consist of slope (a>>k) and y-intercept (b), which are derived from the neighboring luma and chroma pixels using the least mean square solution. The values of the prediction samples predSamples[x,y], with x,y=0 . . . nS−1, where nS specifies the block size of the current chroma PU, are derived as follows:

$$predSamples [ x , y ] = Clip {1}_{C} ( ( ( {p}_{Y}^{′} [ x , y ] ⋆ a ) >> k ) + b ) , with x , y = 0 … nS - 1 \qquad ( 17 )$$

where P_{Y}′[x,y] is the reconstructed pixels from the corresponding luma component. When the coordinates x and y are equal to or larger than 0, P_{Y}′ is the reconstructed pixel from the co-located luma PU. When x or y is less than 0, P_{Y}′ is the reconstructed neighboring pixel of the co-located luma PU.

Some intermediate variables in the derivation process, L, C, LL, LC, k2 and k3, are derived as:

$$L = ( {\sum }_{y = 0}^{n S - 1} {p}_{Y}^{′} [ - 1 , y ] + {\sum }_{x = 0}^{n S - 1} {p}_{Y}^{′} [ x , - 1 ] ) >> k 3 \qquad ( 18 - 1 )$$

$$C = ( {\sum }_{y = 0}^{n S - 1} p [ - 1 , y ] + {\sum }_{x = 0}^{n S - 1} p [ x , - 1 ] ) >> k 3 \qquad ( 18 - 2 )$$

$$LL = ( {\sum }_{y = 0}^{n S - 1} {{p}_{Y}^{′} [ - 1 , y ]}^{2} + {\sum }_{x = 0}^{n S - 1} {{p}_{Y}^{′} [ x , - 1 ]}^{2} ) >> k 3 \qquad ( 18 - 3 )$$

$$( 18 - 4 )$$

$$LC = ( {\sum }_{y = 0}^{n S - 1} {p}_{Y}^{′} [ - 1 , y ] * p [ - 1 , y ] + {\sum }_{y = 0}^{n S - 1} {p}_{Y}^{′} [ x , - 1 ] * p [ x , - 1 ] ) >> k 3$$

$$k 2 = Log 2 ( ( 2 ⋆ nS ) >> k 3 ) \qquad ( 18 - 5 )$$

$$k 3 = Max ( 0 , BitDepth + Log 2 ( nS ) - 14 ) \qquad ( 18 - 6 )$$

Therefore, variables a, b and k can be derived as:

$$a 1 = ( LC << k 2 ) - L ⋆ C \qquad ( 19 - 1 )$$

$$a 2 = ( LL << k 2 ) - L ⋆ L \qquad ( 19 - 2 )$$

$$k 1 = Max ( 0 , Log 2 ( abs ( a 2 ) ) - 5 ) - Max ( 0 , Log 2 ( abs ( a 1 ) ) - 14 ) + 2 \qquad ( 19 - 3 )$$

$$a 1 s = a 1 >> Max ( 0 , Log 2 ( abs ( a 1 ) ) - 14 ) \qquad ( 19 - 4 )$$

$$a 2 s = abs ( a 2 >> Max ( 0 , Log 2 ( abs ( a 2 ) ) - 5 ) ) \qquad ( 19 - 5 )$$

$$( 19 - 6 )$$

$$a 3 = a 2 s < 1 ? 0 : Clip 3 ( - {2}^{15} , {2}^{15} - 1 , a 1 s ⋆ lmDiv + ( 1 << ( k 1 - 1 ) ) >> k 1 )$$

$$a = a 3 >> Max ( 0 , Log 2 ( abs ( a 3 ) ) - 6 ) \qquad ( 19 - 7 )$$

$$k = 13 - Max ( 0 , Log 2 ( abs ( a ) ) - 6 ) \qquad ( 19 - 8 )$$

$$b = ( L - ( ( a ⋆ C ) >> k 1 ) + ( 1 << ( k 2 - 1 ) ) ) >> k 2 , \qquad ( 19 - 9 )$$

where lmDiv is specified in a 63-entry look-up table, i.e. Table 3, which is online generated by:

$$lm Div ( a 2 s ) = ( ( 1 << 15 ) + a 2 s / 2 ) / a 2 s . \qquad ( 20 )$$

TABLE 3
Specification of lmDiv

| | a2s | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| lmDiv | 32768 | 16384 | 10923 | 8192 | 6554 | 5461 | 4681 | 4096 | 3641 | 3277 | 2979 | 2731 | 2521 |

| | a2s | | | | | | | | | | | | |
|---|---|---|---|---|---|---|---|---|---|---|---|---|---|
| | 14 | 15 | 16 | 17 | 18 | 19 | 20 | 21 | 22 | 23 | 24 | 25 | 26 |
| lmDiv | 2341 | 2185 | 2048 | 1928 | 1820 | 1725 | 1638 | 1560 | 1489 | 1425 | 1365 | 1311 | 1260 |
| | a2s | | | | | | | | | | | | |
| | 27 | 28 | 29 | 30 | 31 | 32 | 33 | 34 | 35 | 36 | 37 | 38 | 39 |
| lmDiv | 1214 | 1170 | 1130 | 1092 | 1057 | 1024 | 993 | 964 | 936 | 910 | 886 | 862 | 840 |
| | a2s | | | | | | | | | | | | |
| | 40 | 41 | 42 | 43 | 44 | 45 | 46 | 47 | 48 | 49 | 50 | 51 | 52 |
| lmDiv | 819 | 799 | 780 | 762 | 745 | 728 | 712 | 697 | 683 | 669 | 655 | 643 | 630 |

| | a2s | | | | | | | | | | | |
|---|---|---|---|---|---|---|---|---|---|---|---|---|
| | 53 | 54 | 55 | 56 | 57 | 58 | 59 | 60 | 61 | 62 | 63 | 64 |
| lmDiv | 618 | 607 | 596 | 585 | 575 | 565 | 555 | 546 | 537 | 529 | 520 | 512 |

In Equation (19-6), a1s is a 16-bit signed integer and hmDiv is a 16-bit unsigned integer. Therefore, 16-bit multiplier and 16-bit storage are needed. It is proposed to reduce the bit depth of multipliers to the internal bit depth, as well as the size of the look-up table, as detailed below.

The bit depth of a1s is reduced to the internal bit depth by changing equation (19-4) as:

$$a 1 s = a 1 >> Max ( 0 , Log 2 ( abs ( a 1 ) ) - ( {BitDepth}_{C} - 2 ) ) . \qquad ( 21 )$$

The values of lmDiv with the internal bit depth are achieved with the following equation (22) and stored in the look-up table:

$$l m D i v ( a 2 s ) = ( ( 1 << ( {BitDepth}_{C} - 1 ) ) + a 2 s / 2 ) / a 2 s . \qquad ( 22 )$$

Table 4 shows the example of internal bit depth 10.

TABLE 4
Specification of lmDiv with the internal bit depth equal to 10

| | a2s | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| lmDiv | 512 | 256 | 171 | 128 | 102 | 85 | 73 | 64 | 57 | 51 | 47 | 43 | 39 | 37 | 34 | 32 |

| | a2s | | | | | | | | | | | | | | | |
|---|---|---|---|---|---|---|---|---|---|---|---|---|---|---|---|---|
| | 17 | 18 | 19 | 20 | 21 | 22 | 23 | 24 | 25 | 26 | 27 | 28 | 29 | 30 | 31 | 32 |
| lmDiv | 30 | 28 | 27 | 26 | 24 | 23 | 22 | 21 | 20 | 20 | 19 | 18 | 18 | 17 | 17 | 16 |
| | a2s | | | | | | | | | | | | | | | |
| | 33 | 34 | 35 | 36 | 37 | 38 | 39 | 40 | 41 | 42 | 43 | 44 | 45 | 46 | 47 | 48 |
| lmDiv | 16 | 15 | 15 | 14 | 14 | 13 | 13 | 13 | 12 | 12 | 12 | 12 | 11 | 11 | 11 | 11 |

| | a2s | | | | | | | | | | | | | | |
|---|---|---|---|---|---|---|---|---|---|---|---|---|---|---|---|
| | 49 | 50 | 51 | 52 | 53 | 54 | 55 | 56 | 57 | 58 | 59 | 60 | 61 | 62 | 63 |
| lmDiv | 10 | 10 | 10 | 10 | 10 | 9 | 9 | 9 | 9 | 9 | 9 | 9 | 8 | 8 | 8 |

Modifications are also made to Equation (19-3) and (19-8) as below:

$$k 1 = Max ( 0 , Log 2 ( a b s ( a 2 ) ) - 5 ) - M a x ( 0 , Log 2 ( abs ( a 1 ) ) - ( {BitDepth}_{C} - 2 ) ) , \qquad ( 23 - 1 )$$

$$and$$

$$k = {BitDepth}_{C} - 1 - M a x ( 0 , Log 2 ( a b s ( a ) ) - 6 ) . \qquad ( 23 - 2 )$$

It is also proposed to reduce the entries from 63 to 32, and the bits for each entry from 16 to 10, as shown in Table 5. By doing this, almost 70% memory saving can be achieved. The corresponding changes for equation (19-6), equation (20) and equation (19-8) are as follows:

$$a 3 = a 2 s < 32 ? 0 : Clip 3 ( - {2}^{15} , {2}^{15} - 1 , a 1 s ⋆ lmDiv + ( 1 << ( k 1 - 1 ) ) >> k 1 ) \qquad ( 24 - 1 )$$

$$lmDiv ( a 2 s ) = ( ( 1 << ( {BitDepth}_{C} + 4 ) ) + a 2 s / 2 ) / a 2 s \qquad ( 24 - 2 )$$

$$k = {BitDepth}_{C} + 4 - Max ( 0 , Log 2 ( abs ( a ) ) - 6 ) . \qquad ( 24 - 3 )$$

TABLE 5
Specification of lmDiv with the internal bit depth equal to 10

| | a2s | | | | | | | | | | | | | | | |
|---|---|---|---|---|---|---|---|---|---|---|---|---|---|---|---|---|
| | 32 | 33 | 34 | 35 | 36 | 37 | 38 | 39 | 40 | 41 | 42 | 43 | 44 | 45 | 46 | 47 |
| lmDiv | 512 | 496 | 482 | 468 | 455 | 443 | 431 | 420 | 410 | 400 | 390 | 381 | 372 | 364 | 356 | 349 |
| | a2s | | | | | | | | | | | | | | | |
| | 48 | 49 | 50 | 51 | 52 | 53 | 54 | 55 | 56 | 57 | 58 | 59 | 60 | 61 | 62 | 63 |
| lmDiv | 341 | 334 | 328 | 321 | 315 | 309 | 303 | 298 | 293 | 287 | 282 | 278 | 273 | 269 | 264 | 260 |

### Multi-Model Linear Model Prediction

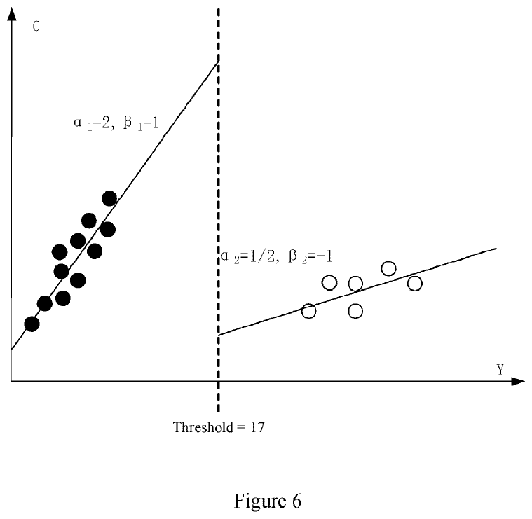

In ECM-1.0, Multi-model LM (MMLM) prediction mode is proposed, for which the chroma samples are predicted based on the reconstructed luma samples of the same CU by using two linear models as follows:

$$\{ \begin{matrix}{pred}_{C} ( i , j ) = {α}_{1} \cdot {rec}_{L}^{′} ( i , j ) + {β}_{1} if {rec}_{L}^{′} ( i , j ) \leq Threshold \\ {pred}_{C} ( i , j ) = {α}_{2} \cdot {rec}_{L}^{′} ( i , j ) + {β}_{2} if {rec}_{L}^{′} ( i , j ) > Threshold\end{matrix} \qquad ( 25 )$$

where pred_{C}(i, j) represents the predicted chroma samples in a CU and rec_{L}′(i, j) represents the down-sampled reconstructed luma samples of the same CU. Threshold is calculated as the average value of the neighboring reconstructed luma samples. FIG. 6 illustrates an example of classifying the neighboring samples into two groups based on the value Threshold. For each group, parameter αᵢ and βᵢ, with i equal to 1 and 2 respectively, are derived from the straight-line relationship between luma values and chroma values from two samples, which are minimum luma sample A (X_{A}, Y_{A}) and maximum luma sample B (X_{B}, Y_{B}) inside the group. Here X_{A}, Y_{A} are the x-coordinate (i.e., luma value) and y-coordinate (i.e., chroma value) value for sample A, and X_{B}, Y_{B} are the x-coordinate and y-coordinate value for sample B. The linear model parameters α and β are obtained according to the following equations.

$$α = \frac{{y}_{B} − {y}_{A}}{{x}_{B} − {x}_{A}} \qquad ( 26 )$$

$$β = {y}_{A} − α {x}_{A}$$

Such a method is also called min-max method. The division in the equation above could be avoided and replaced by a multiplication and a shift.

For a coding block with a square shape, the above two equations are applied directly. For a non-square coding block, the neighboring samples of the longer boundary are first subsampled to have the same number of samples as for the shorter boundary.

Besides the scenario wherein the above template and the left template are used together to calculate the linear model coefficients, the two templates also can be used alternatively in the other two MMLM modes, called MMLM_A, and MMLM_L modes.

In MMLM_A mode, only pixel samples in the above template are used to calculate the linear model coefficients. To get more samples, the above template is extended to the size of (W+W). In MMLM_L mode, only pixel samples in the left template are used to calculate the linear model coefficients. To get more samples, the left template is extended to the size of (H+H).

Note that when the upper reference line is at the CTU boundary, only one luma row (which is stored in line buffer for intra prediction) is used to make the down-sampled luma samples.

For chroma intra mode coding, a total of 11 intra modes are allowed for chroma intra mode coding. Those modes include five traditional intra modes and six cross-component linear model modes (CCLM, LM_A, LM_L, MMLM, MMLM_A and MMLM_L). Chroma mode signaling and derivation process are shown in Table 6. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 6
Derivation of chroma prediction mode
from luma mode when MMLM_is enabled

| | Corresponding luma intra prediction mode | | | | |
|---|---|---|---|---|---|
| Chroma prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 81 | 81 | 81 | 81 | 81 |
| 5 | 82 | 82 | 82 | 82 | 82 |
| 6 | 83 | 83 | 83 | 83 | 83 |
| 7 | 84 | 84 | 84 | 84 | 84 |
| 8 | 85 | 85 | 85 | 85 | 85 |
| 9 | 86 | 86 | 86 | 86 | 86 |
| 10 | 0 | 50 | 18 | 1 | X |

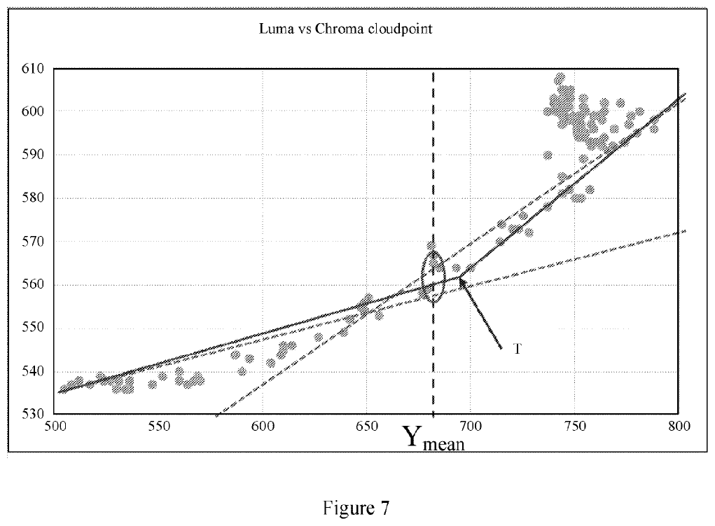

MMLM and LM modes may also be used together in an adaptive manner. For MMLM, two linear models are as follows:

$$\{ \begin{matrix}{pred}_{C} ( i , j ) = {α}_{1} \cdot {rec}_{L}^{′} ( i , j ) + {β}_{1} if {rec}_{L} ( i , j ) \leq Threshold \\ {pred}_{C} ( i , j ) = {α}_{2} \cdot {rec}_{L}^{′} ( i , j ) + {β}_{2} if {rec}_{L} ( i , j ) > Threshold\end{matrix} \qquad ( 27 )$$

where pred_{C}(i, j) represents the predicted chroma samples in a CU and rec_{L}′(i, j) represents the down-sampled reconstructed luma samples of the same CU. Threshold can be simply determined based on the luma and chroma average values together with their minimum and maximum values. FIG. 7 shows an example of classifying the neighboring samples into two groups based on the knee point, T, indicated by an arrow. Linear model parameter α₁ and β₁ are derived from the straight-line relationship between luma values and chroma values from two samples, which are minimum luma sample A (X_{A}, Y_{A}) and the Threshold (X_{T}, Y_{T}). Linear model parameter α₂ and β₂ are derived from the straight-line relationship between luma values and chroma values from two samples, which are maximum luma sample B (X_{B}, Y_{B}) and the Threshold (X_{T}, Y_{T}). Here X_{A}, Y_{A} are the x-coordinate (i.e., luma value) and y-coordinate (i.e., chroma value) value for sample A, and X_{B}, Y_{B} are the x-coordinate and y-coordinate value for sample B. The linear model parameters αᵢ and βᵢ for each group, with i equal to 1 and 2 respectively, are obtained according to the following equations.

$${α}_{1} = \frac{{Y}_{T} - {Y}_{A}}{{X}_{T} - {X}_{A}} \qquad ( 28 )$$

$${β}_{1} = {Y}_{A} - {α}_{1} {X}_{A}$$

$${α}_{2} = \frac{{Y}_{B} - {Y}_{T}}{{X}_{B} - {X}_{T}}$$

$${β}_{2} = {Y}_{T} - {α}_{2} {X}_{T}$$

For a coding block with a square shape, the above equations are applied directly. For a non-square coding block, the neighboring samples of the longer boundary are first subsampled to have the same number of samples as for the shorter boundary.

Besides the scenario wherein the above template and the left template are used together to determine the linear model coefficients, the two templates also can be used alternatively in the other two MMLM modes, called MMLM_A, and MMLM_L modes respectively.

In MMLM_A mode, only pixel samples in the above template are used to calculate the linear model coefficients. To get more samples, the above template is extended to the size of (W+W). In MMLM_L mode, only pixel samples in the left template are used to calculate the linear model coefficients. To get more samples, the left template is extended to the size of (H+H).

Note that when the upper reference line is at the CTU boundary, only one luma row (which is stored in line buffer for intra prediction) is used to make the down-sampled luma samples.

For chroma intra mode coding, there is a condition check used to select LM modes (CCLM, LM_A, and LM_L) or multi-model LM modes (MMLM, MMLM_A, and MMLM_L). The condition check is as follows:

$$\{ \begin{matrix}LM modes if ( ( ( {Y}_{T} - {Y}_{A} ) \leq d ‖ ( {Y}_{B} - {Y}_{T} ) \leq d \& ( block area \geq {BlkSizeThres}_{L M} ) ) \\ MMLM modes if ( ( ( {Y}_{T} - {Y}_{A} ) > d \& \& ( {Y}_{B} - {Y}_{T} ) > d ) \& ( block area \geq {BlkSizeThres}_{M M} ) )\end{matrix} \qquad ( 29 )$$

where BlkSizeThres_{LM} represents the smallest block size of LM modes and BlkSizeThres_{MM} represents the smallest block size of MMLM modes. The symbol d represents a pre-determined threshold value. In one example, d may take a value of 0. In another example, d may take a value of 8.

For chroma intra mode coding, a total of 8 intra modes are allowed for chroma intra mode coding. Those modes include five traditional intra modes and three cross-component linear model modes. Chroma mode signaling and derivation process are shown in Table 1. It is worth noting that for a given CU, if it is coded under linear model mode, whether it is a conventional single model LM mode or a MMLM mode is determined based on the condition check above. Unlike the case shown in Table 6, there are no separate MMLM modes to be signaled. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

During ECM development, scale (slope) adjustment for CCLM are proposed as further improvements, for example, as described in JVET-Y0055/Z0049.

As discussed above, CCLM uses a model with 2 parameters to map luma values to chroma values. The scale parameter “a” and the bias parameter “b” define the mapping as follows:

$$chroma Val = a ⋆ luma Val + b \qquad ( 30 )$$

It is proposed to signal an adjustment “u” to the scale parameter to update the model to the following form:

$$chroma Val = {a}^{′} ⋆ luma Val + {b}^{′} \qquad ( 31 )$$

where a′=a+u, and b′=b−u*yᵣ.

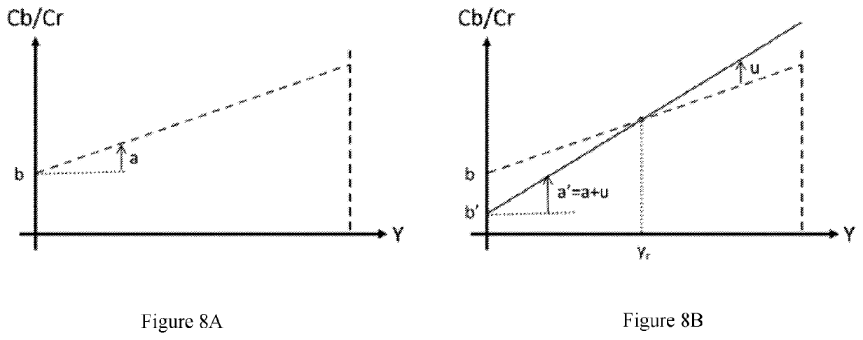

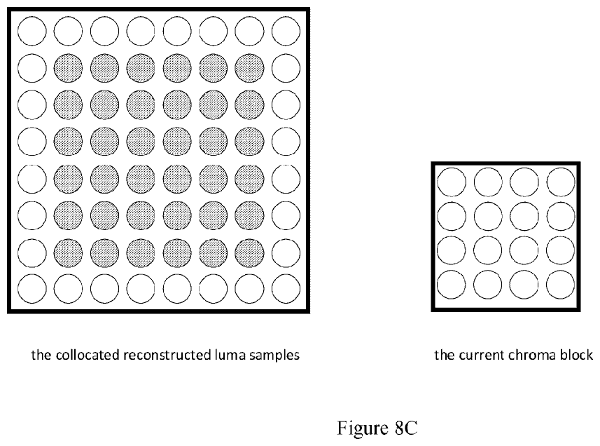

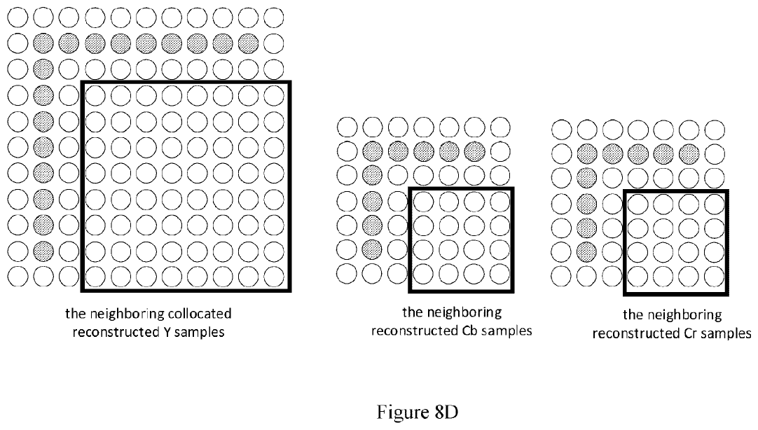

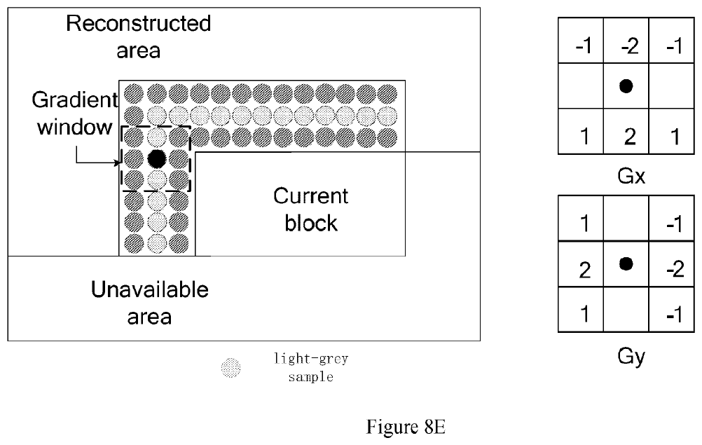

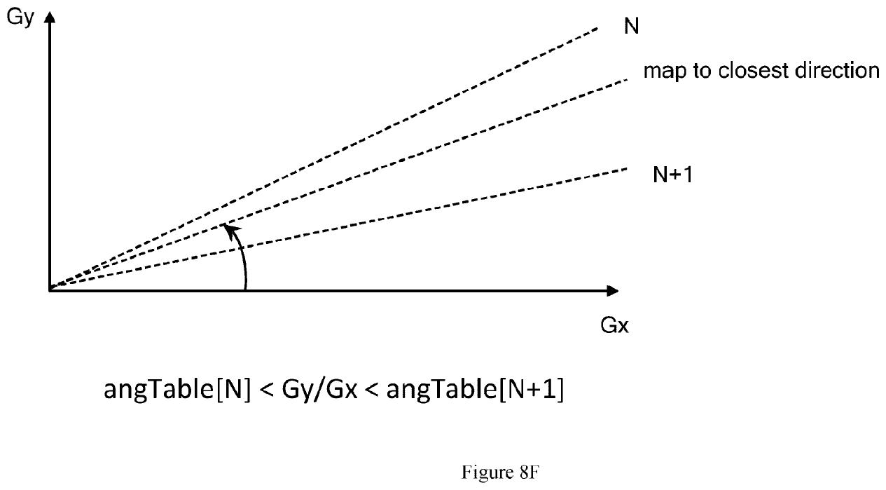

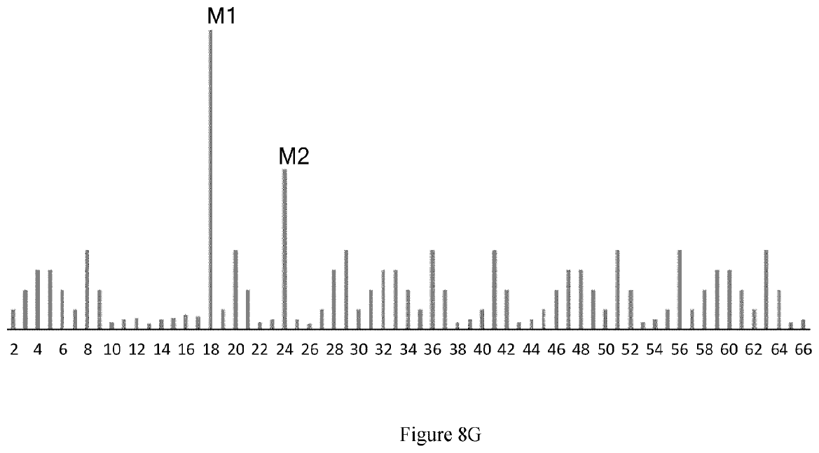

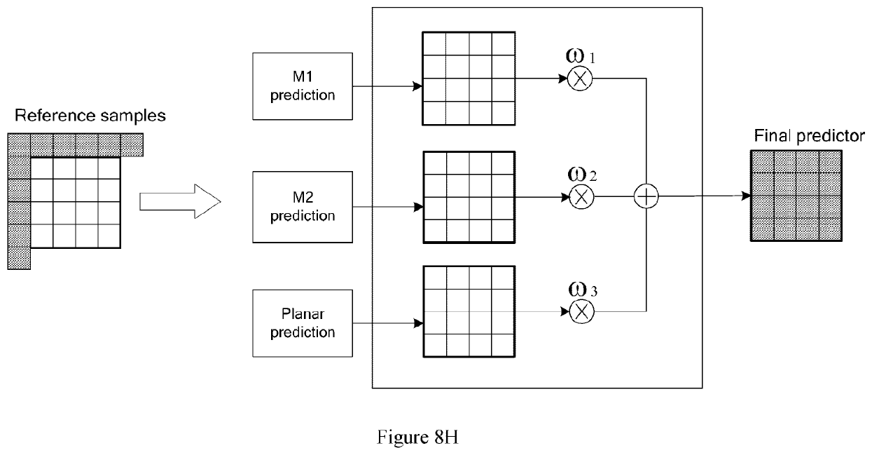

With this selection, the mapping function is tilted or rotated around the point with luminance value yᵣ. It is proposed to use the average of the reference luma samples used in the model creation as yᵣ in order to provide a meaningful modification to the model. FIGS. 8A to 8B illustrate the effect of the scale adjustment parameter “u”, wherein FIG. 8A illustrates the model created without the scale adjustment parameter “u”, and FIG. 8B illustrates the model created with the scale adjustment parameter “u”.

In one example, the scale adjustment parameter is provided as an integer between −4 and 4, inclusive, and signaled in the bitstream. The unit of the scale adjustment parameter is ⅛th of a chroma sample value per one luma sample value (for 10-bit content).

In one example, adjustment is available for the CCLM models that are using reference samples both above and left of the block (“LM_CHROMA_IDX” and “MMLM_CHROMA_IDX”), but not for the “single side” modes. This selection is based on coding efficiency vs. complexity trade-off considerations.

When scale adjustment is applied for a multimode CCLM model, both models can be adjusted and thus up to two scale updates are signaled for a single chroma block.

To enable the scale adjustment at the encoder, the encoder may perform an SATD based search for the best value of the scale update for Cr and a similar SATD based search for Cb. If either one results as a non-zero scale adjustment parameter, the combined scale adjustment pair (SATD based update for Cr, SATD based update for Cb) is included in the list of RD checks for the TU.

### The Fusion of Chroma Intra Prediction Modes

During ECM development, JVET-Y0092/Z0051 proposed fusion of chroma intra modes.

The intra prediction modes enabled for the chroma components in ECM-4.0 are six cross-component linear model (LM) modes including CCLM_LT, CCLM_L, CCLM_T, MMLM_LT, MMLM_L and MMLM_T modes, the direct mode (DM), and four default chroma intra prediction modes. The four default modes are given by the list {0, 50, 18, 1} and if the DM mode already belongs to that list, the mode in the list will be replaced with mode 66.

A decoder-side intra mode derivation (DIMD) method for luma intra prediction is included in ECM-4.0. First, a horizontal gradient and a vertical gradient are calculated for each reconstructed luma sample of the L-shaped template of the second neighboring row and column of the current block to build a Histogram of Gradients (HoG). Then, the two intra prediction modes with the largest and the second largest histogram amplitude values are blended with the Planar mode to generate the final predictor of the current luma block.

In order to improve the coding efficiency of chroma intra prediction, two methods are proposed, including a decoder-side derived chroma intra prediction mode (DIMD chroma) and a fusion of a non-LM mode and the MMLM_LT mode.

In a first embodiment, a DIMD chroma mode is proposed. The proposed DIMD chroma mode uses the DIMD derivation method to derive the chroma intra prediction mode of the current block based on the collocated reconstructed luma samples. Specifically, a horizontal gradient and a vertical gradient are calculated for each collocated reconstructed luma sample of the current chroma block to build a HoG, as shown in FIG. 8C. Then the intra prediction mode with the largest histogram amplitude values is used for performing chroma intra prediction of the current chroma block.

When the intra prediction mode derived from the DIMD chroma mode is the same as the intra prediction mode derived from the DM mode, the intra prediction mode with the second largest histogram amplitude value is used as the DIMD chroma mode.

A CU level flag is signaled to indicate whether the proposed DIMD chroma mode is applied as shown in Table 7.

TABLE 7
The binarization process for
intra_chroma_pred_mode in the
proposed method

| | bin | chroma intra |
|---|---|---|
| intra_chroma_pred_mode | string | mode |
| 0 | 1100 | list[0] |
| 1 | 1101 | list[1] |
| 2 | 1110 | list[2] |
| 3 | 1111 | list[3] |
| 4 | 10 | DIMD chroma |
| 5 | 0 | DM |

In a second embodiment, a fusion of chroma intra prediction modes is proposed, wherein the DM mode and the four default modes can be fused with the MMLM_LT mode as follows:

$$pred = ( w 0 * pred 0 + w 1 * pred 1 + ( 1 << ( shift - 1 ) ) ) >> shift$$

where pred0 is the predictor obtained by applying the non-LM mode, pred1 is the predictor obtained by applying the MMLM_LT mode and pred is the final predictor of the current chroma block. The two weights, w0 and w1 are determined by the intra prediction mode of adjacent chroma blocks and shift is set equal to 2. Specifically, when the above and left adjacent blocks are both coded with LM modes, {w0, w1}={1, 3}; when the above and left adjacent blocks are both coded with non-LM modes, {w0,w1}={3, 1}; otherwise, {w0,w1}={2, 2}.

For the syntax design, if a non-LM mode is selected, one flag is signaled to indicate whether the fusion is applied. And the proposed fusion is only applied to I slices.

In a third embodiment, the DIMD chroma mode and the fusion of chroma intra prediction modes are combined. Specifically, the DIMD chroma mode described in the first embodiment is applied, and for I slices, the DM mode, the four default modes and the DIMD chroma mode can be fused with the MMLM_LT mode using the weights described in the second embodiment, while for non-I slices, only the DIMD chroma mode can be fused with the MMLM_LT mode using equal weights.

In a fourth embodiment, the DIMD chroma mode with reduced processing and the fusion of chroma intra prediction modes are combined. Specifically, the DIMD chroma mode with reduced processing derives the intra mode based on the neighboring reconstructed Y, Cb and Cr samples in the second neighboring row and column as shown in FIG. 8D. Other parts are the same as the third embodiment.

In one embodiment, when DIMD is applied, two intra modes are derived from the reconstructed neighbor samples, and those two predictors are combined with the planar mode predictor with the weights derived from the gradients as described in JVET-00449. The division operations in weight derivation is performed utilizing the same lookup table (LUT) based integerization scheme used by the CCLM. For example, the division operation in the orientation calculation

$$Orient = {G}_{y} / {G}_{x}$$

is computed by the following LUT-based scheme:

$$x = Floor ( Log 2 ( G x ) )$$

$$normDiff = ( ( Gx << 4 ) >> x ) \& 15$$

$$x += ( 3 + ( normDiff != 0 ) ? 1 : 0 )$$

$$Orient = Gy ⋆ ( DivSigTable [ normDiff ] \vert 8 + ( 1 << ( x - 1 ) ) ) >> x$$

where

### DivSigTable[16]={0, 7, 6, 5, 5, 4, 4, 3, 3, 2, 2, 1, 1, 1, 1, 0}.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

FIGS. 8E to 8H illustrate the steps of decoder-side intra mode derivation, wherein intra prediction direction is estimated without intra mode signaling. The first step as shown in FIG. 8E includes estimating gradient per sample (for light-grey samples as illustrated in FIG. 8E). The second step as shown in FIG. 8F includes mapping gradient values to closest prediction direction within [2,66]. The third step as shown in FIG. 8G includes selecting 2 prediction directions, wherein for each prediction direction, all absolute gradients Gx and Gy of neighboring pixels with that direction are summed up, and top 2 directions are selected. The fourth step as shown in FIG. 8H includes enabling weighted intra prediction with the selected directions.

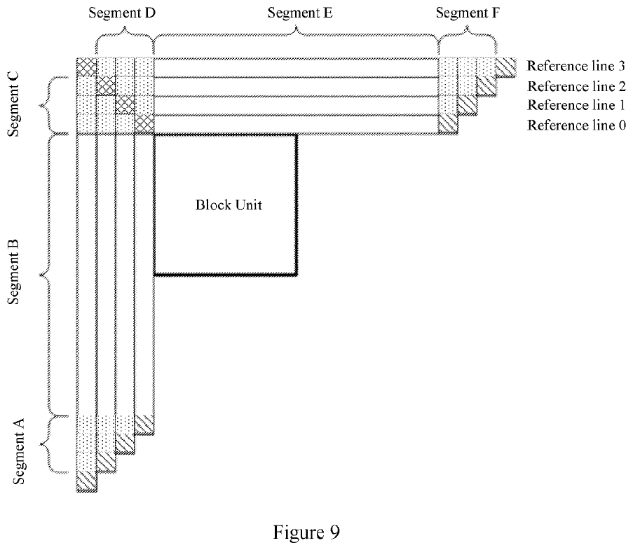

Multiple reference line (MRL) intra prediction uses more reference lines for intra prediction. In FIG. 9, an example of 4 reference lines is depicted, where the samples of segments A and F are not fetched from reconstructed neighboring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signaled and used to generate intra predictor. For reference line idx, which is greater than 0, only include additional reference line modes in MPM list and only signal mpm index without remaining mode. The reference line index is signaled before intra prediction modes, and Planar mode is excluded from intra prediction modes in case a nonzero reference line index is signaled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices is aligned with that of reference line index 0. MRL requires the storage of 3 neighboring luma reference lines with a CTU to generate predictions. The Cross-Component Linear Model (CCLM) tool also requires 3 neighboring luma reference lines for its down-sampling filters. The definition of MRL to use the same 3 lines is aligned as CCLM to reduce the storage requirements for decoders.

During ECM development, a convolutional cross-component model (CCCM) of chroma intra modes is proposed.

It is proposed to apply convolutional cross-component model (CCCM) to predict chroma samples from reconstructed luma samples in a similar spirit as done by the current CCLM modes. As with CCLM, the reconstructed luma samples are down-sampled to match the lower resolution chroma grid when chroma sub-sampling is used.

Also, similarly to CCLM, there is an option of using a single model or multi-model variant of CCCM. The multi-model variant uses two models, one model derived for samples above the average luma reference value and another model for the rest of the samples (following the spirit of the CCLM design). Multi-model CCCM mode can be selected for PUs which have at least 128 reference samples available.

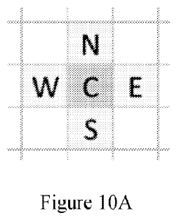

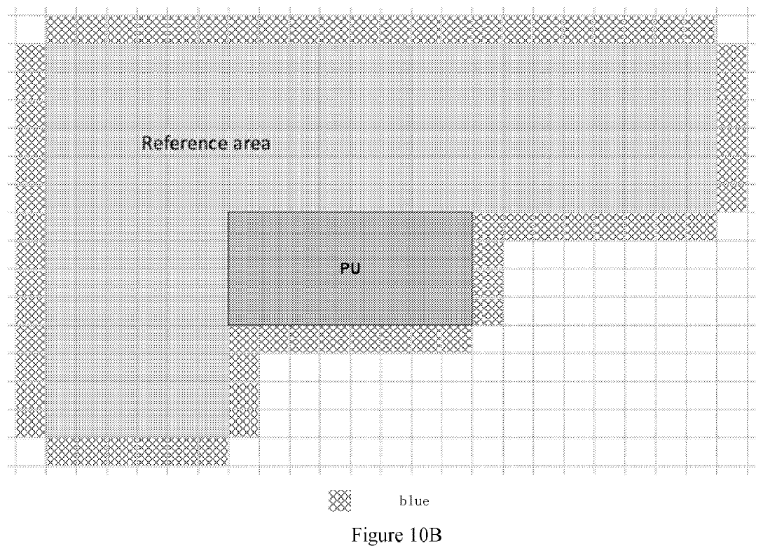

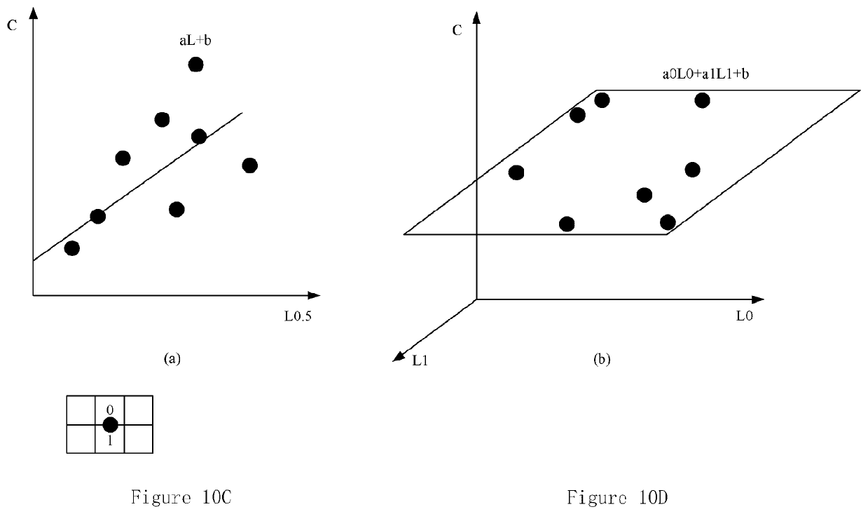

The proposed convolutional 7-tap filter consists of a 5-tap plus sign shape spatial component, a nonlinear term and a bias term. The input to the spatial 5-tap component of the filter consists of a center (C) luma sample which is collocated with the chroma sample to be predicted and its above/north (N), below/south (S), left/west (W) and right/east (E) neighbors as illustrated in FIG. 10A.

The nonlinear term P is represented as power of two of the center luma sample C and scaled to the sample value range of the content:

$$P = ( C ⋆ C + midVal ) >> bitDepth$$

That is, for 10-bit content it is calculated as:

$$P = ( C * C + 512 ) >> 10$$

The bias term B represents a scalar offset between the input and output (similarly to the offset term in CCLM) and is set to middle chroma value (512 for 10-bit content).

Output of the filter is calculated as a convolution between the filter coefficients cᵢ and the input values and clipped to the range of valid chroma samples:

$$PredChromaVal = {c}_{0} C + {c}_{1} N + {c}_{2} S + {c}_{3} E + {c}_{4} W + {c}_{5} P + {c}_{6} B$$

The filter coefficients cᵢ are calculated by minimising MSE between predicted and reconstructed chroma samples in the reference area. FIG. 10B illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations. The proposed approach uses only integer arithmetic.

Usage of the mode is signalled with a CABAC coded PU level flag. One new CABAC context was included to support this. When it comes to signalling, CCCM is considered a sub-mode of CCLM. That is, the CCCM flag is only signalled if intra prediction mode is LM_CHROMA_IDX (to enable single mode CCCM) or MMLM_CHROMA_IDX (to enable multi-model CCCM).

The encoder performs two new RD checks in the chroma prediction mode loop, one for checking single model CCCM mode and one for checking multi-model CCCM mode.

In the existing CCLM or MMLM design, the neighboring reconstructed luma-chroma sample pairs are classified into one or more sample groups based on the value Threshold, which only considers the luma DC values. That is, a luma-chroma sample pair is classified by only considering the intensity of the luma sample. However, luma component usually preserves abundant textures, and the current luma sample may be highly correlated with neighboring luma samples, such inter-sample correlation (AC correlation) may benefit the classification of luma-chroma sample pairs and can bring additional coding efficiency.

As shown in FIG. 10C, the CCLM assumes a given chroma sample only correlates to a corresponding luma sample (L0.5, which can be taken as the fractional luma sample position), and a simple linear regression (SLR) with ordinary least squares (OLS) estimation is used to predict the given chroma sample. However, as shown in FIG. 10D, in some video content, one chroma sample may simultaneously correlate to multiple luma samples (AC or DC correlation), so a multiple linear regression (MLR) model may further improve the prediction accuracy.

Although the CCCM mode can enhance the intra prediction efficiency, there is room to further improve its performance. Meanwhile, some parts of the existing CCCM mode also need to be simplified for efficient codec hardware implementations or improved for better coding efficiency. Furthermore, the tradeoff between its implementation complexity and its coding efficiency benefit needs to be further improved.

### Edge-Classified Linear Model (ELM)

To improve the coding efficiency of luma and chroma components, classifiers considering luma edge or AC information is introduced, in contrast to the above implementations wherein only luma DC values are considered. Besides the existing band-classified MMLM, the present disclosure provides exemplary classifiers. The process of generating linear prediction models for different sample groups may be similar as CCLM or MMLM (e.g., via a least square method, or a simplified min-max method, etc.), but with different metrices for classification. Different classifiers may be used to classify the neighboring luma samples (e.g., of the neighboring luma-chroma sample pairs) and/or the luma samples corresponding to chroma samples to be predicted. The luma samples corresponding to the chroma samples may be obtained by a down-sampling operation to match the locations of the corresponding chroma samples for 4:2:0 video sequences. For example, a luma sample corresponding to a chroma sample may be obtained by performing a down-sampling operation on more than one (e.g., 4) reconstructed luma samples corresponding to the chroma sample (e.g., located around the chroma sample). Alternatively, the luma samples may obtained directly from the reconstructed luma samples in a case of 4:4:4 video sequences, for example. Alternatively, the luma samples may be obtained from respective ones of the reconstructed luma samples that are at respective collocated positions for the corresponding chroma samples. For example, a luma sample to be classified may be obtained from one of four reconstructed luma samples corresponding to the chroma sample that is at a left-top position of the four reconstructed luma samples, which may be considered as a collocated position for the chroma sample.

A first classifier may classify luma samples according to their edge strengths. For example, one direction (e.g., 0-degree, 45-degree, or 90-degree, etc.) may be selected to calculate the edge strength. A direction may be formed by a current sample and a neighboring sample along the direction (e.g., a neighboring sample located at the right-top of the current sample for 45-degree). An edge strength may be calculated by subtracting the neighbor sample from the current sample. The edge strength may be quantized into one of M segments by M−1 thresholds, and the first classifier may use M classes to classify the current sample. Alternatively or additionally, N directions may be formed by a current sample and N neighboring samples along the N directions. N edge strengths may be calculated by subtracting N neighboring samples from the current sample, respectively. Similarly, if each of the N edge strengths may be quantized into one of M segments by M−1 thresholds, then the first classifier may use MN classes to classify the current sample.

A second classifier may be used to classify according to a local pattern. For example, a current luma sample Y0 may be compared with its neighboring N luma samples Yi. A score may be added by one if the value of Y0 is greater than that of Yi, otherwise, the score may be reduced by one. The score may be quantized to form K classes. The second classifier may classify a current sample into one of the K classes. For example, the neighboring luma samples may be obtained from four neighbors that are located above, left, right and below the current luma samples, i.e., without diagonal neighbors.

It may be contemplated that a plurality of the first classifier, the second classifier, or different instances of the first or second classifier or other classifiers described herein may be combined. For example, a first classifier may be combined with the existing MMLM threshold-based classifier. For another example, instance A of the first classifier may be combined with another instance B of the first classifier, where the instance A and B employ different directions (e.g., employing vertical and horizontal directions, respectively).

It will be appreciated by those skilled in the art that though the existing CCLM design in the VVC standard is used as the basic CCLM method in the description, the proposed cross-component method described in the disclosure can also be applied to other prediction coding tools with similar design spirits. For example, for the chroma from luma (CfL) in the AV1 standard, the proposed method can also be applied by dividing luma-chroma sample pairs into multiple sample groups.

It will be appreciated by those skilled that Y/Cb/Cr also can be denoted as Y/U/V in video coding area. If video data is of RGB format, the proposed method can also be applied by simply mapping YUV notation to GBR, for example.

### Filter-Based Linear Model (FLM)

A filter-based linear model (FLM) which utilizes the MLR model is introduced as follows, to take into account the possibilities that one chroma sample may simultaneously correlate to multiple luma samples.

For a to-be-predicted chroma sample, the reconstructed collocated and neighboring luma samples can be used to predict the chroma sample, to capture the inter-sample correlation among the collocated luma sample, neighboring luma samples, and the chroma sample. The reconstructed luma samples are linear weighted and combined with one “offset” to generate the predicted chroma sample (C: predicted chroma sample, Lᵢ: i-th reconstructed collocated or neighboring luma samples, αᵢ: filter coefficients, β: offset, N: filter taps), as shown in the following equation (32-1). Note the linear weighted plus offset value directly forms the predicted chroma sample (can be low pass, high pass adaptively according to video content), and it is then added by the residual to form the reconstructed chroma sample.

$$C = {\sum }_{i = 0}^{N - 1} {α}_{i} \cdot {L}_{i} + β \qquad ( 32 - 1 )$$

In some implementation like CCCM, the offset term can also be implemented as middle chroma value B (512 for 10-bit content) multiplied by another coefficient, as shown in the following equation (32-2).

$$C = {\sum }_{i = 0}^{N - 1} {α}_{i} \cdot {L}_{i} + {α}_{N} \cdot B \qquad ( 32 - 2 )$$

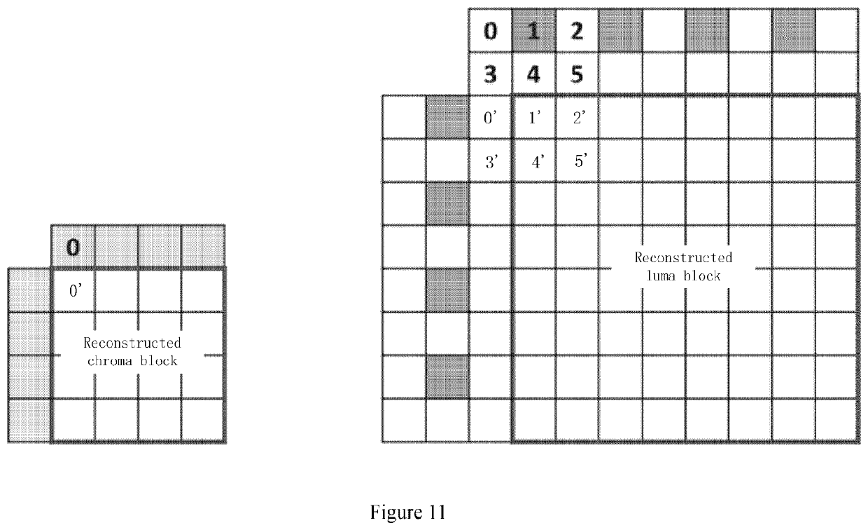

For a given CU, the top and left reconstructed luma and chroma samples can be used to derive or train the FLM parameters (αᵢ, β). Like CCLM, αᵢ and β can be derived via OLS. The top and left training samples are collected, and one pseudo inverse matrix is calculated at both encoder and decoder sides to derive the parameters, which are then used to predict the chroma samples in the given CU. Let N denotes the number of filter taps applied on luma samples, M denotes the total top and left reconstructed luma-chroma sample pairs used for training parameters, Lⱼⁱ denotes luma sample with the i-th sample pair and the j-th filter tap, Cⁱ denotes the chroma sample with the i-th sample pair, the following equations show the derivation of the pseudo inverse matrix A⁺, and also the parameters. FIG. 11 shows an example that N is 6 (6-tap), M is 8, top 2 rows and left 3 columns luma samples and top 1 row and left 1 column chroma samples are used to derive or train the parameters.

$${C}^{0} = {α}_{0} \cdot {L}_{0}^{0} + {α}_{1} \cdot {L}_{1}^{0} + … + {α}_{N - 1} \cdot {L}_{N - 1}^{0} + β \qquad ( 33 )$$

$${C}^{1} = {α}_{0} \cdot {L}_{0}^{1} + {α}_{1} \cdot {L}_{1}^{1} + … + {α}_{N - 1} \cdot {L}_{N - 1}^{1} + β$$

$${C}^{M - 1} = {α}_{0} \cdot {L}_{0}^{M - 1} + {α}_{1} \cdot {L}_{1}^{M - 1} + … + {α}_{N - 1} \cdot {L}_{N - 1}^{M - 1} + β$$

$$[ \begin{matrix}{C}^{0} \\ {C}^{1} \\ ⋮ \\ ⋮ \\ {C}^{M − 1}\end{matrix} ] = [ \begin{matrix}{L}_{0}^{0} & {L}_{1}^{0} & ⋯ & {L}_{N − 1}^{0} & 1 \\ {L}_{0}^{1} & {L}_{1}^{1} & ⋯ & {L}_{N − 1}^{1} & 1 \\ ⋮ & ⋮ & ⋯ & ⋮ & ⋮ \\ ⋮ & ⋮ & ⋯ & ⋮ & ⋮ \\ {L}_{0}^{M − 1} & {L}_{1}^{M − 1} & ⋯ & {L}_{N − 1}^{M − 1} & 1\end{matrix} ] [ \begin{matrix}{α}_{0} \\ {α}_{1} \\ ⋮ \\ {α}_{N − 1} \\ β\end{matrix} ]$$

$$b = Ax$$

$$x = {( {A}^{T} A )}^{- 1} {A}^{T} b = {A}^{+} b$$

Please note that one can predict the chroma sample by only αᵢ without the offset β, which may be a subset of the proposed method.

The proposed ELM/FLM/GLM (as discussed below) can be extended straightforwardly to the CfL design in the AV1 standard, which transmits model parameters (α, β) explicitly. For example, (1-tap case) deriving α and/or β at encoder at SPS/DPS/VPS/SEI/APS/PPS/PH/SH/Region/CTU/CU/Subblock/Sample levels, and signaled to decoder for the CfL mode.

To further improve the coding performance, additional designs may be used in the FLM prediction. As shown in FIG. 11 and discussed above, a 6-tap luma filter is used for the FLM prediction. However, though a multiple tap filter can fit well on training data (e.g., top and left neighboring reconstructed luma and chroma samples), in some cases that training data do not capture full characteristics of testing data, it may result in overfitting and may not predict well on testing data (i.e., the to-be-predicted chroma block samples). Also, different filter shapes may adapt well to different video block content, leading to more accurate prediction.

To address this issue, the filter shape and number of filter taps can be predefined or signaled or switched in Sequence Parameter Set (SPS), Adaptation Parameter Set (APS), Picture Parameter Set (PPS), Picture Header (PH), Slice Header (SH), Region, CTU, CU, Subblock, or Sample level. A set of filter shape candidates can be predefined, and a selection on the set of filter shape candidates may be signaled or switched in SPS, APS, PPS, PH, SH, Region, CTU, CU, Subblock, or Sample level. Different components (e.g., U and V) may have different filter switch control. For example, a set of filter shape candidates (e.g., indicated by index 0-5) may be predefined, and a filter shape (1, 2) may denote a 2-tap luma filter, a filter shape (1, 2, 4) may denote a 3-tap luma filter and the like, as shown in FIG. 11. The filter shape selection of U and V components can be switched in PH or in CU or CTU level. Note N-tap can represent N-tap with or without the offset β as described herein. One example is given as below in Table 8.

TABLE 8
Exemplary signaling and switching for different filter shapes

| predefined filter shape candidates: | | # of filter taps | filter shape |
|---|---|---|---|
| idx | 0 | 2 | (1, 2) |
| idx | 1 | 2 | (1, 4) |
| idx | 2 | 2 | (1, 5) |
| idx | 3 | 3 | (1, 2, 4) |
| idx | 4 | 4 | (1, 2, 4, 5) |
| idx | 5 | 6 | (0, 1, 2, 3, 4, 5) |

| POC | comp | selected filter shape idx | |
|---|---|---|---|
| 0 | U | 3 | PH switch |
| | V | 0~5 | CU switch |
| 1 | U | 4 | PH switch |
| | V | 0~2 | CTU switch |

The FLM or the CCCM filter shape may include a nonlinear term. For example, for a CCCM filter, the chroma sample value may be predicted using the following equation:

$$predChromaVal = {c}_{0} C + {c}_{1} N + {c}_{2} S + {c}_{3} E + {c}_{4} W + {c}_{5} P + {c}_{6} B , P = C ⋆ C + midVal ) >> bitDepth$$

wherein the filter corresponds to weighting coefficients c₀, c₁, . . . c₆ for a center (C) luma sample value which is collocated with the chroma sample to be predicted, its above/north (N), below/south (S), right/east (E) and left/west (W) neighbors, a nonlinear term P and a bias term B. The values used to derive the nonlinear term P can be a combination of current and neighboring luma samples, but not limited to C*C. For example, P can be derived as following:

$$P = ( Q ⋆ R + midVal ) >> bitDepth$$

wherein Q and R denotes the value used to derive the nonlinear term P.

Q and R can be linear combination of current and neighboring luma samples either in a down-sampled domain (for example, the Q and R being pre-operated luma samples obtained by weighted-average operation) or without any down-sampling process.

For example, each one of Q and R can be selected from one of N, S, E, W, and C luma sample values, for example Q*R=C*N, C*S, C*E, C*W, S*N or N*N etc.; or Q and R can both be equal to the average value of N, S, E, and W luma sample values, i.e., Q=R=(N+S+E+W)/4; or Q equals to C luma sample value while R equals to the average value of N, S, E, and W luma sample values, i.e., Q=C while R=(N+S+E+W)/4.

Different values (Q and R) used to derive the nonlinear term are considered as different filter shapes and can be predefined or signaled/switched in SPS/DPS/VPS/SEI/APS/PPS/PH/SH/Region/CTU/CU/Subblock/Sample levels. A set of filter shape candidates can be predefined or signaled/switched in SPS/DPS/VPS/SEI/APS/PPS/PH/SH/Region/CTU/CU/Subblock/Sample levels.

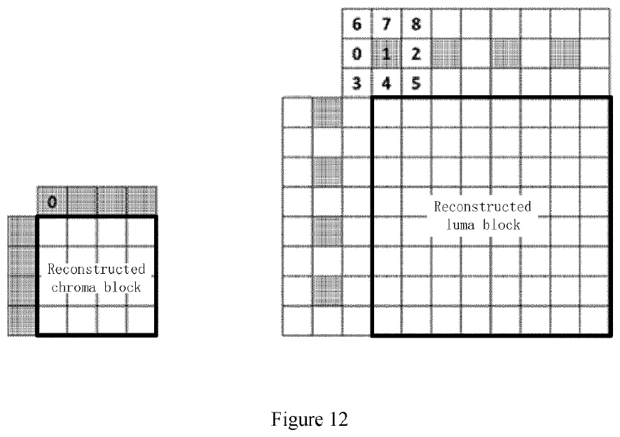

Different chroma types and/or color formats can have different predefined filter shapes and/or taps. For example, a predefined filter shape (1, 2, 4, 5) may be used for 4:2:0 type-0, a predefined filter shape (0, 1, 2, 4, 7) may be used for 4:2:0 type-2, and a predefined filter shape (1, 4) may be used for 4:2:2, and a predefined filter shape (0, 1, 2, 3, 4, 5) may be used for 4:4:4, as shown in FIG. 12.

In another aspect of the present disclosure, unavailable luma and chroma samples for deriving the MLR model can be padded from available reconstructed samples. For example, if using a 6-tap (0, 1, 2, 3, 4, 5) filter as in FIG. 12, for a CU located at the left picture boundary, the left columns including samples (0, 3) are not available (out of picture boundary), so samples (0, 3) are repetitive padding from samples (1, 4) to apply the 6-tap filter. Note that the padding process may be applied in both training data (top and left neighboring reconstructed luma and chroma samples) and testing data (the luma and chroma samples in the CU(s)).

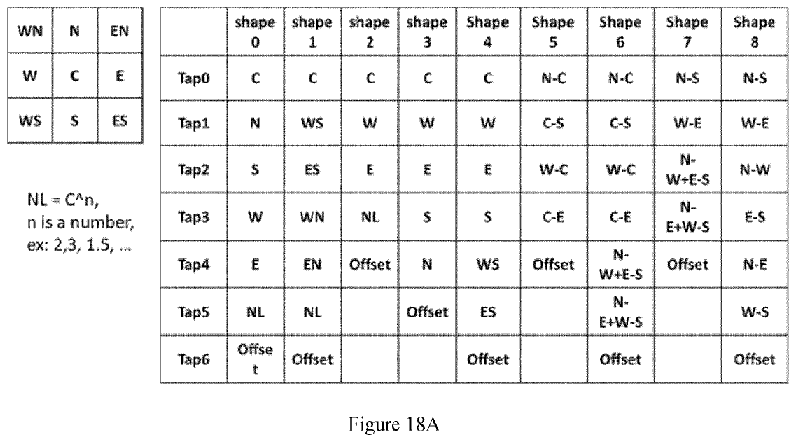

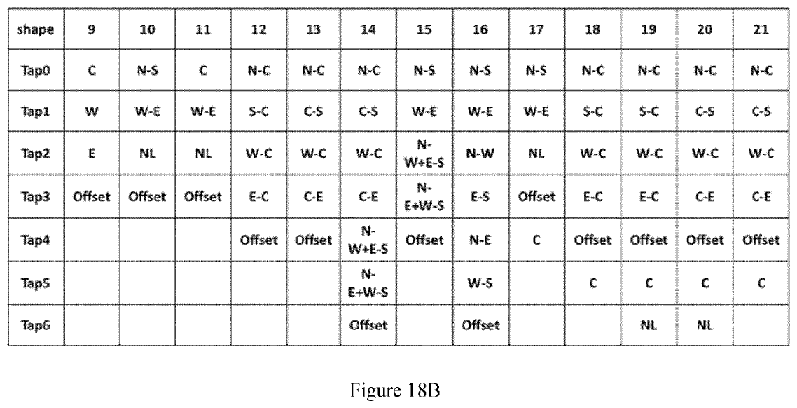

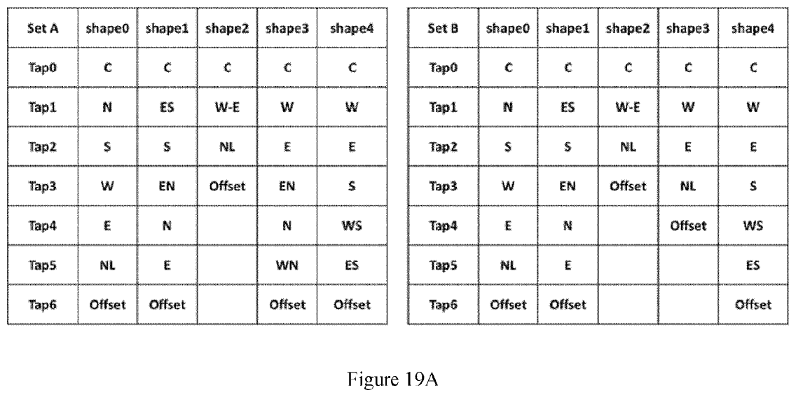

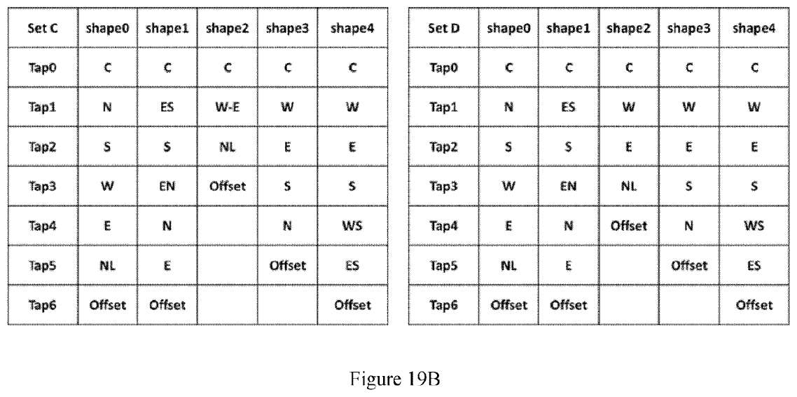

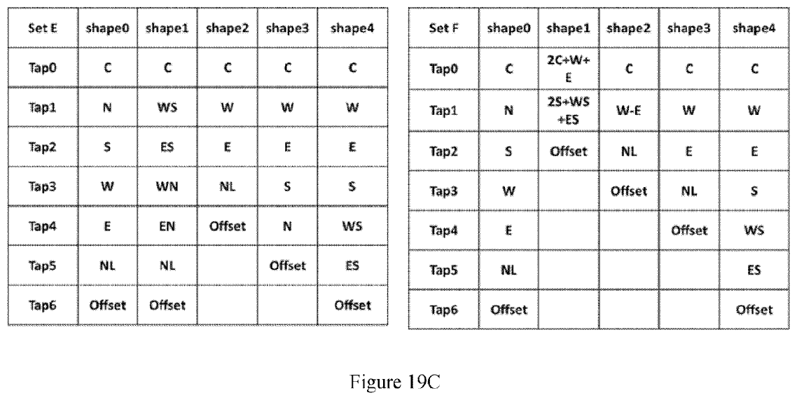

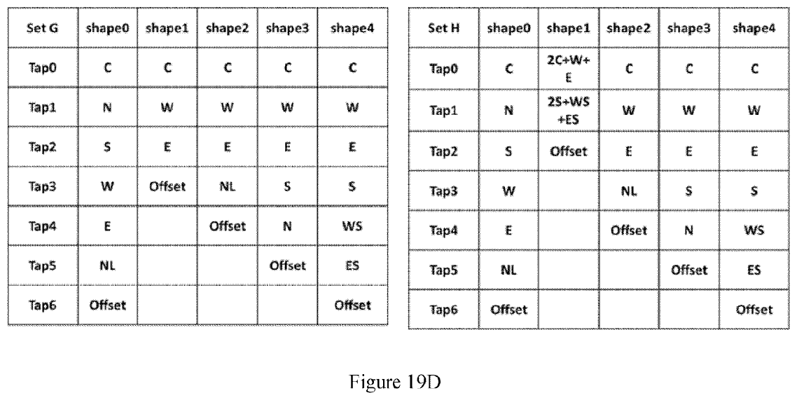

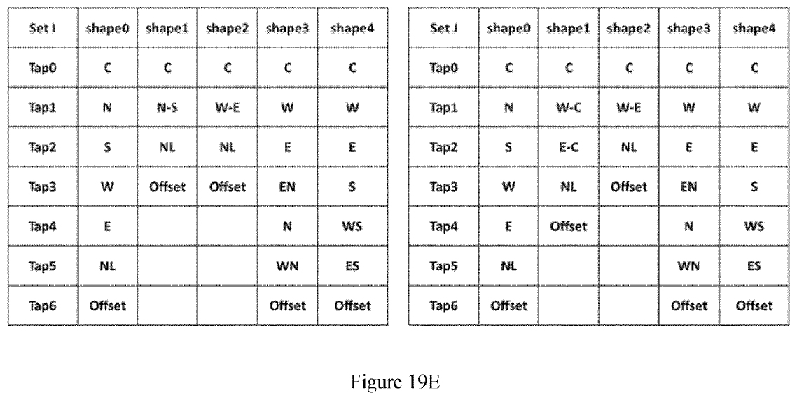

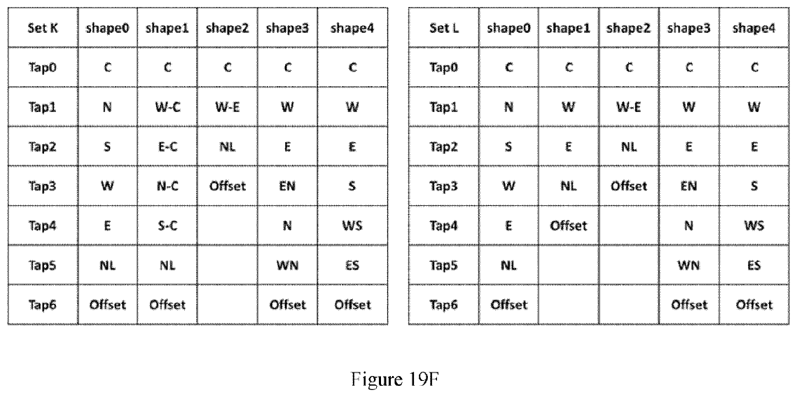

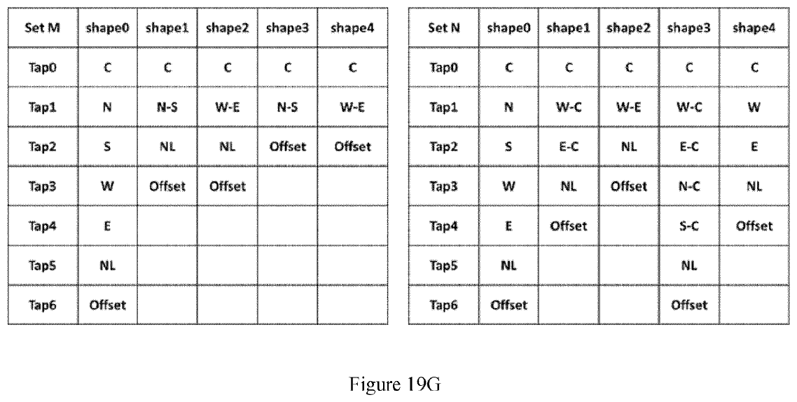

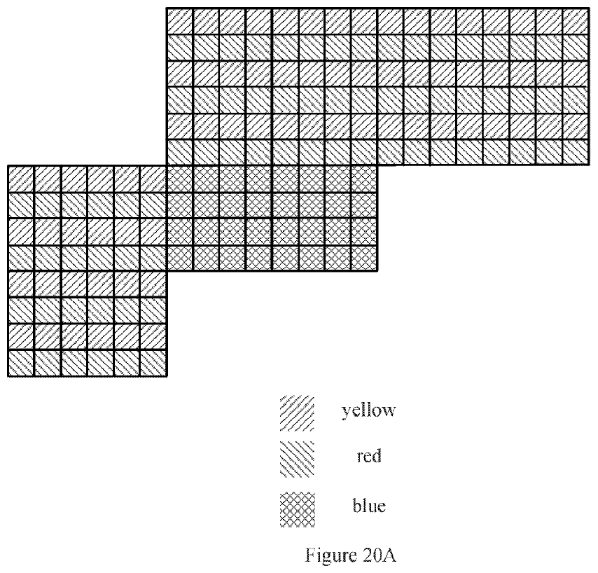

One or more shape/number of filter taps may be used for FLM prediction, examples being shown in FIG. 16, FIG. 17, and FIGS. 18A to 18B. One or more sets of filter taps may be used for FLM prediction, and examples are shown in FIGS. 19A to 19G.

The filter shape candidates can be implicitly derived without explicitly signaling bits. For example, the filter shape candidates can be the filter shape candidates for FLM or GLM (as discussed below). In another example, the filter shape candidates can be the cross shape filter for CCCM, any of the filters shown in FIG. 16, FIG. 17, FIG. 18A, FIG. 18B, and FIGS. 19A to 19G, or other filters mentioned in this disclosure. The well-known N-fold training technique in machine learning area can be used for training filter coefficients. As longer filter taps theoretically always fit better in training data (template area) but may be overfitting, the well-known “N-fold cross-validation” technique in machine learning area can be used for training filter coefficients. The technique divides the available training data into N sets, and use partial sets for training, others for validation

The following example involves implicit filter shape derivation for FLM prediction:
Step 1: determining M filter shape candidates for predicting the chroma sample values of the current CU;
Step 2: dividing the available L-shaped template area external to the CU into N regions, denoted as R₀, R₁, . . . R_{N-1}, i.e., dividing the training data into N sets for N-fold training, wherein the luma sample values and the chroma sample values of the available template area are known values;
Step 3: applying each of the M filter shape candidates respectively to a part of the available template area, i.e., one or more regions among all the N regions R₀, R₁, . . . R_{N-1};
Step 4: deriving M filter coefficient sets corresponding to the M filter shape candidates, denoted as F₀, F₁, . . . F_{M-1};
Step 5: applying the derived F₀, F₁, . . . F_{M-1} filter coefficient sets to another part of the available template area to predict the chroma sample values based on corresponding luma sample values, wherein the another part of the available template area is different from the part of the available template area mentioned in Step 3;
Step 6: accumulating, for each of the M filter shapes respectively, the errors between the predicted chroma sample values and the known chroma sample values in the another part of the available template area by Sum of Absolute Difference (SAD), Sum of Squared Difference (SSD), or Sum of Absolute Transformed Difference (SATD), denoted as E₀, E₁, . . . E_{M-1};
Step 7: sorting and selecting K smallest errors, denoted as E′₀, E′₁, . . . E′_{K-1}, which correspond to K filter shapes and K filter coefficient sets; and
Step 8: selecting one filter shape candidate from the K filter shape candidates, to apply to the current CU for chroma prediction. If K is more than 1, then the decoder may still receive signal from the encoder indicating the applied filter. However, if K is 1, then the signaling can be omitted and the filter with the smallest accumulated error is determined to be the applied filter.

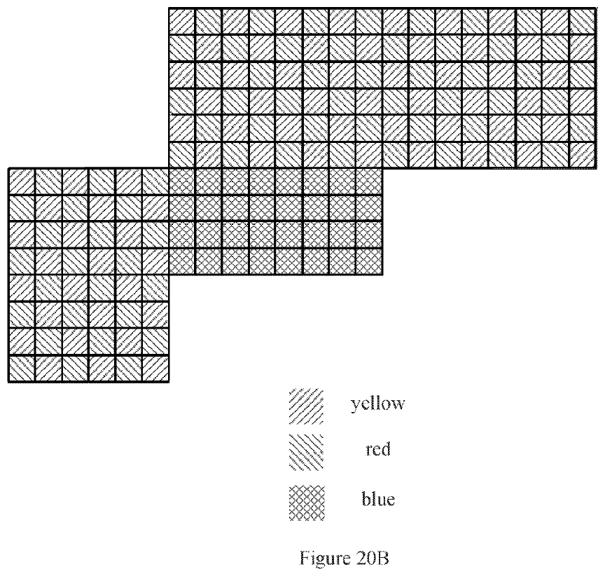

FIG. 20A and FIG. 20B illustrate examples of 2-fold training for implicitly filter shape derivation. For current chroma CU prediction (blue area), FIG. 20A shows that in template area, even-row region R₀ (yellow) is used for training/deriving 4 filter coefficient sets, and odd-row region R₁ (red) is used for validation/comparing and sorting costs of 4 filter coefficient sets; FIG. 20B shows that in template area, R₀ (yellow) and R₁ (red) are interleaved. It should be understood that R₀ and R₁ can be exchanged in these examples.

In one example, one of 4 filter shape candidates is to be selected as the applied filter, while the L-shaped template area is divided into even-numbered and odd-numbered rows or columns. The steps include:
predefining 4 filter shape candidates for the current CU (for example, 4 filter shape candidates from FIG. 16);
dividing the available L-shaped template area (for example, 6 chroma rows and columns for CCCM, note that in CCCM design, each chroma sample involves 6 luma samples for down-sampling) into 2 regions denoted as R₀, R₁, wherein, for example, R₀ is composed of the even rows or columns, and R₁ is composed of the odd rows or columns (FIG. 20A shows the example that in template area, even-row region R₀ is used for training/deriving 4 filter coefficient sets, and odd-row region R₁ is used for validation/comparing and sorting costs of 4 filter coefficient sets);
applying 4 filter shape candidates independently to a part of the available template area (for example, region R₀);
deriving 4 filter coefficient sets for the 4 filter shapes respectively, denoted as F₀, F₁, . . . F₃;
applying the derived F₀, F₁, . . . F₃ filter coefficient sets to the other part of the available template area (for example, region R₁) respectively, to predict the corresponding chroma sample values;
accumulating, for each of the 4 filters respectively, the errors between the predicted chroma sample values and the known chroma sample values in the other part of the available template area (for example, region R₁) by SAD, SSD, or SATD, denoted as E₀, E₁, . . . E₃; and
selecting one of the 4 filter shape candidates with the smallest accumulated error in E₀, E₁, . . . E₃, denoted as E′₀, which corresponds to one filter shape and one filter coefficient set. In this example, only the filter shape candidate with the smallest accumulated error will be determined as the applied filter, then the decoder does not need to receive signal indicative of the applied filter.

In one example, the L-shaped template area can be divided into interleaved parts, while K=2. The steps include:
determining 4 filter shape candidates for the current CU;
dividing the available L-shaped template area (for example, 6 chroma rows or columns for CCCM) into 2 regions denoted as R₀, R₁, wherein the luma samples in R₀ and R₁ are for example interleaved as shown in the following tables:

| R₀ | R₁ |
|---|---|
| R₁ | R₀ |

or

| R₀ | R₁ |
|---|---|
| R₁ | R₀ |

and FIG. 20B shows the example that in template area, R0 and R1 are interleaved;
applying 4 filter shape candidates independently to a part of the available template area (for example, region R0);
deriving 4 filter coefficient sets for the 4 filter shapes respectively, denoted as F₀, F₁, . . . F₃; applying the derived F₀, F₁, . . . F₃ filter coefficient sets to the other part of the available template area (for example, region R₁) respectively, to predict the corresponding chroma sample values;
accumulating, for each of the 4 filter shapes respectively, the errors between the predicted chroma sample values and the known chroma sample values in the other part of the available template area (for example, region R₁) by SAD, SSD, or SATD, denoted as E₀, E₁, . . . E₃;
sorting and selecting 2 smallest accumulated errors in E₀, E₁, . . . E₃, denoted as E′₀, E′₁, which correspond to 2 filter shapes and 2 filter coefficient sets; and
based on the received signal from the encoder, selecting one filter shape candidate in the 2 filter shape candidates, to apply to the current CU for chroma prediction.

Note the method of implicit filter shape derivation can also be used to determine whether to introduce nonlinear term in CCCM filter coefficients (treating with/without nonlinear term as different filter shapes).

Although examples are illustrated above for CCCM filter, it should be understood that the nonlinear term P may also be included in FLM filters (e.g., a 3*2 filter as shown in FIG. 11) and derived in a similar way as discussed above.

In one example, the steps of dividing the available L-shaped template area may be omitted. In this example, the M filter coefficient sets may be derived based on the sample values from the available template area and then applied back to the available template area respectively, to predict the corresponding chroma sample values for accumulating the errors.

As mentioned above, an MLR model (linear equations) must be derived at both the encoder and the decoder. According to one or more aspects of the present disclosure, several methods are proposed to derive the pseudo inverse matrix A⁺, or to directly solve the linear equations. Other known methods like Newton's method, Cayley-Hamilton method, and Eigendecomposition as mentioned in https://en.wikipedia.org/wiki/Invertible_matrix can also be applied.

In the present disclosure, A⁺ can be denoted as A⁻¹ for simplification. The linear equations may be solved as follows

1. Solving A⁻¹ by Adjugate Matrix (adjA), Closed Form, Analytic Solution:
Below shows one n×n general form, one 2×2 and one 3×3 cases. If FLM uses 3×3, 2 scalers plus one offset need be solved.

$$b = A x , x = {( {A}^{T} A )}^{- 1} {A}^{T} b = {A}^{+} b , denoted as {A}^{- 1} b$$

$$\begin{matrix}{A}^{- 1} = \frac{1}{det A} , adjA & ( adjA ) \text{?}\end{matrix} = {( - 1 )}^{i + j} det \tilde{A} \text{?}$$

$$\text{?} \text{indicates text missing or illegible when filed}$$

Ãⱼᵢ: (n−1)×(n−1) submatrix by removing j-th row and i-th column

$${A}^{- 1} = {[ \begin{matrix}a & b \\ c & d\end{matrix} ]}^{- 1} = \frac{1}{det A} [ \begin{matrix}{A}_{11} \text{?} & {A}_{21} \text{?} \\ - {A}_{12} \text{?} & {A}_{22} \text{?}\end{matrix} ] = \frac{1}{det A} [ \begin{matrix}d & - b \\ - c & a\end{matrix} ]$$

$${A}^{- 1} = {[ \begin{matrix}{a}_{11} & {a}_{12} & {a}_{13} \\ a \text{?} & {a}_{22} & {a}_{23} \\ {a}_{31} & {a}_{32} & {a}_{33}\end{matrix} ]}^{- 1} = \frac{1}{det A} [ - \begin{matrix}\vert \begin{matrix}{a}_{22} & {a}_{23} \\ {a}_{32} & {a}_{33}\end{matrix} \vert & - \vert \begin{matrix}{a}_{12} & {a}_{13} \\ {a}_{32} & {a}_{33}\end{matrix} \vert & \vert \begin{matrix}{a}_{12} & {a}_{13} \\ {a}_{22} & {a}_{23}\end{matrix} \vert \\ \vert \begin{matrix}{a}_{22} & a \text{?} \\ a \text{?} & a \text{?}\end{matrix} \vert & \vert \begin{matrix}a \text{?} & a \text{?} \\ a \text{?} & a \text{?}\end{matrix} \vert & - \vert \begin{matrix}a \text{?} & a \text{?} \\ a \text{?} & a \text{?}\end{matrix} \vert \\ \vert \begin{matrix}{a}_{21} & {a}_{22} \\ {a}_{31} & {a}_{32}\end{matrix} \vert & - \vert \begin{matrix}{a}_{11} & {a}_{12} \\ {a}_{31} & {a}_{32}\end{matrix} \vert & \vert \begin{matrix}{a}_{11} & {a}_{12} \\ a \text{?} & a \text{?}\end{matrix} \vert\end{matrix} ]$$

$$\text{?} \text{indicates text missing or illegible when filed}$$

### 2. Gauss-Jordan Elimination

The linear equations can be solved using Gauss-Jordan elimination, by an augmented matrix [A Iₙ] and a series of elementary row operation to obtain the reduced row echelon form [I|X]. Below shows 2×2 and 3×3 examples.

$$[ \begin{matrix}a & b \\ c & d\end{matrix} \vert \begin{matrix}1 & 0 \\ 0 & 1\end{matrix} ] \to [ \begin{matrix}a & b \\ 0 & ad - bc\end{matrix} \vert \begin{matrix}1 & 0 \\ - c & a\end{matrix} ] \to [ \begin{matrix}a & b \\ 0 & 1\end{matrix} \vert \begin{matrix}1 & 0 \\ \frac{- c}{ad - bc} & \frac{a}{ad - bc}\end{matrix} ] \to [ \begin{matrix}a & 0 \\ 0 & 1\end{matrix} \vert \begin{matrix}\frac{ad}{ad - bc} & \frac{- ab}{ad - bc} \\ \frac{- c}{ad - bc} & \frac{a}{ad - bc}\end{matrix} ] \to [ \begin{matrix}1 & 0 \\ 0 & 1\end{matrix} \vert \begin{matrix}\frac{d}{ad - bc} & \frac{- b}{ad - bc} \\ \frac{- c}{ad - bc} & \frac{a}{ad - bc}\end{matrix} ]$$

$$[ \begin{matrix}2 & 2 & 5 \\ - 2 & 1 & 2 \\ 6 & 3 & 9\end{matrix} \vert \begin{matrix}1 & 0 & 0 \\ 0 & 1 & 0 \\ 0 & 0 & 1\end{matrix} ] \to [ \begin{matrix}2 & 2 & 5 \\ 0 & 3 & 7 \\ 0 & - 3 & - 6\end{matrix} \vert \begin{matrix}1 & 0 & 0 \\ 1 & 1 & 0 \\ - 3 & 0 & 1\end{matrix} ] \to [ \begin{matrix}2 & 2 & 5 \\ 0 & 3 & 7 \\ 0 & 0 & 1\end{matrix} \vert \begin{matrix}1 & 0 & 0 \\ 1 & 1 & 0 \\ - 2 & 1 & 1\end{matrix} ] \to [ \begin{matrix}2 & 2 & 0 \\ 0 & 3 & 0 \\ 0 & 0 & 1\end{matrix} \vert \begin{matrix}11 & - \text{?} & - 5 \\ 15 & - 6 & - 7 \\ - 2 & 1 & 1\end{matrix} ] \to [ \begin{matrix}2 & 2 & 0 \\ 0 & 1 & 0 \\ 0 & 0 & 1\end{matrix} \vert \begin{matrix}11 & - 5 & - \text{?} \\ 5 & - 2 & \text{?} \\ - 2 & 1 & 1\end{matrix} ] \to [ \begin{matrix}2 & 0 & 0 \\ 0 & 1 & 0 \\ 0 & 0 & 1\end{matrix} \vert \begin{matrix}1 & - 1 & \text{?} \\ 5 & - 2 & \text{?} \\ - 2 & 1 & 1\end{matrix} ] \to [ \begin{matrix}1 & 0 & 0 \\ 0 & 1 & 0 \\ 0 & 0 & 1\end{matrix} \vert \begin{matrix}\text{?} & - \text{?} & - \text{?} \\ 5 & - 2 & - \text{?} \\ - 2 & 1 & - \text{?}\end{matrix} ]$$

$$\text{?} \text{indicates text missing or illegible when filed}$$

### 3. Cholesky Decomposition

To solve Ax=b, A can be firstly decomposed by Cholesky-Crout algorithm, leading to one upper triangular and one lower triangular matrices, and one forward substitution plus one backward substitution can be applied in serial to obtain the solution. Below shows a 3×3 example.

$$\begin{matrix}A = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] = {GG}^{T} \\ = [ \begin{matrix}{g}_{11} & 0 & 0 \\ {g}_{21} & {g}_{22} & 0 \\ {g}_{31} & {g}_{32} & {a}_{33}\end{matrix} ] [ \begin{matrix}{g}_{11} & {g}_{12} & g \text{?} \\ 0 & {g}_{22} & g \text{?} \\ 0 & 0 & {g}_{33}\end{matrix} ] \\ = [ \begin{matrix}{g}_{11}^{2} & {g}_{21} {g}_{21} & {g}_{31} {g}_{11} \\ {g}_{21} {g}_{11} & {g}_{21}^{2} + {g}_{22}^{2} & g \text{?} {g}_{21} + {g}_{32} {g}_{22} \\ {g}_{31} {g}_{11} & g \text{?} g \text{?} & {g}_{31}^{2} + {g}_{32}^{2} + {g}_{33}^{2}\end{matrix} ]\end{matrix} \qquad \\$$

$${g}_{11} = \sqrt{{a}_{11}}$$

$${g}_{21} = \frac{{a}_{21}}{{g}_{11}}$$

$${g}_{31} = \frac{{a}_{31}}{{g}_{11}}$$

$${g}_{22} = \sqrt{{a}_{22} - {g}_{21}^{2}}$$

$${g}_{32} = \frac{1}{{g}_{22}} ( a \text{?} - {g}_{31} {g}_{32} )$$

$${g}_{32} = ( a \text{?} - {g}_{31}^{2} {g}_{32}^{2} )$$

$${g}_{jj} = \sqrt{{a}_{jj} - {\sum }_{k = 1}^{j - 1} {g}_{jk}^{2}}$$

$$g \text{?} = \frac{1}{g \text{?}} ( {a}_{ij} - {\sum }_{k = 1}^{j - 1} {g}_{ik} {g}_{jk} ) , i = j + 1 , j + 2 , … , n$$

$$\text{?} \text{indicates text missing or illegible when filed}$$

Apart from the above examples, some conditions need special handling. For example, if some conditions result in that the linear equations cannot be solved, default values can be used to fill the chroma prediction values. The default values can be predefined or signaled or switched in SPS/DPS/VPS/SEI/APS/PPS/PH/SH/Region/CTU/CU/Subblock/Sample levels, for example, when predefined 1<<(bitDepth−1), meanC, meanL, or meanC-meanL (mean current chroma or other chroma, luma values from available, or subset of FLM reconstructed neighboring region).

The following examples represent situations when the matrix A cannot be solved, where default prediction values may be assigned to the whole current block:
1. Solving by closed form (analytic, adjugate matrix), but A is singular, (i.e., detA=0);
2. Solving by Cholesky decomposition, but A cannot be Cholesky decomposed, gⱼⱼ<REG_SQR, where REG_SQR is one small value, can be predefined or signaled or switched in SPS/DPS/VPS/SEI/APS/PPS/PH/SH/Region/CTU/CU/Subblock/Sample levels.

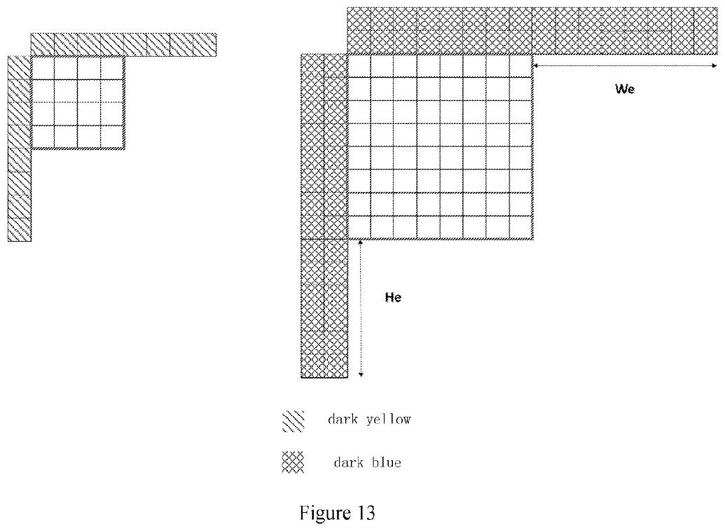

FIG. 11 shows a typical case that the FLM parameters are derived using top 2 and/or left 3 luma lines and top 1 and/or left 1 chroma lines. However, using different region for parameter derivation may bring coding benefit because of different block content and the reconstructive quality of different neighboring samples, as mentioned above. Several ways to choose the applied region for parameter derivation are proposed below:
1. Similar to MDLM, the FLM derivation can only use top or left luma and/or chroma samples to derive the parameters. Whether to use FLM, FLM_L, or FLM_T can be predefined or signaled or switched in SPS/DPS/VPS/SEI/APS/PPS/PH/SH/Region/CTU/CU/Subblock/Sample levels. Suppose that a current chroma block has a size of W×H, then W′ and H′ are obtained as follows:
   W′=W, H′=H when FLM mode is applied;
   W′=W+We when FLM_T mode is applied; where We denotes extended top luma/chroma samples;
   H′=H+He when FLM_L mode is applied; where He denotes extended left luma/chroma samples.
      The number of extended luma/chroma samples (We, He) can be predefined, or signaled or switched in SPS/DPS/VPS/SEI/APS/PPS/PH/SH/Region/CTU/CU/Subblock/Sample levels.
      For example, predefine (We, He)=(H, W) as the VVC CCLM, or (W, H) as the ECM CCLM. The unavailable (We, He) luma/chroma samples can be repetitive padded from the nearest (horizontal, vertical) luma/chroma samples.
      FIG. 13 shows an illustration of FLM_L and FLM_T (e.g., under 4 tap). When FLM_L or FLM_T is applied, only H′ or W′ luma/chroma samples are used for parameter derivation, respectively.
2. Similar to MRL, different line index can be predefined, or signaled or switched in SPS/APS/PPS/PH/SH/Region/CTU/CU/Subblock/Sample levels, to indicate the selected luma-chroma sample pair line. This may benefit from different reconstructive quality of different line samples.

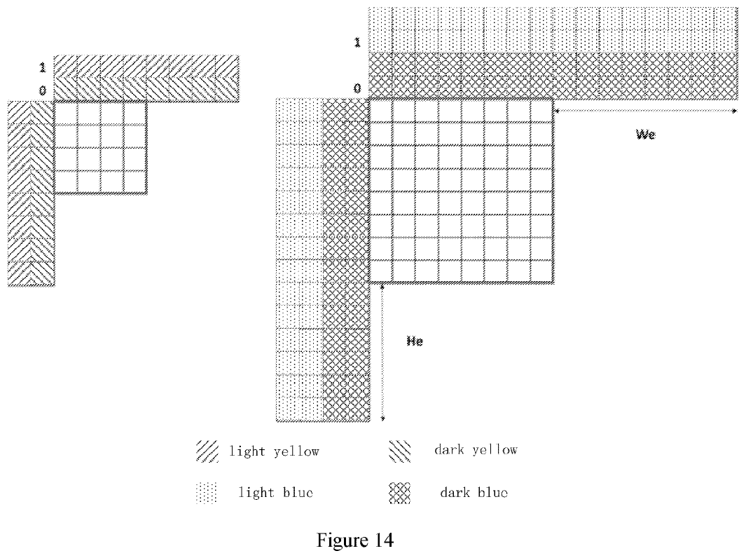

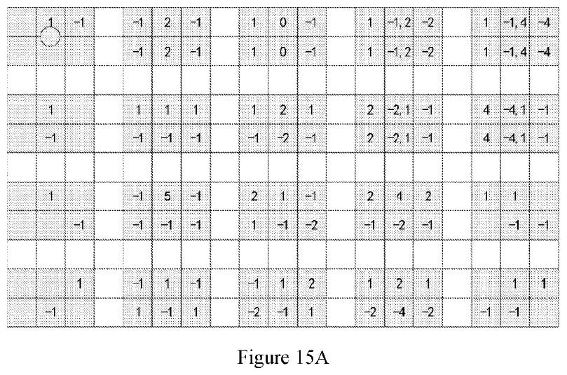

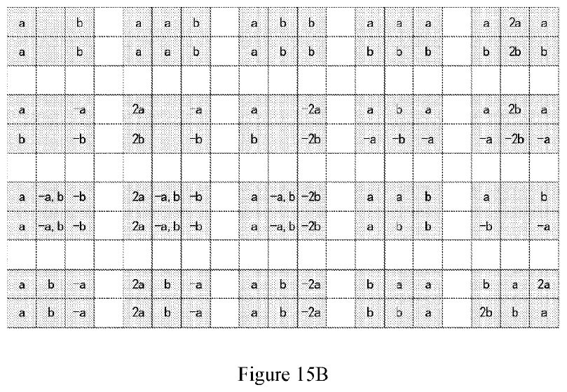

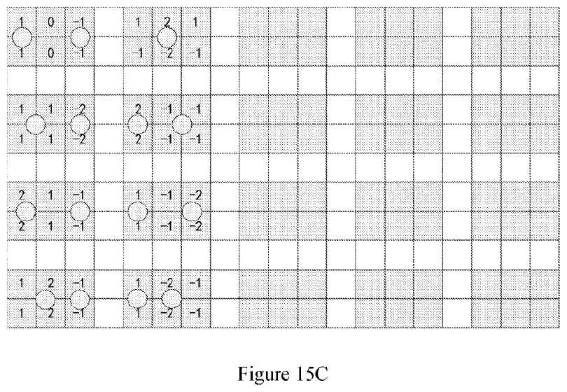

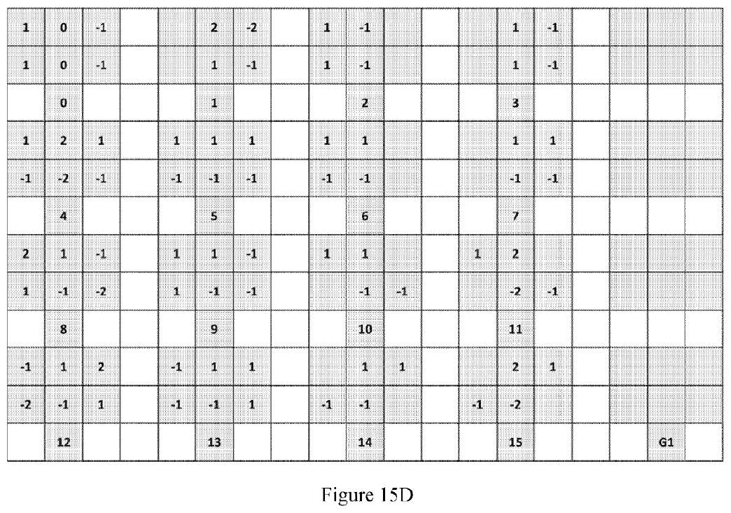

FIG. 14 shows that similar to MRL, FLM can use different lines for parameter derivation (e.g., under 4 tap). For example, FLM can use light blue/yellow luma and/or chroma samples in index 1.
3. Extend CCLM region and take full top N and/or left M lines for parameter derivation. FIG. 14 shows all dark and light blue and yellow region can be used at one time. Training using larger region (data) may lead to a more robust MLR model.

It should be understood that the luma sample values of an external region of the video block to be decoded may be referred to as “the external luma sample values”, and the chroma sample values of the external region may be referred to as “the external chroma sample values” throughout the disclosure.

Corresponding syntax may be defined as below in Table 9 for the FLM prediction. Wherein FLC represents fixed length code, TU represents truncated unary code, EGk represents exponential-golomb code with order k, where k can be fixed or signaled/switched in SPS/DPS/VPS/SEI/APS/PPS/PH/SH/Region/CTU/CU/Subblock/Sample levels, SVLC represents signed EG0, and UVLC represents unsigned EG0.

TABLE 9
An example of FLM syntax

| Level | Syntax element | Binarization | Meaning |
|---|---|---|---|
| SPS | flm_enabled_flag | FLC | whether FLM is enabled in the sequence, |
| | | | can be inferred off when chromaFormat |
| | | | CHROMA_400, or CCLM is off |
| PH/SH | ph_flm_cb_flag | FLC | whether FLM is enabled in this |
| | ph_flm_cr_flag | | picture/slice for Cb/Cr, can be inferred off |
| | | | when chromaFormat == CHROMA_400, |
| | | | or CCLM is off |
| PH/SH | ph_flm_cb_ctb_control_flag | FLC | whether to enable Cb/Cr on/off control at |
| | ph_flm_cr_ctb_control_flag | | CTB level |
| CTU | ctb_flm_cb_flag | CABAC | whether FLM is enabled for the current Cb |
| | ctb_flm_cr_flag | | or Cr CTB, can be CABAC bypass coded |
| | | | or with N contexts (2: up/left, or N |
| | | | neighboring CTBs) |
| CU | cu_flm_cb_flag | CABAC, TU | whether FLM is enabled for the current Cb |
| | cu_flm_cr_flag | | or Cr CU, can be CABAC bypass coded or |
| | | | with N contexts (2: up/left, or N |
| | | | neighboring CUs) |
| CU | flm_cb_filter_idx | CABAC, TU | which filter shape idx (in the predefined |
| | flm_cr_filter_idx | | set) is used for the CU, can be CABAC |
| | | | bypass coded or with N contexts (2: |
| | | | up/left, or N neighboring CUs) |
| CU | flm_cb_mdlm_idx | CABAC, TU | which MDLM idx (FLM, FLM_L, |
| | flm_cr_mdlm_idx | | FLM_T) is used for the CU, can be |
| | | | CABAC bypass coded or with N contexts |
| | | | (2: up/left, or N neighboring CUs) |
| CU | flm_cb_mrl_idx | CABAC, TU | which FLM MRL idx (e.g., 0, 1) is used |
| | flm_cr_mrl_idx | | for the CU, can be CABAC bypass coded |
| | | | or with N contexts (2: up/left, or N |
| | | | neighboring CUs) |

Note that the binarization of each syntax element can be changed.

A new method for cross-component prediction is proposed on the basis of the existing linear model designs, in order to further improve coding accuracy and efficiency. Main aspects of the proposed method are detailed as follows.

Though the above discussed FLM provides the best flexibility (leading to the best performance), it requires to solve many unknown parameters if the number of filter taps goes up. When the inverse matrix is larger than 3×3, the closed form derivation is not suitable (too many multipliers), and iterative methods like Cholesky are needed, which burden decoder processing cycles. In this section, pre-operations before applying the linear model are proposed, including utilizing the sample gradients to exploit the correlation between luma AC information and chroma intensities. With the help of gradients, the number of filter taps can be efficiently reduced.

Please note that methods/examples in this section can be combined/reused from any of the designs discussed above, including but not limited to classification, filter shape, matrix derivation (with special handling), applied region, syntax. Moreover, methods/examples listed in this section can also be applied in any of the designs discussed above, to have a better performance with certain complexity trade-off.

Please note that reference samples/training template/reconstructed neighboring region as used herein usually refers to the luma samples used for deriving the MLR model parameters, which are then applied to the inner luma samples in one CU, to predict the chroma samples in the CU.

According to the proposed method, instead of directly using luma sample intensity values as the input of the linear model, pre-operations (e.g., pre linear weighted, sign, scale/abs, thresholding, ReLU) can be applied to downgrade the dimension of unknown parameters. In one example, the pre-operations may comprise calculating sample differences based on the luma sample values. As understood by one skilled in the art, the sample differences may be characterized as gradients, and thus this new method is also referred to as gradient linear model (GLM) in certain embodiments.

Please note that the following detailed description discuss scenarios wherein the proposed pre-operations may be reused for/combined with the SLR model (also referred to as 1-tap case), and reused for/combined with the MLR model (also referred to as multi-tap case, for example, 2-tap).

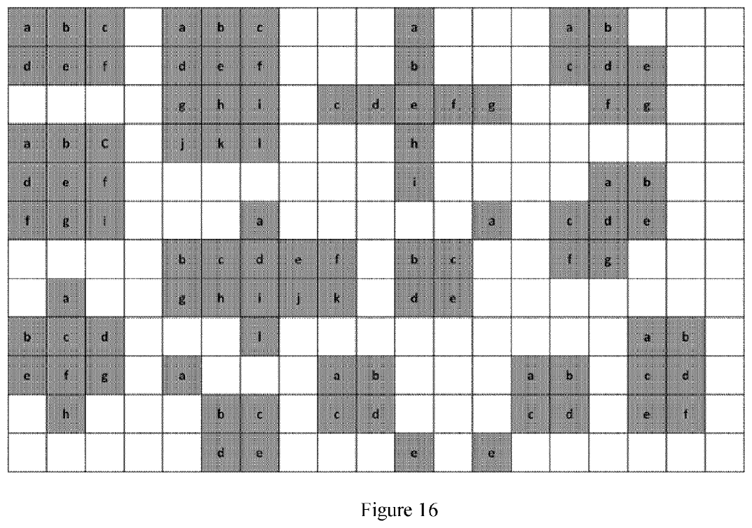

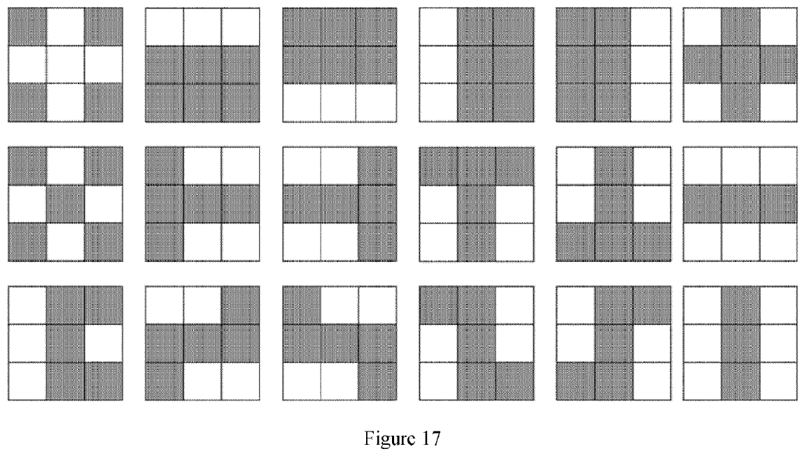

For example, instead of applying 2-tap on 2 luma samples, the 2 luma samples can be pre-operated, then a simpler 1-tap can be applied to reduce complexity. FIGS. 15A to 15D show some examples for 1-tap/2-tap (with offset) pre-operations, where 2-tap coefficients are denoted as (a, b). please note that each circle as illustrated in FIGS. 15A to 15D represent an illustrative chroma position in the YUV 4:2:0 format. As discussed above, in the YUV 4:2:0 format, a luma sample corresponding to a chroma sample may be obtained by performing a down-sampling operation on more than one (e.g., 4) reconstructed luma samples corresponding to the chroma sample (e.g., located around the chroma sample). In other words, the chroma position may correspond to corresponding to one or more luma samples comprising a collocated luma sample. The different 1-tap patterns are designed for different gradient directions and using different “interpolated” luma samples (weighting to different luma location) for gradient calculation. For example, one typical filter [1, 0, −1; 1, 0, −1] is shown in FIGS. 15A, 15C and 15D, which represents the following operations:

$${{Rec}_{L}}^{′ ′} \text{} ( i , j ) = [ \begin{matrix}{rec}_{L} ( 2 i − 1 , 2 j − 1 ) − {rec}_{L} ( 2 i + 1 , 2 j − 1 ) + \\ {rec}_{L} ( 2 i − 1 , 2 j ) − {rec}_{L} ( 2 i + 1 , 2 j )\end{matrix} ] \qquad ( 34 )$$

Wherein rec_{L} represents the reconstructed luma sample values and ReC_{L}″ (i, j) represents the pre-operated luma sample values. Please also note that the 1-tap filters as shown in FIGS. 15A, 15C and 15D may be understood as alternatives for the down-sampling filters as used in CCLM (please refer to equations (6)-(7)), with changed filter coefficients.

Pre-operations can be according to gradients, edge direction (detection), pixel intensity, pixel variation, pixel variance, Roberts/Prewitt/compass/Sobel/Laplacian operator, high-pass filter (by calculating gradients or other relevant operators), low-pass filter (by performing weighted-average operations) . . . etc. The edge direction detectors listed in the examples can be extended to different edge directions. For example, 1-tap (1, −1) or 2-tap (a, b) applied along different directions to detect different edge gradients. The filter shape/coefficients can be symmetric with respect to the chroma position, as the FIGS. 15A to 15D examples (420 type-0 case).

The pre-operation parameters (coefficients, sign, scale/abs, thresholding, ReLU) can be fixed or signaled/switched in SPS/DPS/VPS/SEI/APS/PPS/PH/SH/Region/CTU/CU/Subblock/Sample levels. Note in the examples, if multiple coefficients apply on one sample (e.g., −1, 4), then they can be merged (e.g., 3) to reduce operations.

In one example, the pre-operations may relate to calculating sample differences of the luma sample values. Alternatively, the pre-operations may comprise performing down-sampling by weighted-average operations. In certain cases, the pre-operations can be applied repeatedly. For example, one may apply one template filtering to template to remove outliers using the low-pass smoothing FIR filter [1, 2, 1]/4, or [1, 2, 1; 1, 2, 1]/8 (i.e., down-sampling) and then apply 1-tap GLM filter to calculate the sample differences to derive the linear model. It may be contemplated that one may also calculate the sample differences and then enabling down-sampling.

In one example, the pre-operation coefficients (finally applied (e.g., 3), or middle applied (e.g., −1, 4) to per luma sample) can be limited to power-of-2 values to save multipliers.

In one aspect of the present disclosure, the proposed new method may be reused for/combined with the above discussed CCLM, which utilizing a simple linear regression (SLR) model and using one corresponding luma sample value to predict the chroma sample value. This is also referred to as a 1-tap case. In this case, deriving the linear model further comprises deriving a scale parameter α and an offset parameter β by using the pre-operated neighboring luma sample values and the neighboring chroma sample values. Or, the linear model may be re-written as:

$$C = α \cdot L + β \qquad ( 35 )$$

Wherein L here represents “pre-operated” luma samples. The parameter derivation of 1-tap GLM can reuse CCLM design, but taking directional gradient into consideration (may be with high-pass filter). In one example, the scale parameter α may be derived by utilizing a division look-up table, as detailed below, to enable simplification.

In one example, when combining GLM with the SLR model, the scale parameter α and the offset parameter β may be derived by utilizing the above-discussed min-max method. Specifically, the scale parameter α and the offset parameter β may be derived by: comparing the pre-operated neighboring luma sample values to determine a minimum luma sample value Y_{A} and a maximum luma sample value Y_{B}; determining corresponding chroma samples values X_{A} and X_{B} for the minimum luma sample value Y_{A} and the maximum luma sample value Y_{B}, respectively; and deriving the scale parameter α and the offset parameter β based on the minimum luma sample value Y_{A}, the maximum luma sample value Y_{B}, and the corresponding chroma samples values X_{A} and X_{B} according to the following equations:

$$\begin{matrix}α = \frac{{Y}_{A} − {Y}_{B}}{{X}_{A} − {X}_{B}} ; \\ β = {Y}_{A} − α {X}_{A} .\end{matrix} \qquad ( 36 )$$

In one example, when combining GLM with the SLR model, the above discussed scale adjustment may be reused. In this case, the encoder may determine a scale adjustment value (for example, “u”) to be signaled in the bitstream and add the scale adjustment value to the derived scale parameter α. The decoder may determine the scale adjustment value (for example, “u”) from the bitstream and add the scale adjustment value to the derived scale parameter α. The added value are finally used to predict the internal chroma sample values.

In one aspect of the present disclosure, the proposed new method may be reused for/combined with FLM, which utilizing a multiple linear regression (MLR) model and using multiple luma sample values to predict the chroma sample value. This is also referred to as a multi-tap case, for example, 2-tap. In this case, the linear model may be re-written as:

$$\begin{matrix}{C}^{0} = α \cdot {L}^{0} + β \\ {C}^{1} = α \cdot {L}^{1} + β \\ ⋮ \\ {C}^{M - 1} = α \cdot {L}^{M} + β\end{matrix} \qquad ( 37 )$$

$$[ \begin{matrix}{C}^{0} \\ {C}^{1} \\ ⋮ \\ {C}^{M − 1}\end{matrix} ] = [ \begin{matrix}{L}^{0} & 1 \\ {L}^{1} & 1 \\ ⋮ & ⋮ \\ {L}^{M − 1} & 1\end{matrix} ] [ \begin{matrix}α \\ β\end{matrix} ]$$

$$b = A x$$

$$x = {( {A}^{T} A )}^{− 1} {A}^{T} b = {A}^{+} b$$

$$α = \frac{n \sum {x}_{k} {y}_{k} − \sum {x}_{k} \sum {y}_{k}}{n \sum {x}_{k}^{2} − {( \sum {x}_{k} )}^{2}} = \frac{{A}_{1}}{{A}_{2}}$$

$$β = \frac{\sum {y}_{k} - α \sum {x}_{k}}{n} = \overline{y} - α \overline{x}$$

In this case, multiple scale parameters α and an offset parameter β may be derived by using the pre-operated neighboring luma sample values and the neighboring chroma sample values. In one example, the offset parameter β is optional. In one example, at least one of the multiple scale parameters α may be derived by utilizing the sample differences. Moreover, another of the multiple scale parameters α may be derived by utilizing the down-sampled luma sample value. In one example, at least one of the multiple scale parameters α may be derived by utilizing horizontal or vertical sample differences calculated on the basis of down-sampled neighboring luma sample values. In other words, the linear model may combine multiple scale parameters α associated with different pre-operations.

### Implicit Filter Shape Derivation

In one example, instead of explicitly signaling the selected filter shape index, the used direction oriented filter shape can be derived at decoder to save bit overhead. For example, at the decoder, a number of directional gradient filters may be applied for each reconstructed luma sample of the L-shaped template of the i-th neighboring row and column of the current block. Then the filtered values (gradients) may be accumulated for each direction of the number of directional gradient filters respectively. In an example, the accumulated value is an accumulated value of absolute values of corresponding filtered values. After the accumulation, the direction of the directional gradient filter for which the accumulated value is the largest may be determined as the derived (luma) gradient direction. For example, a Histogram of Gradients (HoG) may be built to determine the largest value. The derived direction can be further applied as the direction for predicting chroma samples in the current block.

The following example involves reusing the decoder-side intra mode derivation (DIMD) method for luma intra prediction included in ECM-4.0:
Step 1: applying 2 kinds of directional gradient filters (3×3 hor/ver Sobel) for each reconstructed luma sample of the L-shaped template of the 2^{nd} neighboring row and column of the current block;
Step 2: accumulating filtered values (gradients) by SAD (sum of absolute differences) for each of the directional gradient filters;
Step 3: Build a Histogram of Gradients (HoG) based on the accumulating filtered values; and
Step 4: The largest value in HoG is determined to be the derived (luma) gradient direction, based on which the GLM filter may be determined.

In one example, if the shape candidates are [−1, 0, 1; −1, 0, 1](horizontal) and [1, 2, 1; −1, −2, −1](vertical), when the largest value is associated with the horizontal shape, then use shape [−1, 0, 1; −1, 0, 1] for GLM based chroma prediction.

The gradient filter used for deriving the gradient direction can be the same or different with the GLM filter in shape. For example, both of the filters may be horizontal [−1, 0, 1; −1, 0, 1], or the two filters may have different shapes, while the GLM filter may be determined based on the gradient filter.

The proposed GLM can be combined with above discussed MMLM or ELM. When combined with classification, each group can share or have its own filter shape, with syntaxes indicating shape for each group. For example, as an exemplary classifier, horizontal gradients grad_hor may be classified into a first group, which correspond to a first linear model, and vertical gradients grad_ver may be classified into a second group, which correspond to a second linear model. In one example, the horizontal luma patterns may be generated only once.

Further possible classifiers are also provided as follows. With the classifiers, the neighboring and internal luma-chroma sample pairs of the current video block may be classified into multiple groups based on one or more thresholds. Please note that, as discussed above, each neighboring/internal chroma sample and its corresponding luma sample may be referred to as a luma-chroma sample pair. The one or more thresholds are associated with intensities of neighboring/internal luma samples. In this case, each of the multiple groups corresponds to a respective one of the plurality of linear models.

When combining with MMLM classifier, the following operations may be performed: classifying neighboring reconstructed luma-chroma sample pairs of the current video block into 2 groups based on Threshold; deriving different linear models for different groups, wherein the deriving process may be GLM simplified, i.e., with the above pre-operations to reduce the number of taps; classifying luma-chroma sample pairs inside the CU (internal luma-chroma sample pairs, wherein each of the internal luma-chroma sample pairs comprises an internal chroma sample value to be predicted with the derived linear model) into 2 groups similarly based on Threshold; applying different linear models to the reconstructed luma samples in different groups; and predicting chroma samples in the CU based on different classified linear models. Wherein Threshold may be average value of the neighboring reconstructed luma samples. Note the number of classes (2) can be extended to multiple classes by increasing the number of Threshold (e.g., equally divided based on min/max of neighboring reconstructed (down-sampled) luma samples, fixed or signaled/switched in SPS/DPS/VPS/SEI/APS/PPS/PH/SH/Region/CTU/CU/Subblock/Sample levels).

In one example, instead of MMLM luma DC intensity, the filtered values of FLM/GLM apply on neighboring luma samples are used for classification. For example, if 1-tap (1, −1) GLM is applied, average AC values are used (physical meaning). The processing can be: classifying neighboring reconstructed luma-chroma sample pairs into K groups based on one or more filter shapes, one or more filtered values, and K−1 Threshold Ti; deriving different MLR models for different groups, wherein the deriving process may be GLM simplified, i.e., with the above pre-operations to reduce the number of taps; classifying luma-chroma sample pairs inside the CU (internal luma-chroma sample pairs, wherein each of the internal luma-chroma sample pairs comprises an internal chroma sample value to be predicted with the derived linear model) into K groups similarly based on one or more filter shapes, one or more filtered values, and K−1 Threshold Ti; applying different linear models to the reconstructed luma samples in different groups; predicting chroma samples in the CU based on different classified linear models. Wherein Threshold can be predefined (e.g., 0, or can be a table) or signaled/switched in SPS/DPS/VPS/SEI/APS/PPS/PH/SH/Region/CTU/CU/Subblock/Sample levels). For example, Threshold can be the average AC value (filtered value) (2 groups), or equally divided based on min/max AC (K groups), of neighboring reconstructed (can be down-sampled) luma samples.

It is also proposed to combine GLM with ELM classifier. As shown in FIGS. 15A to 15D, one filter shape (e.g., 1-tap) may be selected to calculate edge strengths. The direction is determined as a direction along which a sample difference between samples of the current and N neighboring samples (e.g., all 6 luma samples) is calculated. For example, the filter (shape [1, 0, −1; 1, 0, −1]) at the upper middle in FIG. 15A indicates a horizontal direction since a sample difference may be calculated between samples in the horizontal direction, while the filter below it (shape [1, 2, 1; −1, −2, −1]) indicates a vertical direction since a sample difference may be calculated between samples in the vertical direction. The positive and negative coefficients in each of the filters enable the calculation of the sample differences. The processing may then comprise: calculating one edge strength by the filtered value (e.g., equivalent); quantizing the edge strength into M segments by M−1 thresholds Ti; using K classes to classify the current sample. (e.g., K==M); deriving different MLR models for different groups, wherein the deriving process may be GLM simplified, i.e., with the above pre-operations to reduce the number of taps; classifying luma-chroma sample pairs inside the CU into K groups; applying different MLR models to the reconstructed luma samples in different groups; and predicting chroma samples in the CU based on different classified MLR models. Please note that the filter shape used for classification can be the same or different with the filter shape used for MLR prediction. Both and the number of thresholds M−1, the thresholds values Ti, can be fixed or signaled/switched in SPS/DPS/VPS/SEI/APS/PPS/PH/SH/Region/CTU/CU/Subblock/Sample levels. Moreover, other classifiers/combined-classifiers as discussed in ELM can also be used for GLM.

If classified samples in one group are less than a number (e.g., predefined 4), default values mentioned when discussing the matrix derivation for the MLR model can be applied for the group parameters (αᵢ, β). If the corresponding neighboring reconstructed samples are not available with respect to the selected LM modes, default values can be applied. For example, when MMLM_L mode is selected but left samples are not valid.

Several methods relate to simplification for GLM are introduced as follows for further improving coding efficiency.

The matrix/parameter derivation in FLM requires floating-point operation (e.g., division in closed-form), which is expensive for decoder hardware, so a fixed-point design is required. For 1-tap GLM case, it can be taken as modified luma reconstructed sample generation of CCLM (e.g., horizontal gradient direction, from CCLM [1, 2, 1;1, 2, 1]/8 to GLM [−1, 0, 1; −1, 0, 1]), the original CCLM process can be reused for GLM, including fixed-point operation, MDLM downsampling, division table, applied size restriction, min-max approximation, and scale adjustment. For all items, 1-tap GLM can have its own configurations or share the same design as CCLM. For example, using simplified min-max method to derive the parameters (instead of LMS), and combined with scale adjustment after GLM model is derived. In this case, the center point (luminance value yᵣ) used to rotate the slope becomes the average of the reference luma samples “gradient”. Another example, when GLM is on for this CU, CCLM slope adjustment is inferred off and don't need to signal slope adjustment related syntaxes.

This section takes typical case reference samples (up 1 row and left 1 column) for example. Note as in FIG. 14, extended reconstructed region can also use the simplification with the same spirit, and may be with syntax indicating the specific region (like MDLM, MRL).

Please note that the following aspects can be combined and applied jointly. For example, combining reference sample down-sampling and division table to perform the division process.

When classification (MMLM/ELM) is applied, each group can apply the same or different simplification operation. For example, samples for each group are padded respectively to the target sample number before applying right shift, and then apply the same derivation process, same division table.

### Fixed-Point Implementation

The 1-tap case can reuse the CCLM design, dividing by n may be implemented by right shift, dividing by A₂ may be implemented by a LUT. The integerization parameters, including n_{α}, n_{A}_{₁}, n_{A}_{₂}, r_{A}_{₁}, r_{A}_{₂} n_{table} involved in the integerization design of LMS CCLM and intermediate parameters for deriving the linear model (equations (19)-(20)) can be the same as CCLM or have different values, to have more precision. The integerization parameters can be predefined or signaled/switched in SPS/DPS/VPS/SEI/APS/PPS/PH/SH/Region/CTU/CU/Subblock/Sample levels, can be conditioned on sequence bitdepth. For example, n_{table}=bitdepth+4.

### MDLM Down-Sample

When GLM is combined with MDLM, the existed total samples used for parameter derivation may not be power-of-2 values, and need padding to power-of-2 to replace division with right shift operation. For example, for an 8×4 chroma CU, MDLM needs W+H=12 samples, with MDLM_T only 8 samples are available (reconstructed), then down-sampled 4 samples (0, 2, 4, 6) may be padded equally. Codes for implementing such operations are shown as follows:

```
int targetSampNum = 1 << ( floorLog2( existSampNum − 1 ) + 1 );
if (targetSampNum != existSampNum)//if existSampNum not a value
of power of 2
{
  xPadMdlmTemplateSample;
}
int step = (int)(existSampNum / sampNumToBeAdd);
for (int i = 0; i < sampNumToBeAdd; i++)
{
  pTempSrc[i] = pSrc[i * step];
  pTempCur[i] = pCur[i * step];
}
```

Other padding method like repetitive/mirror padding with respect to last neighbouring samples (rightmost/lowermost) can also be applied.

The padding method for GLM can be the same or different with that of CCLM.

Note in ECM version, an 8×4 chroma CU MDLM_T/MDLM_L needs 2T/2L=16/8 samples respectively, in such case, same padding method can be applied to meet the target power-of-2 sample number.

### Division LUT

Division LUT proposed for CCLM/LIC (Local Illumination Compensation) in known standard development like AVC/HEVC/AV1/VVC/AVS can be used for GLM division. For example, reusing the LUT in JCTVC-I0166 for bitdepth=10 case (Table 4). The division LUT can be different from CCLM. For example, CCLM uses min-max with DivTable as in equation 5, but GLM uses 32-entries LMS division LUT as in Table 5.

When GLM is combined with MMLM, the meanL values may not always be positive (e.g., using filtered/gradient values to classify groups), so sgn(meanL) needs to be extracted, and use abs(meanL) to look-up the division LUT. Note division LUT used for MMLM classification and parameter derivation can be different. For example, using lower precision LUT (as the LUT in min-max) for mean classification, and using higher precision LUT (as in the LMS) for parameter derivation.

### Size Restriction and Latency Constraint

Similar to the CCLM design, some size restrictions can be applied for ELM/FLM/GLM. For example, same constraint for luma-chroma latency in dual tree may be applied.

The size restriction can be according to the CU area/width/height/depth. The threshold can be predefined or signaled in SPS/DPS/VPS/SEI/APS/PPS/PH/SH/Region/CTU/CU/Subblock/Sample levels. For example, the predefined threshold may be 128 for chroma CU area.

In one example, the at least one pre-operation is performed in response to determining that the video block meets an enabling threshold, wherein the enabling threshold is associated with area, width, height or partition depth of the video block. Specifically, the enabling threshold may define a minimum or maximum area, width, height or partition depth of the video block. As understood by one skilled in the art, the video block may comprise a current chroma block and its collocated luma block. It is also proposed to apply the above enabling threshold for the current chroma block and its collocated luma block jointly. For example, the at least one pre-operation is performed in response to determining the enabling threshold is met for both the current chroma block and its collocated luma block.

### Line Buffer Reduction

Similar to the CCLM design, if the collocated luma area of the current chroma CU contains the 1st row inside one CTU, the top template samples generation can be limited to 1 row, to reduce CTU row line buffer storage. Note that only one luma line (general line buffer in intra prediction) is used to make the down-sampled luma samples when the upper reference line is at the CTU boundary.

For example, in FIG. 13, if the collocated luma area of the current chroma CU contains the 1st row inside one CTU, top template can be limited to only use 1 row (but not 2) for parameter derivation (other CUs can still use 2 rows). This saves luma sample line buffer storage when processing CTU row by row at decoder hardware. Several methods can be used to achieve the line buffer reduction. Note the example of limited “1” row can be extended to N rows with similar operations. Similarly, 2-tap or multi-tap can also apply such operations. When applying multi-tap, chroma samples may also need to apply operations.

For example, take the 1-tap filter [1, 0, −1; 1, 0, −1] shown in FIG. 15A as an example for illustration. This filter can be reduced to [0, 0, 0; 1, 0, −1], i.e., only use below row coefficients. Alternatively, the limited upper row luma samples can be padded (repetitive, mirror, 0, meanL, meanC . . . etc.) from the bellow row luma samples.

Take an example where N=4, that is, the video block is at a top boundary of a current CTU, while top 4 rows of neighboring luma sample values and corresponding chroma sample values are used for deriving the linear model. Please note that, the corresponding chroma sample values may refer to corresponding top 4 rows of neighboring chroma sample values (for example, for the YUV 4:4:4 format). Alternatively, the corresponding chroma sample values may refer to corresponding top 2 rows of neighboring chroma sample values (for example, for the YUV 4:2:0 format). In this case, the top 4 rows of neighboring luma sample values and corresponding chroma sample values may be divided into two regions—a first region comprising valid sample values (for example, the one nearest row of luma sample values and corresponding chroma sample values) and a second region comprising invalid sample values (for example, the other three rows of luma sample values and corresponding chroma sample values). Then coefficients of the filter corresponding to sample positions not belonging to the first region may be set as zeros, such that only sample values from the first region are used for calculating the sample differences. For example, as discussed above, in this case the filter [1, 0, −1; 1, 0, −1] can be reduced to [0, 0, 0; 1, 0, −1]. Alternatively, the nearest sample values in the first region may be padded to the second region, such that the padded sample values may be used to calculate the sample differences.

### Fusion of Chroma Intra Prediction Modes

In one example, since GLM can be taken as one special CCLM mode, the fusion design can be reused or have its own way. Multiple (two or more) weights can be applied to generation the final predictor. For example,

$$pred = ( w 0 * pred 0 + w 1 * pred 1 + ( 1 ≪ ( shift - 1 ) ) ) ≫ shift$$

wherein pred0 is the predictor based on non-LM mode, while pred1 is the predictor based on GLM, or pred0 is the predictor based on one of CCLM (including all MDLM/MMLM), while pred1 is the predictor based on GLM, or pred0 is the predictor based on GLM, while pred1 is the predictor based on GLM.

Different I/P/B slices can have different designs for weights, w0 and w1, depending on if neighboring blocks is coded with CCLM/GLM/other coding mode or the block size/width/height.

For example, the designs for weights can be determined by the intra prediction mode of adjacent chroma blocks and shift is set equal to 2. Specifically, when the above and left adjacent blocks are both coded with LM modes, then {w0, w1}={1, 3}; when the above and left adjacent blocks are both coded with non-LM modes, then {w0,w1}={3, 1}; otherwise, {w0,w1}={2, 2}. For non-I slices, w0 and w1 can both be set equal to 2.

For the syntax design, if a non-LM mode is selected, one flag is signaled to indicate whether the fusion is applied.

As described above, GLM has good gain complexity trade-off since it can reuse the existing CCLM module without introducing additional derivation. Such 1-tap design can be extended or generalized further according to one or more aspects of the present disclosure.

In an aspect of the present disclosure, for a chroma sample to be predicted, one single corresponding luma sample L may be generated by combining collocated luma sample and neighboring luma samples. For example, the combination may be a combination of different linear filters, e.g., a combination of a high-pass gradient filter (GLM) and a low-pass smoothing filter (e.g., [1, 2, 1; 1, 2, 1]/8 FIR down-sampling filter that may be generally used in CCLM); and/or a combination of a linear filter and a non-linear filter (e.g., with power of n, e.g., Lⁿ, n can be positive, negative, or +− fractional number (e.g., +½, square root or +3, cube, which can rounding and rescale to bitdepth dynamic range)).

In an aspect of the present disclosure, the combination may be repeatedly applied. For example, a combination of GLM and [1, 2, 1; 1, 2, 1]/8 FIR may be applied on the reconstructed luma samples, and then a non-linear power of ½ may be applied. For example, the non-linear filter may be implemented as LUT (look up table), e.g, for bitDepth=10, power of n, n=½, LUT[i]=(int)(sqrt(i)+0.5)<<5, i=0-1023, where 5 is to scale to bitdepth=10 dynamic range. The nonlinear filter may provide options when linear filter cannot handle the luma-chroma relationship efficiently. Whether to use nonlinear term can be predefined or signaled/switched in SPS/DPS/VPS/SEI/APS/PPS/PH/SH/Region/CTU/CU/Subblock/Sample levels.

In the above one or more aspects of the present disclosure, the GLM may refer to Generalized Linear Model (may be used to generate one single luma sample linearly or nonlinearly, and the generated one single luma sample may be fed into the CCLM linear model to derive parameters of the CCLM linear model), linear/nonlinear generation may be called general patterns. Different gradient or general patterns can be combined to form another pattern. For example, a gradient pattern may be combined with a CCLM down-sampled value; a gradient pattern may be combined with a non-linear L² value; a gradient pattern may be combined with another gradient pattern, the two gradient patterns to be combined may have different directions or the same direction, e.g., [1, 1, 1; −1, −1, −1] and [1, 2, 1; −1, −2, −1], which both have a vertical direction, may be combined, also [1, 1, 1; −1, −1, −1] and [1, 0, −1; 1, 0, −1], which have a vertical and horizontal directions, may be combined, as shown in FIGS. 15A to 15D. The combination may comprise plus, minus, or linear weighted.

### GLM Applied on Down-Sampled Domain

As described above, pre-operations can be applied repeatedly and GLM can be applied on pre linear weighted/pre-operated samples. For example, as CCLM, one template filtering can be applied to luma samples, in order to remove outliers using the low-pass smoothing FIR filter [1, 2, 1; 1, 2, 1]/8 (i.e., CCLM down-sampling smoothing filter) and to generate down-sampled luma samples (one down-sampled luma sample corresponding to one chroma sample). And after that, 1-tap GLM can be applied on smoothed down-sampled luma samples to derive the MLR model.

Some gradient filter patterns, such as 3×3 Sobel or Prewitt operators, can be applied on down-sampled luma samples. The following table shows some of the gradient filter patterns.

| Gradient filter pattern | Filter shape |
|---|---|
| 0 | [1, 0, −1; 2, 0, −2; 1, 0, −1] |
| 1 | [1, 2, 1; 0, 0, 0; −1, −2, −1] |
| 2 | [2, 1, 0; 1, 0, −1; 0, −1, −2] |
| 3 | [0, 1, 2; −1, 0, 1; −2, −1, 0] |
| 4 | [0, 1, −1; 0, 2, −2; 0, 1, −1] |
| 5 | [0, 0, 0; 1, 2, 1; −1, −2, −1] |
| 6 | [0, 0, 0; 0, 2, 0; 0, 0, −2] |
| 7 | [0, 0, 0; 0, 2, 0; −2, 0, 0] |
| 8 | [1, −1, 0; 2, −2, 0; 1, −1, 0] |
| 9 | [1, 2, 1; −1, −2, −1; 0, 0, 0] |
| 10 | [2, 0, 0; 0, −2, 0; 0, 0, 0] |
| 11 | [0, 0, 2; 0, −2, 0; 0, 0, 0] |
| 12 | [0, 0, 0; 2, 0, −2; 0, 0, 0] |
| 13 | [0, 2, 0; 0, 0, 0; 0, −2, 0] |
| 14 | [2, 0, 0; 0, 0, 0; 0, 0, −2] |
| 15 | [0, 0, 2; 0, 0, 0; −2, 0, 0] |

The gradient filter patterns can be combined with other gradient/general filter patterns in the down-sampled luma domain. In one example, a combined filter pattern may be applied on down-sampled luma samples. For example, the combined filter pattern may be derived by performing addition or subtraction operations to respective coefficients of the gradient filter pattern and a DC/low-pass based filter pattern, such as filter pattern [0, 0, 0; 0, 1, 0; 0, 0, 0], or [1, 2, 1; 2, 4, 1; 1, 2, 1]. In another example, the combined filter pattern is derived by performing addition or subtraction operations to a coefficient of the gradient filter pattern and a non-linear value such as L^{Z}. In another example, the combined filter pattern is derived by performing addition or subtraction operations to respective coefficients of the gradient filter pattern and another gradient filter pattern having a different or the same direction. In another example, the combined filter pattern is derived by performing linear weighted operations to the coefficients of the gradient filter pattern.

GLM applied on down-sampled domain can fit in CCCM framework but may sacrifice high frequency accuracy since low-pass smoothing is applied before applying GLM.

### GLM Serves as Input of CCCM

As illustrated above, CCCM applies luma down-sampling before convolution as with CCLM. The reconstructed luma samples are down-sampled to match the lower resolution chroma grid when chroma sub-sampling is used. Since 1-tap GLM can also be taken as changing CCLM down-sample filter coefficients (e.g., from [1, 2, 1; 1, 2, 1]/8 to [1, 2, 1, −1, −2, −1], i.e., from low-pass to high-pass), the GLM can serve as the input of CCCM. Specifically, the gradient filter of GLM replaces luma down-sampling filter ([1, 2, 1; 1, 2, 1]/8) with gradient-based coefficients (e.g., [1, 2, 1, −1, −2, −1). In this case, CCCM operation becomes “linear/non-linear combination of gradients”, as shown by the following equation:

$$predChromaVal = {c}_{0} C + {c}_{1} N + {c}_{2} S + {c}_{3} E + {c}_{4} W + {c}_{5} P + {c}_{6} B$$

where C, N, S, E, W, P are gradients of current or neighboring samples (compared to original down-sample values for CCCM). Related GLM methods described in this disclosure can be applied in the same way before entering CCCM convolution, e.g., classification, separate Cb/Cr control, syntax, pattern combining, PU size restriction etc.

The gradient-based coefficients replacement can apply to specific CCCM taps. Also, not only high-pass but low-pass/band-pass/all-pass coefficients replacement can be used. The replacement can be combined with FLM/CCCM shape switch discussed above (leading to different number of taps). For example, gradient patterns in FIGS. 15A to 15D can be used for replacement. In one example, the operations for applying GLM as input of CCCM includes: predefining one or more coefficients candidates for CCCM/FLM down-sampling; determining CCCM/FLM filter shape and number of filter taps for this CU; applying different CCLM down-sample coefficients to different filter taps, wherein the coefficients can be high-pass filters (GLM), or low-pass/band-pass/all-pass filters; generating the down-sampled luma samples (using the applied coefficients) for CCCM input samples; and feeding the generated down-sampled luma samples into CCCM process.

The following shows some examples for changing the CCLM down-sample filter coefficients:

### Example 1

Candidate filters are [1, 2, 1; 1, 2, 1]/8 and [1, 0, −1; 1, 0, −1]; predChromaVal=c₀C+c₁N+c₂S+c₃E+c₄W+c₅P+c₆B, using typical CCCM cross shape, 7-tap; N, S, W, E use filters [1, 2, 1; 1, 2, 1]/8, keeping original CCLM down-sampling filter; and C, P use filters [1, 0, −1; 1, 0, −1], i.e., horizontal gradient filter, and P then physically means gradient\hat{ }2.

### Example 2

Candidate filters are [1, 2, 1; 1, 2, 1]/8, [1, 0, −1; 1, 0, −1], [1, 2, 1; −1, −2, −1], [2, 1, −1; 1, −1, −2], and [−1, 1, 2; −2, −1, 1]; predChromaVal=c₀C₀+c₁C₁+c₂C₂+c₃C₃+c₄C₄+c₅P+c₆B; C₀ uses filter [1, 2, 1; 1, 2, 1]/8, keeping original CCLM down-sampling filter; C₁ uses filter [1, 0, −1; 1, 0, −1]; C₂ uses filter [1, 2, 1; −1, −2, −1]; C₃ uses filter [2, 1, −1; 1, −1, −2]; C₄ uses filter [−1, 1, 2; −2, −1, 1]; C₅ uses filter [1, 2, 1; 1, 2, 1]/8, keeping original CCLM down-sampling filter; C₀ to C₅, and P have the same down-sampled luma position (==C in typical CCCM cross shape); and C₁ to C₄ are generated by different direction Sobel-based gradient filters (as shown in FIGS. 15A to 15D).

### Example 3

Candidate filters are [1, 2, 1; 1, 2, 1]/8, [1, 0, −1; 1, 0, −1], [1, 2, 1; −1, −2, −1], [0, 1, 1; 0, 1, 1], and [1, 1, 0; 1, 1, 0]; predChromaVal=c₀C₀+c₁C₁+c₂C₂+c₃C₃+c₄C₄+c₅P+c₆B; C₀ uses filter [1, 2, 1; 1, 2, 1]/8, keeping original CCLM down-sampling filter; C₁ uses filter [1, 0, −1; 1, 0, −1]; C₂ uses filter [1, 2, 1; −1, −2, −1]; C₃ uses filter [0, 1, 1; 0, 1, 1]; C₄ uses filter [1, 1, 0; 1, 1, 0]; C₅ uses filter [1, 2, 1; 1, 2, 1]/8, keeping original CCLM down-sampling filter; C₀ to C₅, and P have the same down-sampled luma position (==C in typical CCCM cross shape); C₁ to C₂ are generated by different direction Sobel-based gradient filters (as shown in FIGS. 15A to 15D); and C₃ to C₄ are generated by low-pass filters.

Which CCCM/FLM taps to apply the coefficients replacement can be predefined (as above examples) or signaled/switched in SPS/DPS/VPS/SEI/APS/PPS/PH/SH/Region/CTU/CU/Subblock/Sample levels.

For each CCCM/FLM tap, the coefficients candidate for CCCM/FLM down-sampling can be predefined or signaled/switched in SPS/DPS/VPS/SEI/APS/PPS/PH/SH/Region/CTU/CU/Subblock/Sample levels.

### Example 4

Candidate filters are [1, 2, 1; 1, 2, 1]/8, [1, 0, −1; 1, 0, −1], [1, 2, 1; −1, −2, −1], [2, 1, −1; 1, −1, −2], and [−1, 1, 2; −2, −1, 1]; predChromaVal=c₀C+c₁N+c₂S+c₃E+c₄W+c₅P+c₆B, using typical CCCM cross shape, 7-tap; C uses switching down-sampling filters among 5 candidate filters; N, S, W, E use filter [1, 2, 1; 1, 2, 1]/8, keeping original CCLM down-sampling filter; and P uses switching down-sampling filters among 5 candidate filters.

### Example 5

Candidate filters are: [1, 2, 1; 1, 2, 1]/8, [1, 0, −1; 1, 0, −1], [1, 2, 1; −1, −2, −1], [0, 1, 1; 0, 1, 1], and [1, 1, 0; 1, 1, 0]; predChromaVal=c₀C+c₁W+c₂E+c₃P+c₄B, i.e., horizontal minus sign shape, 5-tap; C uses switching down-sampling filters among 5 candidate filters; W, E use switching down-sampling filters among 3 candidate filters: [1, 2, 1; 1, 2, 1]/8, [0, 1, 1; 0, 1, 1], and [1, 1, 0; 1, 1, 0]; and P uses filter [1, 2, 1; 1, 2, 1]/8, keeping original CCLM down-sampling filter.

In one or more aspects of the present disclosure, one or more syntaxes may be introduced to indicate information on the GLM. An example of GLM syntaxes is illustrated in the following Table 10.

TABLE 10

| Level | Syntax element | Binarization | Meaning |
|---|---|---|---|
| SPS | glm_enabled_flag | FLC | whether GLM is enabled in the |
| | | | sequence, can be inferred off when |
| | | | chromaFormat == CHROMA_400, |
| | | | or CCLM is off |
| PH/SH | ph_glm_flag | FLC | whether GLM is enabled in this |
| | ph_glm_cb_flag | | picture/slice for Cb/Cr, can be |
| | ph_glm_cr_flag | | inferred off when chromaFormat == |
| | | | CHROMA_400, or CCLM is off, one |
| | | | flag can be added to jointly control |
| | | | “if either Cb/Cr is on” |
| PH/SH | ph_glm_ctb_control_flag | FLC | whether to enable Cb/Cr on/off |
| | ph_glm_cb_ctb_control_flag | | control at CTB level, one flag can be |
| | ph_glm_cr_ctb_control_flag | | added to jointly control “if either |
| | | | Cb/Cr is enable on/off control at |
| | | | CTB level” |
| CTU | ctb_glm_flag | CABAC | whether GLM can be enabled for the |
| | ctb_glm_cb_flag | | current Cb or Cr CTB, can be |
| | ctb_glm_cr_flag | | CABAC bypass coded or with N |
| | | | contexts (2: up/left, or N neighboring |
| | | | CTBs), one flag can be added to |
| | | | jointly control “if either Cb/Cr can be |
| | | | enabled” |
| CU | cu_glm_flag | CABAC, TU | whether GLM is enabled for the |
| | cu_glm_cb_flag | | current Cb or Cr CU, can be CABAC |
| | cu_glm_cr_flag | | bypass coded or with N contexts (2: |
| | | | up/left, or N neighboring CUs), one |
| | | | flag can be added to jointly control |
| | | | “if either Cb/Cr can be enabled” |
| CU | glm_cb_filter_idx | CABAC, TU, | which filter shape idx (gradient |
| | glm_cr_filter_idx | FLC | pattern) (in the predefined set) is |
| | | | used for the CU, can be CABAC |
| | | | bypass coded or with N contexts (2: |
| | | | up/left, or N neighboring CUs), as |
| | | | stated in FLM syntax, Cb/Cr can |
| | | | have its own filter shape idx |
| | | | (gradient pattern) or share the same |
| | | | filter shape. |
| CU | glm_cb_mdlm_idx | CABAC, TU | which MDLM idx (GLM, GLM_L, |
| | glm_cr_mdlm_idx | | GLM_T) is used for the CU, can be |
| | | | CABAC bypass coded or with N |
| | | | contexts (2: up/left, or N neighboring |
| | | | CUs) |
| CU | glm_cb_mrl_idx | CABAC, TU | which GLM MRL idx (e.g., 0, 1) is |
| | | | used for the CU, can be CABAC |
| | glm_cr_mrl_idx | | bypass coded or with N contexts (2: |
| | | | up/left, or N neighboring CUs) |

FLC: fixed length code
TU: truncated unary code
EGk: exponential-golomb code with order k, where k can be fixed or signaled/switched in SPS/DPS/VPS/SEI/APS/PPS/PH/SH/Region/CTU/CU/Subblock/Sample levels.
SVLC: signed EGO
UVLC: unsigned EGO

Please be noted that the binarization of each syntax element may be changed.

In an aspect of the present disclosure, The GLM on/off control for Cb/Cr components may be jointly or separately. For example, at CU level, 1 flag may be used to indicate if GLM is active for this CU. If active, 1 flag may be used to indicate if Cb/Cr are both active. If not both active, 1 flag to indicate either Cb or Cr is active. Filter index/gradient (general) pattern may be signaled separately when Cb and/or Cr is active. All flags may have its own context model or be bypass coded.

In another aspect of the present disclosure, whether to signal GLM on/off flags may depend on luma/chroma coding modes, and/or CU size. For example, in ECM5 chroma intra mode syntax, GLM may be inferred off when MMLM or MMLM_L or MMLM_T is applied; when CU area <A, where A can be predefined or signaled/switched in SPS/DPS/VPS/SEI/APS/PPS/PH/SH/Region/CTU/CU/Subblock/Sample levels; If combined with CCCM, GLM may be inferred off when CCCM is on.

Please be noted that when GLM is combined with MMLM, different models may share the same or have their own gradient/general patterns.

| | | |
|---|---|---|
| intra_chroma_pred_mode | bin string | chroma intra mode |

| | | | |
|---|---|---|---|
| 10 | 77 | 00 | DM |
| 11 | | 010 | DIMD_CHROMA |
| 0 | | 01100 | PLANAR |
| 1 | | 01101 | VER |
| 2 | | 01110 | HOR |
| 3 | | 01111 | DC |
| 4 | 67 | 10 | LM |
| 5 | 68 | 110 | MMLM |
| 6 | 69 | 1110 | LM_L |
| 7 | 71 | 11110 | LM_T |
| 8 | 70 | 111110 | MMLM_L |
| 9 | 72 | 111111 | MMLM_T |

When GLM is combined with CCCM/FLM, CU level GLM enabling flag can be inferred off if current CU is enabled as CCCM/FLM.
hasGlmFlag &=!pu.cccmFlag;
   CCCM without Down-Sampled Process

CCCM requires to process down-sampled luma reference values before the calculation of model parameters and applying the CCCM model, which burden decoder processing cycles. In this section, CCCM without down-sampling process is proposed, including utilizing non-down-sampled luma reference values and/or different selection of non-down-sampled luma reference. One or more filter shapes may be used for the purpose as described below.

Please note that methods/examples in this section can be combined/reused with the methods mentioned above, including but not limited to methods related to classification, filter shape, matrix derivation (with special handling), applied region, and syntax. Moreover, methods/examples listed in this section can also be applied with the methods/examples above (more taps), to have a better performance with certain complexity trade-off.

In this disclosure, reference samples/training templates/reconstructed neighboring regions usually refer to the luma samples used for deriving the MLR model parameters, which are then applied to the inner luma samples in one CU, to predict the chroma samples in the CU.

### Filter Shape

One or more shape/number of filter taps may be used for CCCM prediction, as shown in FIG. 16, FIG. 17, and FIGS. 18A to 18B. One or more sets of filter taps may be used for FLM prediction, examples being shown in FIGS. 19A to 19G. The selected luma reference values are non-down-sampled. One or more predefined shape/number of filter taps may be used for CCCM prediction based on previous decoded information on TB/CB/slice/picture/sequence level.

Though a multiple tap filter can fit well on training data (i.e., top/left neighboring reconstructed luma/chroma samples), in some cases, that training data do not capture full characteristics of the testing data, and it may result in overfitting and may not predict well on the testing data (i.e., the to-be-predicted chroma block samples). Also, different filter shapes may adapt well to different video block content, leading to more accurate prediction. To address this issue, the filter shape/number of filter taps can be predefined or signaled/switched in SPS/DPSNPS/SEI/APS/PPS/PH/SH/Region/CTU/CU/Subblock/Sample levels. A set of filter shape candidates can be predefined or signaled/switched in SPS/DPSNPS/SEI/APS/PPS/PH/SH/Region/CTU/CU/Subblock/Sample levels. Different components (UN) may have different filter switch control. For example, as shown in the following table, predefining a set of filter shape candidates (idx=0-5), and filter shape (1, 2) denotes a 2-tap luma filter, while filter shape (1, 2, 4) denotes a 3-tap luma filter as shown in FIG. 11 . . . etc. The filter shape selection of UN components can be switched in PH or in CU/CTU levels. Note that N-tap can represent N-tap with or without the offset β as described above.

| predefined filter shape candidates: | | # of filter taps | filter shape |
|---|---|---|---|
| idx | 0 | 2 | (1, 2) |
| idx | 1 | 2 | (1, 4) |
| idx | 2 | 2 | (1, 5) |
| idx | 3 | 3 | (1, 2, 4) |
| idx | 4 | 4 | (1, 2, 4, 5) |
| idx | | 6 | (0, 1, 2, 3, 4, 5) |

| POC | comp | selected filter shape idx | |
|---|---|---|---|
| 0 | U | 3 | PH switch |
| | V | 0~5 | CU switch |
| 1 | U | 4 | PH switch |
| | V | 0~2 | CTU switch |

Different chroma types/color formats can have different predefined filter shapes/taps. For example, using predefined filter shape for 420 type-0: (1, 2, 4, 5), 420 type-2: (0, 1, 2, 4, 7), 422: (1, 4), 444: (0, 1, 2, 3, 4, 5) as shown in FIG. 12.

The unavailable luma/chroma samples for deriving the MLR model can be padded from available reconstructed samples. For example, if using a 6-tap (0, 1, 2, 3, 4, 5) filter as in FIG. 12, for a CU located at the left picture boundary, the left columns including (0, 3) are not available (out of picture boundary), so (0, 3) are repetitive padding from (1, 4) to apply the 6-tap filter. Note the padding process applied in both training data (top/left neighboring reconstructed luma/chroma samples) and testing data (the luma/chroma samples in the CU).

According to one or more embodiments of the disclosure, the unavailable luma/chroma samples for deriving the MLR model can be skipped and not used. Then the padding process is not needed for the unavailable luma/chroma samples.

CCLM/MMLM with LDL Decomposition

CCCM requires to process LDL decomposition to calculate the model parameters of CCCM model, avoiding using square root operations and only integer arithmetic is required. In this section, CCLM/MMLM with LDL decomposition are proposed. LDL decomposition may also be used in ELM/FLM/GLM, as described above.

Please note that methods/examples in this section can be combined/reused with the methods mentioned above, including but not limited to methods related to classification, filter shape, matrix derivation (with special handling), applied region, and syntax. Moreover, methods/examples listed in this section can also be applied with the methods/examples above, to have a better performance with certain complexity trade-off.

In this disclosure, reference samples/training templates/reconstructed neighboring regions usually refer to the luma samples used for deriving the MLR model parameters, which are then applied to the inner luma samples in one CU, to predict the chroma samples in the CU.

CCLM/MMLM with Extended Range

One or more reference samples may be used for CCLM/MMLM prediction, i.e., as shown in FIG. 10B, the reference area may be the same as the reference area in CCCM. Different reference areas may be used for CCLM/MMLM prediction based on previous decoded information on TB/CB/slice/picture/sequence level.

Though training data with multiple reference areas can fit well on the calculation of model parameters, in some cases that training data do not capture full characteristics of testing data, it may result in overfitting and may not predict well on testing data (i.e., the to-be-predicted chroma block samples). Also, different reference areas may adapt well to different video block content, leading to more accurate prediction. To address this issue, the reference shape/number of reference areas can be predefined or signaled/switched in SPS/DPS/VPS/SEI/APS/PPS/PH/SH/Region/CTU/CU/Subblock/Sample levels. A set of reference area candidates can be predefined or signaled/switched in SPS/DPS/VPS/SEI/APS/PPS/PH/SH/Region/CTU/CU/Subblock/Sample levels. Different components (UN) may have different reference area switch control. For example, predefined a set of reference area candidates (idx=0-4) as shown in the table below. The reference area selection of U/V components can be switched in PH or in CU/CTU levels. Different chroma types/color formats can have different predefined reference areas.

| | | | | | | # of |
|---|---|---|---|---|---|---|
| Predefined reference | | | | # of top | # of left | top-left |
| area candidates: | | | | samples | samples | samples |
| | | idx | 0 | W(width | H(high | 1 |
| | | | | of block) | of block) | |
| | | idx | 1 | 2W*6 | 2H*6 | 6*6 |
| | | idx | 2 | 2W*6 | 0 | 6*6 |
| | | idx | 3 | 0 | 2H*6 | 6*6 |
| | | idx | 4 | 6W | 6H | 6*6 |
| POC | comp | Selected reference area idx | | | | |
| 0 | U | 4 | | PH switch | | |
| | V | 0~4 | | CU switch | | |
| 1 | U | 0 | | PH switch | | |
| | V | 0~2 | | CTU switch | | |

The unavailable luma/chroma samples for deriving the MLR model can be padded from available reconstructed samples, the padding process being applied in both training data (top/left neighboring reconstructed luma/chroma samples) and testing data (the luma/chroma samples in the CU).

According to one or more embodiments of the disclosure, the unavailable luma/chroma samples for deriving the MLR model can be skipped and not used. Then the padding process is not needed for the unavailable luma/chroma samples.

FLM/GLM/ELM/CCCM with Minimal Samples Restriction

FLM requires to process down-sampled luma reference values and calculate model parameters, which burden decoder processing cycles, especially for small blocks. In this section, FLM with minimal samples restriction is proposed, for example, FLM is only used for samples larger than predefined number, such as 64, 128. One or more different restrictions may be used for the purpose, for example, FLM is only used in single model for samples larger than a predefined number, such as 256, and FLM is only used in multi model for samples larger than a predefined number, such as 128.

According to one or more embodiments of the disclosure, the number of predefined minimal samples for single model may be larger than or equal to the number of predefined minimal samples for multi model. For example, FLM/GLM/ELM/CCCM is only used in single model for samples larger than or equal to a predefined number, such as 128, and FLM/GLM/ELM/CCCM is only used in multi model for samples larger than or equal to a predefined number, such as 256.

According to one or more embodiments of the disclosure, the number of predefined minimal samples for FLM/GLM/ELM may be larger than or equal to the number of predefined minimal samples for CCCM. For example, CCCM is only used in single model for samples larger than or equal to a predefined number, such as 0, and CCCM is only used in multi model for samples larger than or equal to a predefined number, such as 128. FLM is only used in single model for samples larger than or equal to a predefined number, such as 128, and FLM is only used in multi model for samples larger than or equal to a predefined number, such as 256.

Please note that methods/examples in this section can be combined/reused with the methods mentioned above, including but not limited to methods related to classification, filter shape, matrix derivation (with special handling), applied region, and syntax. Moreover, methods/examples listed in this section can also be applied with the methods/examples above (more taps), to have a better performance with certain complexity trade-off.

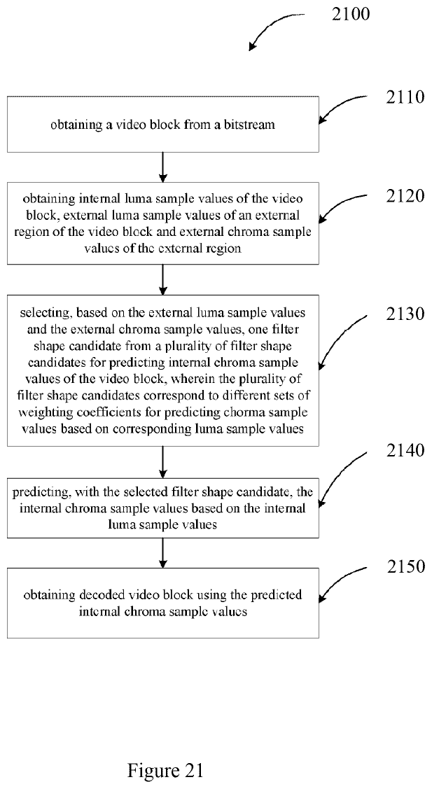

FIG. 21 illustrates a workflow of a method 2100 for decoding video data according to one or more aspects of the present disclosure.

At step 2110, the method 2100 comprises obtaining a video block from a bitstream.

At step 2120, the method 2100 comprises obtaining internal luma sample values of the video block, external luma sample values of an external region of the video block and external chroma sample values of the external region.

At step 2130, the method 2100 comprises selecting, based on the external luma sample values and the external chroma sample values, one filter shape candidate from a plurality of filter shape candidates for predicting internal chroma sample values of the video block, wherein the plurality of filter shape candidates correspond to different sets of weighting coefficients for predicting chroma sample values based on corresponding luma sample values.

At step 2140, the method 2100 comprises predicting, with the selected filter shape candidate, the internal chroma sample values based on the internal luma sample values.

At step 2150, the method 2100 comprises obtaining decoded video block using the predicted internal chroma sample values.

In one example, the method 2100 further comprises: determining the plurality of filter shape candidates for predicting the internal chroma sample values.

In one example, the plurality of filter shape candidates comprise at least one gradient filter candidate enabling calculation of sample differences between luma sample values.

In one example, selecting one filter shape candidate from a plurality of filter shape candidates for predicting the internal chroma sample values comprises: applying each of the sets of weighting coefficients for the plurality of filter shape candidates to the external region respectively, to predict chroma sample values in the external region based on corresponding luma sample values for the chroma sample values in the external region; accumulating, for each of the plurality of filter shape candidates respectively, errors between the predicted chroma sample values and corresponding external chroma sample values in the external region; and selecting one filter shape candidate from the plurality of filter shape candidates based on the accumulated errors for predicting the internal chroma sample values.

In one example, the method 2100 further comprises: applying each of the plurality of filter shape candidates to the external region respectively to derive a set of weighting coefficients corresponding to each of the plurality of filter shape candidates based on external luma sample values and corresponding external chroma sample values in the external region.

In one example, selecting one filter shape candidate from a plurality of filter shape candidates for predicting the internal chroma sample values comprises: dividing the external region into two or more parts; applying each of the plurality of filter shape candidates to a first part of the external region respectively to derive a set of weighting coefficients corresponding to each of the plurality of filter shape candidates based on external luma sample values and corresponding external chroma sample values in the first part of the external region; applying each of the derived sets of weighting coefficients for the plurality of filter shape candidates to a second part of the external region respectively, to predict chroma sample values in the second part of the external region based on corresponding luma sample values for the chroma sample values in the second part of the external region; accumulating, for each of the plurality of filter shape candidates respectively, errors between the predicted chroma sample values and corresponding external chroma sample values in the second part of the external region; selecting one filter shape candidate from the plurality of filter shape candidates based on the accumulated errors for predicting the internal chroma sample values.

In one example, the first part of the external region includes even-numbered rows or columns of the external region, and the second part of the external region includes remaining odd-numbered rows or columns of the external region.

In one example, the first part of the external region and the second part of the external region are interleaved parts of the external region.

In one example, accumulating errors between the predicted chroma sample values and corresponding external chroma sample values comprises: accumulating the errors by Sum of Absolute Difference (SAD), Sum of Squared Difference (SSD), or Sum of Absolute Transformed Difference (SATD).

In one example, selecting one filter shape candidate from the plurality of filter shape candidates based on the accumulated errors for predicting the internal chroma sample values comprises: selecting one filter shape candidate from the plurality of filter shape candidates with the smallest accumulated error for predicting the internal chroma sample values.

In one example, selecting one filter shape candidate from the plurality of filter shape candidates based on the accumulated errors for predicting the internal chroma sample values comprises: sorting and selecting two or more filter shape candidates from the plurality of filter shape candidates with the smallest errors; and selecting one filter shape candidate from the two or more filter shape candidates based on a received signal indicating an applied filter shape candidate for predicting the internal chroma sample values.

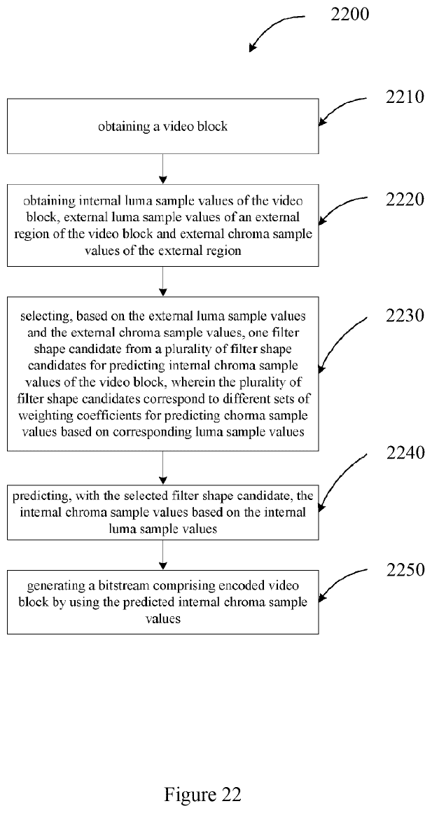

FIG. 22 illustrates a workflow of a method 2200 for encoding video data according to one or more aspects of the present disclosure.

At step 2210, the method 2200 comprises obtaining a video block.

At step 2220, the method 2200 comprises obtaining internal luma sample values of the video block, external luma sample values of an external region of the video block and external chroma sample values of the external region.

At step 2230, the method 2200 comprises selecting, based on the external luma sample values and the external chroma sample values, one filter shape candidate from a plurality of filter shape candidates for predicting internal chroma sample values of the video block, wherein the plurality of filter shape candidates correspond to different sets of weighting coefficients for predicting chroma sample values based on corresponding luma sample values.

At step 2240, the method 2200 comprises predicting, with the selected filter shape candidate, the internal chroma sample values based on the internal luma sample values.

At step 2250, the method 2200 comprises generating a bitstream comprising encoded video block by using the predicted internal chroma sample values.

In one example, the method 2200 further comprises: determining the plurality of filter shape candidates for predicting the internal chroma sample values.

In one example, the plurality of filter shape candidates comprise at least one gradient filter candidate enabling calculation of sample differences between luma sample values.

In one example, selecting one filter shape candidate from a plurality of filter shape candidates for predicting the internal chroma sample values comprises: applying each of the sets of weighting coefficients for the plurality of filter shape candidates to the external region respectively, to predict chroma sample values in the external region based on corresponding luma sample values for the chroma sample values in the external region; accumulating, for each of the plurality of filter shape candidates respectively, errors between the predicted chroma sample values and corresponding external chroma sample values in the external region; and selecting one filter shape candidate from the plurality of filter shape candidates based on the accumulated errors for predicting the internal chroma sample values.

In one example, the method 2200 further comprises: applying each of the plurality of filter shape candidates to the external region respectively to derive a set of weighting coefficients corresponding to each of the plurality of filter shape candidates based on external luma sample values and corresponding external chroma sample values in the external region.

In one example, selecting one filter shape candidate from a plurality of filter shape candidates for predicting the internal chroma sample values comprises: dividing the external region into two or more parts; applying each of the plurality of filter shape candidates to a first part of the external region respectively to derive a set of weighting coefficients corresponding to each of the plurality of filter shape candidates based on external luma sample values and corresponding external chroma sample values in the first part of the external region; applying each of the derived sets of weighting coefficients for the plurality of filter shape candidates to a second part of the external region respectively, to predict chroma sample values in the second part of the external region based on corresponding luma sample values for the chroma sample values in the second part of the external region; accumulating, for each of the plurality of filter shape candidates respectively, errors between the predicted chroma sample values and corresponding external chroma sample values in the second part of the external region; selecting one filter shape candidate from the plurality of filter shape candidates based on the accumulated errors for predicting the internal chroma sample values.

In one example, the first part of the external region includes even-numbered rows or columns of the external region, and the second part of the external region includes remaining odd-numbered rows or columns of the external region.

In one example, the first part of the external region and the second part of the external region are interleaved parts of the external region.

In one example, accumulating errors between the predicted chroma sample values and corresponding external chroma sample values comprises: accumulating the errors by Sum of Absolute Difference (SAD), Sum of Squared Difference (SSD), or Sum of Absolute Transformed Difference (SATD).

In one example, selecting one filter shape candidate from the plurality of filter shape candidates based on the accumulated errors for predicting the internal chroma sample values comprises: selecting one filter shape candidate from the plurality of filter shape candidates with the smallest accumulated error for predicting the internal chroma sample values.

In one example, selecting one filter shape candidate from the plurality of filter shape candidates based on the accumulated errors for predicting the internal chroma sample values comprises: sorting and selecting two or more filter shape candidates from the plurality of filter shape candidates with the smallest errors; and selecting one filter shape candidate from the two or more filter shape candidates for predicting the internal chroma sample values.

In one example, the method 2200 further comprises: signaling a syntax element indicating the selected filter shape candidate in the bitstream.

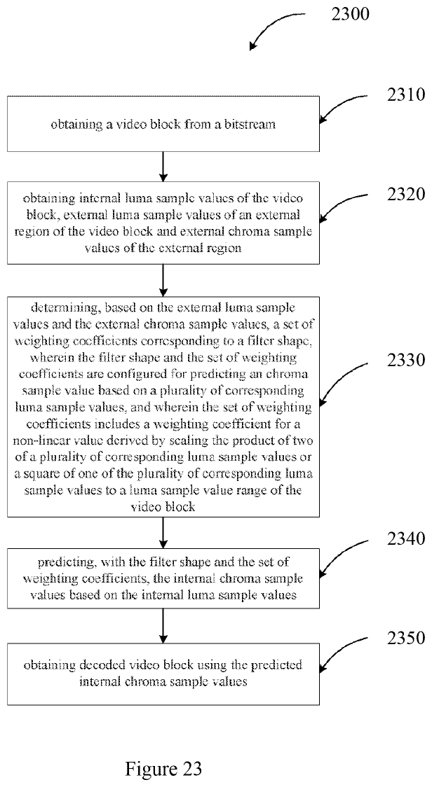

FIG. 23 illustrates a workflow of another method 2300 for decoding video data according to one or more aspects of the present disclosure.

At step 2310, the method 2300 comprises obtaining a video block from a bitstream.

At step 2320, the method 2300 comprises obtaining internal luma sample values of the video block, external luma sample values of an external region of the video block and external chroma sample values of the external region.

At step 2330, the method 2300 comprises determining, based on the external luma sample values and the external chroma sample values, a set of weighting coefficients corresponding to a filter shape, wherein the filter shape and the set of weighting coefficients are configured for predicting an chroma sample value based on a plurality of corresponding luma sample values, and wherein the set of weighting coefficients includes a weighting coefficient for a non-linear value derived by scaling the product of two of a plurality of corresponding luma sample values or a square of one of the plurality of corresponding luma sample values to a luma sample value range of the video block.

At step 2340, the method 2300 comprises predicting, with the filter shape and the set of weighting coefficients, the internal chroma sample values based on the internal luma sample values.

At step 2350, the method 2300 comprises obtaining decoded video block using the predicted internal chroma sample values.

In one example, the set of weighting coefficients further includes one or more weighting coefficients for one or more luma sample values of the plurality of corresponding luma sample values respectively.

In one example, the set of weighting coefficients further includes a weighting coefficient for a bias value.

In one example, the plurality of corresponding luma sample values comprise a plurality of pre-operated luma sample values obtained by weighted-average operations.

In one example, the plurality of corresponding luma sample values comprise a first pre-operated luma sample value collocated with the chroma sample value to be predicted, a second pre-operated luma sample value left to the first pre-operated luma sample value, a third pre-operated luma sample value right to the first pre-operated luma sample value, a fourth pre-operated luma sample value above the first pre-operated luma sample value, and a fifth pre-operated luma sample value below the first pre-operated luma sample value.

In one example, the product of two of the plurality of corresponding luma sample values comprises a product of any two of the first pre-operated luma sample value, the second pre-operated luma sample value, the third pre-operated luma sample value, the fourth pre-operated luma sample value, and the fifth pre-operated luma sample value; and the square of one of the plurality of corresponding luma sample values comprises a square of one of the second pre-operated luma sample value, the third pre-operated luma sample value, the fourth pre-operated luma sample value, and the fifth pre-operated luma sample value.

In one example, the plurality of corresponding luma sample values further comprise an average value of the second pre-operated luma sample value, the third pre-operated luma sample value, the fourth pre-operated luma sample value, and the fifth pre-operated luma sample value, and the square of one of the plurality of corresponding luma sample values comprises a square of the average value of the second pre-operated luma sample value, the third pre-operated luma sample value, the fourth pre-operated luma sample value, and the fifth pre-operated luma sample value.

In one example, the plurality of corresponding luma sample values further comprise an average value of the second pre-operated luma sample value, the third pre-operated luma sample value, the fourth pre-operated luma sample value, and the fifth pre-operated luma sample value, and the product of two of the plurality of corresponding luma sample values comprises a product of the first pre-operated luma sample value and the average value of the second pre-operated luma sample value, the third pre-operated luma sample value, the fourth pre-operated luma sample value, and the fifth pre-operated luma sample value.

In one example, the plurality of corresponding luma sample values comprise a first luma sample value collocated with the chroma sample value to be predicted, a second luma sample value left to the first luma sample value, a third luma sample value right to the first luma sample value, a fourth luma sample value below the first luma sample value, a fifth luma sample value below the second luma sample value, and a sixth luma sample value below the third luma sample value.

In one example, the product of two of the plurality of corresponding luma sample values comprises a product of any two of the first luma sample value, the second luma sample value, the third luma sample value, the fourth luma sample value, the fifth luma sample value, and the sixth luma sample value; and the square of one of the plurality of corresponding luma sample values comprises a square of one of the second luma sample value, the third luma sample value, the fourth luma sample value, the fifth luma sample value or the sixth luma sample value.

In one example, the plurality of corresponding luma sample values further comprise an average value of the second luma sample value, the third luma sample value, the fourth luma sample value, the fifth luma sample value, and the sixth luma sample value, and the square of one of the plurality of corresponding luma sample values comprises a square of the average value of the second luma sample value, the third luma sample value, the fourth luma sample value, the fifth luma sample value, and the sixth luma sample value.

In one example, the plurality of corresponding luma sample values further comprise an average value of the second luma sample value, the third luma sample value, the fourth luma sample value, the fifth luma sample value, and the sixth luma sample value, and the product of two of the plurality of corresponding luma sample values comprises a product of the first luma sample value and the average value of the second luma sample value, the third luma sample value, the fourth luma sample value, the fifth luma sample value, and the sixth luma sample value.

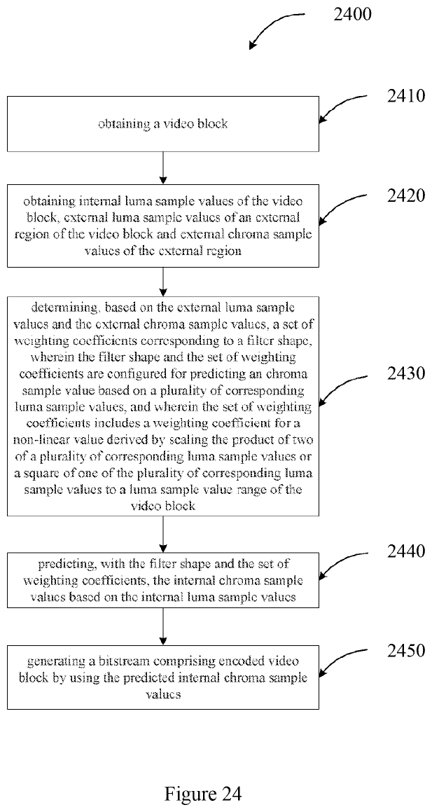

FIG. 24 illustrates a workflow of another method 2400 for encoding video data according to one or more aspects of the present disclosure.

At step 2430, the method 2400 comprises obtaining a video block.

At step 2420, the method 2400 comprises obtaining internal luma sample values of the video block, external luma sample values of an external region of the video block and external chroma sample values of the external region.

At step 2430, the method 2400 comprises determining, based on the external luma sample values and the external chroma sample values, a set of weighting coefficients corresponding to a filter shape, wherein the filter shape and the set of weighting coefficients are configured for predicting an chroma sample value based on a plurality of corresponding luma sample values, and wherein the set of weighting coefficients includes a weighting coefficient for a non-linear value derived by scaling the product of two of a plurality of corresponding luma sample values or a square of one of the plurality of corresponding luma sample values to a luma sample value range of the video block.

At step 2440, the method 2400 comprises predicting, with the filter shape and the set of weighting coefficients, the internal chroma sample values based on the internal luma sample values.

At step 2450, the method 2400 comprises generating a bitstream comprising encoded video block by using the predicted internal chroma sample values.

In one example, the set of weighting coefficients further includes one or more weighting coefficients for one or more luma sample values of the plurality of corresponding luma sample values respectively.

In one example, the set of weighting coefficients further includes a weighting coefficient for a bias value.

In one example, the plurality of corresponding luma sample values comprise a plurality of pre-operated luma sample values obtained by weighted-average operations.

In one example, the plurality of corresponding luma sample values comprise a first pre-operated luma sample value collocated with the chroma sample value to be predicted, a second pre-operated luma sample value left to the first pre-operated luma sample value, a third pre-operated luma sample value right to the first pre-operated luma sample value, a fourth pre-operated luma sample value above the first pre-operated luma sample value, and a fifth pre-operated luma sample value below the first pre-operated luma sample value.

In one example, the product of two of the plurality of corresponding luma sample values comprises a product of any two of the first pre-operated luma sample value, the second pre-operated luma sample value, the third pre-operated luma sample value, the fourth pre-operated luma sample value, and the fifth pre-operated luma sample value; and the square of one of the plurality of corresponding luma sample values comprises a square of one of the second pre-operated luma sample value, the third pre-operated luma sample value, the fourth pre-operated luma sample value, and the fifth pre-operated luma sample value.

In one example, the plurality of corresponding luma sample values further comprise an average value of the second pre-operated luma sample value, the third pre-operated luma sample value, the fourth pre-operated luma sample value, and the fifth pre-operated luma sample value, and the square of one of the plurality of corresponding luma sample values comprises a square of the average value of the second pre-operated luma sample value, the third pre-operated luma sample value, the fourth pre-operated luma sample value, and the fifth pre-operated luma sample value.

In one example, the plurality of corresponding luma sample values further comprise an average value of the second pre-operated luma sample value, the third pre-operated luma sample value, the fourth pre-operated luma sample value, and the fifth pre-operated luma sample value, and the product of two of the plurality of corresponding luma sample values comprises a product of the first pre-operated luma sample value and the average value of the second pre-operated luma sample value, the third pre-operated luma sample value, the fourth pre-operated luma sample value, and the fifth pre-operated luma sample value.

In one example, the plurality of corresponding luma sample values comprise a first luma sample value collocated with the chroma sample value to be predicted, a second luma sample value left to the first luma sample value, a third luma sample value right to the first luma sample value, a fourth luma sample value below the first luma sample value, a fifth luma sample value below the second luma sample value, and a sixth luma sample value below the third luma sample value.

In one example, the product of two of the plurality of corresponding luma sample values comprises a product of any two of the first luma sample value, the second luma sample value, the third luma sample value, the fourth luma sample value, the fifth luma sample value, and the sixth luma sample value; and the square of one of the plurality of corresponding luma sample values comprises a square of one of the second luma sample value, the third luma sample value, the fourth luma sample value, the fifth luma sample value or the sixth luma sample value.

In one example, the plurality of corresponding luma sample values further comprise an average value of the second luma sample value, the third luma sample value, the fourth luma sample value, the fifth luma sample value, and the sixth luma sample value, and the square of one of the plurality of corresponding luma sample values comprises a square of the average value of the second luma sample value, the third luma sample value, the fourth luma sample value, the fifth luma sample value, and the sixth luma sample value.

In one example, the plurality of corresponding luma sample values further comprise an average value of the second luma sample value, the third luma sample value, the fourth luma sample value, the fifth luma sample value, and the sixth luma sample value, and the product of two of the plurality of corresponding luma sample values comprises a product of the first luma sample value and the average value of the second luma sample value, the third luma sample value, the fourth luma sample value, the fifth luma sample value, and the sixth luma sample value.

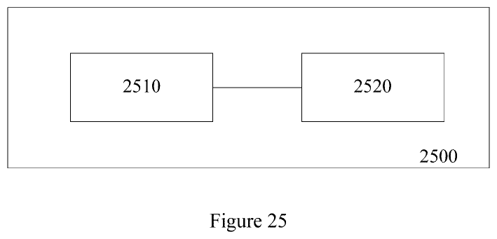

FIG. 25 illustrates an exemplary computing system 2500 according to one or more aspects of the present disclosure. The computing system 2500 may comprise at least one processor 2510. The computing system 2500 may further comprise at least one storage device 2520. The storage device 2520 may store computer-executable instructions that, when executed, cause the processor 2510 to perform the steps of methods described above. The processor 2510 may be a general-purpose processor, or may also be implemented as a combination of computing devices, e.g., a combination of a DSP and a microprocessor, multiple microprocessors, one or more microprocessors in conjunction with a DSP core, or any other such configuration. The storage device 2520 may store the input data, output data, data generated by processor 2510, and/or instructions executed by processor 2510.

It should be appreciated that the storage device 2520 may store computer-executable instructions that, when executed, cause the processor 2510 to perform any operations according to the embodiments of the present disclosure.

The embodiments of the present disclosure may be embodied in a computer-readable medium such as non-transitory computer-readable medium. The non-transitory computer-readable medium may comprise instructions that, when executed, cause one or more processors to perform any operations according to the embodiments of the present disclosure. For example, the instructions, when executed, may cause one or more processors to receive a bitstream and perform the decoding operations as described above. For another example, the instructions, when executed, may cause one or more processors to perform the encoding operations and transmit a bitstream comprising the encoded video information associated with the predicted chroma sample as described above.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the methods described above may be implemented in various approaches. These modules may be implemented as hardware, software, or a combination thereof. Moreover, any of these modules may be further functionally divided into sub-modules or combined together.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skill in the art are expressly incorporated herein by reference and are intended to be encompassed by the claims.

What is claimed is:

1. A method for decoding video data, comprising:
obtaining a video block from a bitstream;
obtaining internal luma sample values of the video block, external luma sample values of an external region of the video block and external chroma sample values of the external region;
selecting, based on the external luma sample values and the external chroma sample values, one filter shape candidate from a plurality of filter shape candidates for predicting internal chroma sample values of the video block, wherein the plurality of filter shape candidates correspond to different sets of weighting coefficients for predicting chroma sample values based on corresponding luma sample values;
predicting, with the selected filter shape candidate, the internal chroma sample values based on the internal luma sample values; and
obtaining decoded video block using the predicted internal chroma sample values.

2. The method of claim 1, further comprising:
determining the plurality of filter shape candidates for predicting the internal chroma sample values.

3. The method of claim 1, wherein the plurality of filter shape candidates comprise at least one gradient filter candidate enabling calculation of sample differences between luma sample values.

4. The method of claim 1, wherein selecting one filter shape candidate from the plurality of filter shape candidates for predicting the internal chroma sample values comprises:
applying each of the sets of weighting coefficients for the plurality of filter shape candidates to the external region respectively, to predict chroma sample values in the external region based on corresponding luma sample values for the chroma sample values in the external region;
accumulating, for each of the plurality of filter shape candidates respectively, errors between the predicted chroma sample values and corresponding external chroma sample values in the external region; and
selecting one filter shape candidate from the plurality of filter shape candidates based on the accumulated errors for predicting the internal chroma sample values.

5. The method of claim 4, further comprising:
applying each of the plurality of filter shape candidates to the external region respectively to derive a set of weighting coefficients corresponding to each of the plurality of filter shape candidates based on external luma sample values and corresponding external chroma sample values in the external region.

6. The method of claim 1, wherein selecting one filter shape candidate from the plurality of filter shape candidates for predicting the internal chroma sample values comprises:
dividing the external region into two or more parts;
applying each of the plurality of filter shape candidates to a first part of the external region respectively to derive a set of weighting coefficients corresponding to each of the plurality of filter shape candidates based on external luma sample values and corresponding external chroma sample values in the first part of the external region;
applying each of the derived sets of weighting coefficients for the plurality of filter shape candidates to a second part of the external region respectively, to predict chroma sample values in the second part of the external region based on corresponding luma sample values for the chroma sample values in the second part of the external region;
accumulating, for each of the plurality of filter shape candidates respectively, errors between the predicted chroma sample values and corresponding external chroma sample values in the second part of the external region; and
selecting one filter shape candidate from the plurality of filter shape candidates based on the accumulated errors for predicting the internal chroma sample values.

7. The method of claim 6, wherein the first part of the external region includes even-numbered rows or columns of the external region, and the second part of the external region includes remaining odd-numbered rows or columns of the external region.

8. The method of claim 6, wherein the first part of the external region and the second part of the external region are interleaved parts of the external region.

9. The method of claim 4, wherein accumulating errors between the predicted chroma sample values and corresponding external chroma sample values comprises:
accumulating the errors by Sum of Absolute Difference (SAD), Sum of Squared Difference (SSD), or Sum of Absolute Transformed Difference (SATD).

10. The method of claim 4, wherein selecting one filter shape candidate from the plurality of filter shape candidates based on the accumulated errors for predicting the internal chroma sample values comprises:
selecting one filter shape candidate from the plurality of filter shape candidates with the smallest accumulated error for predicting the internal chroma sample values.

11. The method of claim 4, wherein selecting one filter shape candidate from the plurality of filter shape candidates based on the accumulated errors for predicting the internal chroma sample values comprises:
sorting and selecting two or more filter shape candidates from the plurality of filter shape candidates with the smallest errors; and
selecting one filter shape candidate from the two or more filter shape candidates based on a received signal indicating an applied filter shape candidate for predicting the internal chroma sample values.

12. A computer system, comprising:
one or more processors; and
one or more storage devices storing computer-executable instructions that, when executed, cause the one or more processors to:
obtain a video block from a bitstream;
obtain internal luma sample values of the video block, external luma sample values of an external region of the video block and external chroma sample values of the external region;
select, based on the external luma sample values and the external chroma sample values, one filter shape candidate from a plurality of filter shape candidates for predicting internal chroma sample values of the video block, wherein the plurality of filter shape candidates correspond to different sets of weighting coefficients for predicting chroma sample values based on corresponding luma sample values;
predict, with the selected filter shape candidate, the internal chroma sample values based on the internal luma sample values; and
obtain decoded video block using the predicted internal chroma sample values.

13. The computer system of claim 12, wherein the computer-executable instructions are further executed to cause the one or more processors to:
determine the plurality of filter shape candidates for predicting the internal chroma sample values.

14. The computer system of claim 12, wherein selecting one filter shape candidate from the plurality of filter shape candidates for predicting the internal chroma sample values comprises:
applying each of the sets of weighting coefficients for the plurality of filter shape candidates to the external region respectively, to predict chroma sample values in the external region based on corresponding luma sample values for the chroma sample values in the external region;
accumulating, for each of the plurality of filter shape candidates respectively, errors between the predicted chroma sample values and corresponding external chroma sample values in the external region; and
selecting one filter shape candidate from the plurality of filter shape candidates based on the accumulated errors for predicting the internal chroma sample values.

15. The computer system of claim 14, wherein the computer-executable instructions are further executed to cause the one or more processors to:
apply each of the plurality of filter shape candidates to the external region respectively to derive a set of weighting coefficients corresponding to each of the plurality of filter shape candidates based on external luma sample values and corresponding external chroma sample values in the external region.

16. The computer system of claim 12, wherein selecting one filter shape candidate from the plurality of filter shape candidates for predicting the internal chroma sample values comprises:
dividing the external region into two or more parts;
applying each of the plurality of filter shape candidates to a first part of the external region respectively to derive a set of weighting coefficients corresponding to each of the plurality of filter shape candidates based on external luma sample values and corresponding external chroma sample values in the first part of the external region;
applying each of the derived sets of weighting coefficients for the plurality of filter shape candidates to a second part of the external region respectively, to predict chroma sample values in the second part of the external region based on corresponding luma sample values for the chroma sample values in the second part of the external region;
accumulating, for each of the plurality of filter shape candidates respectively, errors between the predicted chroma sample values and corresponding external chroma sample values in the second part of the external region; and
selecting one filter shape candidate from the plurality of filter shape candidates based on the accumulated errors for predicting the internal chroma sample values.

17. The computer system of claim 14, wherein selecting one filter shape candidate from the plurality of filter shape candidates based on the accumulated errors for predicting the internal chroma sample values comprises:
selecting one filter shape candidate from the plurality of filter shape candidates with the smallest accumulated error for predicting the internal chroma sample values.

18. The computer system of claim 14, wherein selecting one filter shape candidate from the plurality of filter shape candidates based on the accumulated errors for predicting the internal chroma sample values comprises:
sorting and selecting two or more filter shape candidates from the plurality of filter shape candidates with the smallest errors; and
selecting one filter shape candidate from the two or more filter shape candidates based on a received signal indicating an applied filter shape candidate for predicting the internal chroma sample values.

19. A computer readable storage medium storing a bitstream to be decoded by the method for decoding video data according to claim 1.

20. A method for storing a bitstream, comprising:
performing an encoding method to generate a bitstream; and
storing the bitstream on a computer readable storage medium,
wherein the encoding method comprises:
obtaining a video block;
obtaining internal luma sample values of the video block, external luma sample values of an external region of the video block and external chroma sample values of the external region;
selecting, based on the external luma sample values and the external chroma sample values, one filter shape candidate from a plurality of filter shape candidates for predicting internal chroma sample values of the video block, wherein the plurality of filter shape candidates correspond to different sets of weighting coefficients for predicting chroma sample values based on corresponding luma sample values;
predicting, with the selected filter shape candidate, the internal chroma sample values based on the internal luma sample values; and
generating a bitstream comprising encoded video block by using the predicted internal chroma sample values.
